(19) United States
(12) Patent Application Publication
(10) Pub. No.: US 2026/0251906 A1
(43) Pub. Date: Aug. 27, 2026

(54) POSITIONING, STABILISING, AND INTERFACING STRUCTURES AND SYSTEM INCORPORATING SAME

(71) Applicant: RESMED PTY LTD, Bella Vista, New South Wales (AU)

(72) Inventors: Andrew James BATE, Sydney (AU); Vanessa GRAY, Sydney (AU); Michael Christopher HOGG, Sydney (AU); Stewart Joseph WAGNER, Hawkesbury (AU); Jie YUAN, Sydney (AU); Aaron Samuel DAVIDSON, Sydney (AU); Ian Andrew LAW, Sydney (AU)

(21) Appl. No.: 18/993,806

(22) PCT Filed: Jul. 14, 2023
(86) PCT No.: PCT/AU2023/050650

§ 371 Date: Jan. 13, 2025

(30) Foreign Application Priority Data
Jul. 14, 2022 (AU) 2022901965

(51) Int. Cl. G02B 27/01; F16M 13/04

(52) U.S. Cl. CPC G02B 27/0176; F16M 13/04

(57) ABSTRACT

A head-mounted display system comprising a head-mounted display unit comprising a display; and a positioning and stabilising structure structured and arranged to hold the head-mounted display unit in an operable position on the user's head in use, the head-mounted display unit comprising a display unit housing and an interfacing structure connected to the display unit housing, the interfacing structure constructed and arranged to be in opposing relation with the user's face in use, the interfacing structure comprising: a face engaging flange provided around a periphery of an eye region of the user's face and configured to engage the user's face in use, the face engaging flange being flexible and resilient; and a cushion at least partially covered by the face engaging flange, the cushion formed by a lattice structure.

### 1 CROSS-REFERENCE TO RELATED APPLICATIONS

This application claims the benefit of Australian Patent Application No. 2022901965 filed 14 Jul. 2022, the entire contents of which are hereby incorporated by reference herein.

### 2 BACKGROUND OF THE TECHNOLOGY

### 2.1 Field of the Technology

The present technology relates generally to head mounted displays, positioning and stabilizing structures, user interfacing structures, and other components for use in head mounted displays, associated head-mounted display assemblies and systems including a display unit and positioning and stabilizing structure, interfacing structures and or components, and methods. The present technology finds particular application in the use of immersive reality head mounted displays and is herein described in that context. It is to be appreciated that the present technology may have broader application and may be used in any type of head-mounted display arrangement including, but not limited to, virtual reality displays, augmented reality displays, and/or mixed reality displays.

### 2.2 Description of the Related Art

It is to be understood that, if any prior art is referred to herein, such reference does not constitute an admission that the prior art forms a part of the common general knowledge in the art, in Australia or any other country.

### 2.2.1 Immersive Technology

An immersive technology refers to technology that attempts to replicate or augment a physical environment through the means of a digital or virtual environment by creating a surrounding sensory feeling, thereby creating a sense of immersion.

In particular, an immersive technology provides the user visual immersion, and creates virtual objects and/or a virtual environment. The immersive technology may also provide immersion for at least one of the other five senses.

### 2.2.2 Virtual Reality

Virtual reality (VR) is a computer-generated three-dimensional image or environment that is presented to a user. In other words, the environment may be entirely virtual. Specifically, the user observes an electronic screen in order to observe virtual or computer generated images in a virtual environment. Since the created environment is entirely virtual, the user may be blocked and/or obstructed from interacting with their physical environment (e.g., they may be unable to hear and/or see the physical objects in the physical environment that they are currently located).

The electronic screen may be supported in the user's line of sight (e.g., mounted to the user's head). While observing the electronic screen, visual feedback output by the electronic screen and observed by the user may produce a virtual environment intended to simulate an actual environment. For example, the user may be able to look around (e.g., 360°) by pivoting their head or their entire body, and interact with virtual objects observable by the user through the electronic screen. This may provide the user with an immersive experience where the virtual environment provides stimuli to at least one of the user's five senses, and replaces the corresponding stimuli of the physical environment while the user uses the VR device. Typically, the stimuli relates at least to the user's sense of sight (i.e., because they are viewing an electronic screen), but other senses may also be included. The electronic screens are typically mounted to the user's head so that they may be positioned in close proximity to the user's eyes, which allows the user to easily observe the virtual environment.

The VR device may produce other forms of feedback in addition to, or aside from, visual feedback. For example, the VR device may include and/or be connected to a speaker in order to provide auditory feedback. The VR device may also include tactile feedback (e.g., in the form of haptic response), which may correspond to the visual and/or auditory feedback. This may create a more immersive virtual environment, because the user receives stimuli corresponding to more than one of the user's senses.

While using a VR device, a user may wish to limit to block ambient stimulation. For example, the user may want to avoid seeing and/or hearing the ambient environment in order to better process stimuli from the VR device in the virtual environment. Thus, VR devices may limit and/or prevent the user's eyes from receiving ambient light. In some examples, this may be done by providing a seal against the user's face. In some examples, a shield may be disposed proximate to (e.g., in contact or close contact with) the user's face, but may not seal against the user's face. In either example, ambient light may not reach the user's eyes, so that the only light observable by the user is from the electronic screen.

In other examples, the VR devices may limit and/or prevent the user's ears from hearing ambient noise. In some examples, this may be done by providing the user with headphones (e.g., noise cancelling headphones), which may output sounds from the VR device and/or limit the user from hearing noises from their physical environment. In some examples, the VR device may output sounds at a volume sufficient to limit the user from hearing ambient noise.

In any example, the user may not want to become overstimulated (e.g., by both their physical environment and the virtual environment). Therefore, blocking and/or limiting the ambient from stimulating the user assists the user in focusing on the virtual environment, without possible distractions from the ambient.

Different types of VR devices are described below. Generally, a single VR device may include at least two different classifications. For example, the VR device may be classified by its portability and by how the display unit is coupled to the rest of the interface. These classifications may be independent, so that classification in one group (e.g., the portability of the unit) does not predetermine classification into another group. There may also be additional categories to classify VR devices, which are not explicitly listed below.

### 2.2.2.1 Portability

### 2.2.2.1.1 Fixed Unit

In some forms, a VR device may be used in conjunction with a separate device, like a computer or video game console. This type of VR device may be fixed, since it cannot be used without the computer or video game console, and thus locations where it can be used are limited (e.g., by the location of the computer or video game console).

Since the VR device can be used in conjunction with the computer or video game console, the VR device may be connected to the computer or video game console. For example, an electrical cord may tether the two systems together. This may further “fix” the location of the VR device, since the user wearing the VR device cannot move further from the computer or video game console than the length of the electrical cord. In other examples, the VR device may be wirelessly connected (e.g., via Bluetooth, Wi-Fi, etc.), but may still be relatively fixed by the strength of the wireless signal.

The connection to the computer or video game console may provide control functions to the VR device. The controls may be communicated (i.e., through a wired connector or wirelessly) in order to help operate the VR device. In examples of a fixed unit VR device, these controls may be necessary in order to operate the display screen, and the VR device may not be operable without the connection to the computer or video game console.

In some forms, the computer or video game console may provide electrical power to the VR device, so that the user does not need to support a battery on their head. This may make the VR device more comfortable to wear, since the user does not need to support the weight of a battery.

The user may also receive outputs from the computer or video game console at least partially through the VR device, as opposed to through a television or monitor, which may provide the user with a more immersive experience while using the computer or video game console (e.g., playing a video game). In other words, the display output of the VR device may be substantially the same as the output from a computer monitor or television. Some controls and/or sensors necessary to output these images may be housed in the computer or video game console, which may further reduce the weight that the user is required to support on their body.

In some forms, movement sensors may be positioned remote from the VR device, and connected to the computer or video game console. For example, at least one camera may face the user in order to track movements of the user's head. The processing of the data recorded by the camera(s) may be done by the computer or video game console, before being transmitted to the VR device. While this may assist in weight reduction of the VR device, it may also further limit where the VR device can be used. In other words, the VR device must be in the sight line of the camera(s).

### 2.2.2.1.2 Portable Unit

In some forms, the VR device may be a self-contained unit, which includes a power source and sensors, so that the VR device does not need to be connected to a computer or video game console. This provides the user more freedom of use and movement. For example, the user is not limited to using the VR device near a computer or video game console, and could use the VR device outdoors, or in other environments that do not include computers or televisions.

Since the VR device is not connected to a computer or video game console in use, the VR device is required to support all necessary electronic components. This includes batteries, sensors, and processors. These components add weight to the VR device, which the user must support on their body. Appropriate weight distribution may be needed so that this added weight does not increase discomfort to a user wearing the VR device.

In some forms, the electrical components of the VR device are contained in a single housing, which may be disposed directly in front of the user's face, in use. This configuration may be referred to as a “brick.” In this configuration, the center of gravity of the VR device without the positioning and stabilizing structure is directly in front of the user's face. In order to oppose the moment created by the force of gravity, the positioning and stabilizing structure coupled to the brick configuration must provide a force directed into the user's face, for example created by tension in headgear straps. While the brick configuration may be beneficial for manufacturing (e.g., since all electrical components are in close proximity) and may allow interchangeability of positioning and stabilizing structures (e.g., because they include no electrical connections), the force necessary to maintain the position of the VR device (e.g. tensile forces in headgear) may be uncomfortable to the user. Specifically, the VR device may dig into the user's face, leading to irritation and markings on the user's skin. The combination of forces may feel like “clamping” as the user's head receives force from the display housing on their face and force from headgear on the back of their head. This may make a user less likely to wear the VR device.

As VR and other mixed reality devices may be used in a manner involving vigorous movement of the user's head and/or their entire body (for example during gaming), there may be significant forces/moments tending to disrupt the position of the device on the user's head. Simply forcing the device more tightly against the user's head to tolerate large disruptive forces may not be acceptable as it may be uncomfortable for the user or become uncomfortable after only a short period of time.

In some forms, electrical components may be spaced apart throughout the VR device, instead of entirely in front of the user's face. For example, some electrical components (e.g., the battery) may be disposed on the positioning and stabilizing structure, particularly on a posterior contacting portion. In this way, the weight of the battery (or other electrical components) may create a moment directed in the opposite direction from the moment created by the remainder of the VR device (e.g., the display). Thus, it may be sufficient for the positioning and stabilizing structure to apply a lower clamping force, which in turn creates a lower force against the user's face (e.g., fewer marks on their skin). However, cleaning and/or replacing the positioning and stabilizing structure may be more difficult in some such existing devices because of the electrical connections.

In some forms, spacing the electrical components apart may involve positioning some of the electrical components separate from the rest of the VR device. For example, a battery and/or a processor may be electrically connected, but carried separately from the rest of the VR device. Unlike in the “fixed units” described above, the battery and/or processor may be portable, along with the remainder of the VR device. For example, the battery and/or the processor may be carried on the user's belt or in the user's pocket. This may provide the benefit of reduced weight on the user's head, but would not provide a counteracting moment. The tensile force provided by the positioning and stabilizing structure may still be less than the “brick” configuration, since the total weight supported by the head is less.

### 2.2.2.2 Display Connection

### 2.2.2.2.1 Integrated Display Screen

In some forms, the display screen is an integral piece of the VR device, and generally cannot be detached or removed from the rest of the VR device.

The display screen may be fixed within a housing, and protected from damage. For example, the display screen may be completely covered by the housing, which may reduce the occurrence of scratches. Additionally, integrating display screen with the rest of the VR device eliminates the occurrence of losing the display screen.

In these forms, the display screen functions purely as an immersive technology display. The vast majority of “fixed units” will include an integrated display screen. “Portable units” may include an integrated display screen, or may include a removable display screen (described below).

### 2.2.2.2.2 Removable Display Screen

In some forms, the display screen is a separate structure that can be removed from the VR device, and used separately.

In some forms, a portable electronic device (e.g., a cell phone) may be selectively inserted into a housing of the VR device. The portable electronic device may include most or all of the sensors and/or processors, and may create a virtual environment through a downloadable app.

Portable electronic devices are generally light weight, and may not require the positioning and stabilizing structure to apply a large force to the user's head.

### 2.2.3 Augmented Reality

In some forms, augmented reality (AR) is a computer-generated three-dimensional image or environment that is presented to a user.

While similar to VR, AR differs in that the virtual environment created at least in part by the electronic screen is observed in combination with the user's physical environment. In other words, AR creates virtual objects in order to alter and/or enhance the user's physical environment with elements of a virtual environment. The result of AR is a combined environment that includes physical and virtual objects, and therefore an environment that is both physical and virtual.

For example, images created by the electronic screen may be overlayed into the user's physical environment. Only a portion of an AR combination environment presented to the user includes is virtual. Thus, the user may wish to continue to receive ambient stimulation from their physical environment while using an AR device (e.g., in order to continue to observe the physical or non-virtual component of the combination environment).

Since AR may be used with the user's physical environment, an AR device may not be electrically connected, or otherwise tethered, to a computer or video game console. Instead the AR device may include a battery, or other power source. This may provide the user with the greatest freedom of movement, so that they can explore a variety of physical environments while using the AR device.

This key difference between VR and AR may lead to different types of wearable electronic screens. As described above, a user of a VR device may wish to block ambient light, so the housing of the electronic screen may be opaque in order to limit or prevent ambient light from reaching the user. However, the user of an AR device may want to see the virtual environment blended with their actual environment. The electronic screen in an AR device may be similarly supported in front of the user's eyes, but, screens in AR devices may be transparent or translucent, and the screens may not be supported by an opaque housing (or opaque material may not substantially obstruct the user's line of sight). This may allow the user to continue receiving ambient stimulation, where the virtual environment is simultaneously present. Notwithstanding, some VR devices that do not have a transparent screen through which the user can see their real world surroundings may be configurable for AR by acquiring real-time video of the user's real-world surroundings from the user's perspective (e.g. with cameras on the display housing) and displaying it on the display screen.

Additionally, a person using an AR device may be more mobile than a person using a VR device (e.g., because an AR user can see their physical environment and/or are not tethered to a computer or video game console). Thus, a person using an AR device may wish to wear the device for an extended period of time, while also moving around (e.g., walking, running, biking, etc.). Including components, like batteries, on the AR device may make the AR device uncomfortable for the user's head and/or neck, and may discourage the user from wearing the AR device for long periods of time.

### 2.2.4 Mixed Reality

Mixed reality (MR) is similar to AR but may be more immersive because the MR device may provide the user more ways to interact with virtual objects or environment than an AR device. The virtual reality in MR may also be overlayed and/or blended with the user's physical environment. Unlike AR however, a user may be able to interact with the virtual environment akin to what occurs in VR. In other words, while AR may present only an computer generated image in the physical environment, MR may present the user with the same or similar computer generated image but allow for interaction with the image in the physical environment (e.g., using a hand to “grab” an object produced virtually). Thus, the virtual environment may further merge with a physical environment so that the combined environment better replicates an actual environment.

### 2.2.5 Head-mounted Display Interface

A head-mounted display interface enables a user to have an immersive experience of a virtual environment and have broad application in fields such as communications, training, medical and surgical practice, engineering, and video gaming.

Different head-mounted display interfaces can each provide a different level of immersion. For example, some head-mounted display interfaces can provide the user with a total immersive experience. One example of a total immersive experience is virtual reality (VR). The head-mounted display interface can also provide partial immersion consistent with using an AR device.

VR head-mounted display interfaces typically are provided as a system that includes a display unit which is arranged to be held in an operational position in front of a user's face. The display unit typically includes a housing containing a display and a user interface structure constructed and arranged to be in opposing relation with the user's face. The user interface structure may extend about the display and define, in conjunction with the housing, a viewing opening to the display. The user interfacing structure may engage with the face and include a cushion for user comfort and/or be light sealing to block ambient light from the display. The head-mounted display system further comprises a positioning and stabilizing structure that is disposed on the user's head to maintain the display unit in position.

Other head-mounted display interfaces can provide a less than total immersive experience. In other words, the user can experience elements of their physical environment, as well as a virtual environment. Examples of a less than total immersive experience are augmented reality (AR) and mixed reality (MR).

AR and/or MR head-mounted display interfaces are also typically provided as a system that includes a display unit which is arranged to be held in an operational position in front of a user's face. Likewise, the display unit typically includes a housing containing a display and a user interface structure constructed and arranged to be in opposing relation with the user's face. The head-mounted display system of the AR and/or MR head-mounted display is also similar to VR in that it further comprises a positioning and stabilizing structure that is disposed on the user's head to maintain the display unit in position. However, AR and/or MR head-mounted displays do not include a cushion that totally seals ambient light from the display, since these less than total immersive experience require an element of the physical environment. Instead, head-mounted displays in augmented and/or mixed allow the user to see the physical environment in combination with the virtual environment.

In any types of immersive technology, it is important that the head-mounted display interface is comfortable in order to allow the user to wear the head-mounted display for extended periods of time. Additionally, it is important that the display is able to provide changing images with changing position and/or orientation of the user's head in order to create an environment, whether partially or entirely virtual, that is similar to or replicates one that is entirely physical.

### 2.2.5.1 Interfacing Structure

The head-mounted displays may include a user interfacing structure. Since it is in direct contact with the user's face, the shape and configuration of the interfacing portion can have a direct impact on the effectiveness and comfort of the display unit.

The design of a user interfacing structure presents a number of challenges. The face has a complex three-dimensional shape. The size and shape of noses and heads varies considerably between individuals. Since the head includes bone, cartilage and soft tissue, different regions of the face respond differently to mechanical forces.

One type of interfacing structure extends around the periphery of the display unit and is intended to seal against the user's face when force is applied to the user interface with the interfacing structure in confronting engagement with the user's face. The interfacing structure may include a pad made of a polyurethane (PU). With this type of interfacing structure, there may be gaps between the interfacing structure and the face, and additional force may be required to force the display unit against the face in order to achieve the desired contact.

The regions not engaged at all by the user interface may allow gaps to form between the facial interface and the user's face through which undesirable light pollution may ingress into the display unit (e.g., particularly when using virtual reality). The light pollution or “light leak” may decrease the efficacy and enjoyment of the overall immersive experience for the user. In addition, previous systems may be difficult to adjust to enable application for a wide variety of head sizes. Further still, the display unit and associated stabilizing structure may often be relatively heavy and may be difficult to clean which may thus further limit the comfort and useability of the system.

Another type of interfacing structure incorporates a flap seal of thin material positioned about a portion of the periphery of the display unit so as to provide a sealing action against the face of the user. Like the previous style of interfacing structure, if the match between the face and the interfacing structure is not good, additional force may be required to achieve a seal, or light may leak into the display unit in-use. Furthermore, if the shape of the interfacing structure does not match that of the user, it may crease or buckle in-use, giving rise to undesirable light penetration.

A user interface may be partly characterised according to the design intent of where the interfacing structure is to engage with the face in-use. Some interfacing structures may be limited to engaging with regions of the user's face that protrude beyond the arc of curvature of the face engaging surface of the interfacing structure. These regions may typically include the user's forehead and cheek bones. This may result in user discomfort at localised stress points. Other facial regions may not be engaged at all by the interfacing structure or may only be engaged in a negligible manner that may thus be insufficient to increase the translation distance of the clamping pressure. These regions may typically include the sides of the user's face, or the region adjacent and surrounding the users nose. To the extent to which there is a mismatch between the shape of the users' face and the interfacing structure, it is advantageous for the interfacing structure or a related component to be adaptable in order for an appropriate contact or other relationship to form.

### 2.2.5.2 Positioning and Stabilizing

To hold the display unit in its correct operational position, the head-mounted display system further comprises a positioning and stabilizing structure that is disposed on the user's head. These structures may be responsible for providing forces to counter gravitational forces of the head-mounted display and/or interfacing structure. In the past these structures have been formed from expandable rigid structures that are typically applied to the head under tension to maintain the display unit in its operational position. Such systems have been prone to exert a clamping pressure on the user's face which can result in user discomfort at localised stress points. Also, previous systems may be difficult to adjust to allow wide application head sizes. Further, the display unit and associated stabilizing structure are often heavy, difficult to clean which further limit the comfort and useability of the system.

Certain other head mounted display systems may be functionally unsuitable for the present field. For example, positioning and stabilizing structures designed for ornamental and visual aesthetics may not have the structural capabilities to maintain a suitable pressure around the face. For example, an excess of clamping pressure may cause discomfort to the user, or alternatively, insufficient clamping pressure on the users' face may not effectively seal the display from ambient light.

Certain other head mounted display systems may be uncomfortable or impractical for the present technology. For example, if the system is used for prolonged time periods.

As a consequence of these challenges, some head mounted displays suffer from being one or more of obtrusive, aesthetically undesirable, costly, poorly fitting, difficult to use, and uncomfortable especially when worn for long periods of time or when a user is unfamiliar with a system. Wrongly sized positioning and stabilizing structures can give rise reduced comfort and in turn, shortened periods of use.

Therefore, an interfacing portion of a user interface used for the fully immersive experience of a virtual environment are subject to forces corresponding to the movement of a user during the experience.

### 2.2.5.3 Materials

Materials used in head mounted display assemblies have included dense foams for contacting portions in the interfacing structures, rigid shells for the housings, and positioning and stabilizing structures formed from rigid plastic clamping structures. These materials have various drawbacks including not permitting the skin covered by the material to breath, being inflexible, difficult to clean and to prone trapping bacteria. As a result, products made with such material may be uncomfortable to wear for extended periods of time, causes skin irritation in some individuals and limit the application of the products.

### 3 BRIEF SUMMARY OF THE TECHNOLOGY

The present technology may be directed toward providing positioning and stabilizing structures used in the supporting, stabilizing, mounting, utilizing, and/or securing of a head-mounted display having one or more of improved comfort, cost, efficacy, ease of use and manufacturability.

A first aspect of the present technology relates to apparatuses used in the supporting, stabilizing, mounting, utilizing, and/or securing of a head-mounted display.

Another aspect of the present technology relates to methods used in the supporting, stabilizing, mounting, utilizing, and/or securing of a head-mounted display.

Another aspect is a positioning and stabilizing structure for a head-mounted display that comprising a rear (or posterior) support structure (or portion) arranged, in use, to contact a posterior region of the user's head.

In some forms, the posterior support portion or at least a portion thereof is disposed posterior of the otobasion superior of the user.

In some forms, the posterior support portion is biased into contact with the occipital region of the user.

In some forms, the positioning and stabilizing structure further comprises opposing connectors that are disposed on opposing sides of, and extending along the temporal regions of, the user's head to interconnect the posterior support portion to the head-mounted display unit. In some forms the positioning and stabilising structure comprises an anterior support portion connecting the posterior support portion to the head-mounted display unit.

The present technology may also be directed toward providing interfacing structures used in the supporting, cushioning, stabilizing, positioning, and/or sealing a head-mounted display in opposing relation with the user's face.

Another aspect relates to apparatuses used in the supporting, cushioning, stabilizing, positioning, and/or sealing a head-mounted display in opposing relation with the user's face.

Another aspect relates to methods used in supporting, cushioning, stabilizing, positioning, and/or sealing a head-mounted display in opposing relation with the user's face.

### 3.1 Cushion Having a Lattice Structure

Another aspect of the present technology relates to a head-mounted display system, comprising:
a head-mounted display unit comprising a display; and
a positioning and stabilising structure structured and arranged to hold the head-mounted display unit in an operable position on the user's head in use,
wherein the head-mounted display unit comprises a display unit housing and an interfacing structure connected to the display unit housing, the interfacing structure constructed and arranged to be in opposing relation with the user's face in use, the interfacing structure comprising a cushion at least partially formed by a lattice structure.

In examples:
the interfacing structure comprises a face engaging flange structured and arranged to be provided around a periphery of an eye region of the user's face and configured to engage the user's face in use, the face engaging flange being flexible and resilient, the face engaging flange at least partially covering the lattice structure; the interfacing structure comprises an interfacing structure clip configured to attach the interfacing structure to the display unit housing;
the cushion is removably attached to the interfacing structure clip;
the cushion is permanently attached to the interfacing structure clip;
the cushion comprises one or more cushion clips;
one or more of the cushion clips are configured to connect to the interfacing structure clip to attach the cushion to the interfacing structure clip;
the one or more cushion clips are removably attachable to the interfacing structure clip;
the face engaging flange extends from the interfacing structure clip;
the interfacing structure clip is configured to form a snap fit connection with the display unit housing;
the interfacing structure further comprises a chassis portion, the face engaging flange being attached to the chassis portion, the chassis portion being stiffer than the face engaging flange and being attached to the interfacing structure clip;
the face engaging flange and the chassis portion are integrally formed;
one or more of the cushion clips are configured to connect to the chassis portion; and/or
the cushion clips are removably attachable to the chassis portion.

In further examples:
the cushion is formed flat and bent into a three-dimensional shape during assembly with the face engaging flange;
the cushion is formed in a three-dimensional shape;
the lattice structure is 3D printed;
the lattice structure is 3D printed in a shape corresponding to a unique user's face;
the lattice structure is injection moulded;
the lattice structure is formed from TPU;
the lattice structure is formed from silicone;
the lattice structure is formed from a material having a Durometer hardness within the range of 20 Shore A to 80 Shore A;
the lattice structure comprises a two-dimensional structure;
the lattice structure comprises a three-dimensional structure;
the lattice structure comprises one of a fluorite structure, truncated cube structure, IsoTruss structure, hexagonal honeycomb structure, gyroid structure, and Schwarz structure;
the cushion is formed from foam having holes therein forming the lattice structure; and/or
the size, shape and/or spacing of the holes varies along a length of the cushion and/or between a first side of the cushion and a second side of the cushion.

In further examples:
the interfacing structure comprises a pair of cheek portions configured to engage the user's cheeks in use, a forehead portion configured to engage the user's forehead in use, and a pair of sphenoid portions located on respective lateral sides of the interfacing structure connecting between the forehead portion and the cheek portions and configured to engage the user's head proximate the sphenoid bone;
the cushion is provided within the cheek portions of the interfacing structure;
the cushion is provided within the sphenoid portions of the interfacing structure;
the cushion is provided within the forehead portion of the interfacing structure;
the cushion comprises one or more characteristics that vary between locations corresponding to the cheek portions, forehead portion and sphenoid portions of the interfacing structure;
the one or more characteristics of the cushion include stiffness of the cushion;
the one or more characteristics of the cushion include one or more characteristics of the lattice structure;
the one or more characteristics of the lattice structure include shape, thickness, density, spacing, relative orientation and/or material of unit cells forming the lattice structure;
the cushion is stiffer in the forehead portion and/or the cheek portions in comparison to the sphenoid portions;
the cushion is able to deform to accommodate anthropometric variation to a greater extent in the sphenoid portions than in the forehead portion and/or the cheek portions;
the lattice structure comprises one or more characteristics that vary between a user-facing side of the cushion corresponding to a side of the interfacing structure configured to contact the user's face in use and a non-user facing side of the cushion corresponding to a side of the interfacing structure configured to face away from the user's face in use;
the lattice structure on the user-facing side of the cushion is configured to avoid leaving red marks on the user's face;
the lattice structure on the non-user facing side of the cushion is configured to adapt readily to the shape of the user's face;
the lattice structure comprises smaller unit cells on the user-facing side than on the non-user facing side;
the variation in the one or more characteristics of the lattice structure causes the cushion to be less stiff on the user-facing side of the cushion than on the non-user facing side of the cushion;
the material forming the unit cells of the lattice structure is thinner on the user-facing side of the cushion than on the non-user facing side of the cushion;
the material forming the unit cells of the lattice structure has a thickness within the range of 0.3-0.5 mm on the user-facing side of the cushion;
the material forming the unit cells of the lattice structure has a thickness of within a range of 0.8-1.2 mm on the non-user facing side of the cushion, such as 1 mm;
the lattice structure comprises one or more characteristics that vary along a length of the cushion, wherein in use the cushion receives a distributed load along said length of the cushion applied to the non-user facing side of the cushion, and wherein due to the variation in the one or more characteristics the cushion applies a different distributed load to the user's face along said length of the cushion;
the lattice structure comprises one or more characteristics that vary at and/or proximate a location corresponding to a sensitive facial feature on the user's face;
the variation of the one or more characteristics causes the cushion to apply less pressure on the sensitive facial feature in use than would be applied without the variation of the one or more characteristics;
the variation of the one or more characteristics causes the cushion to apply less pressure on the sensitive facial feature in use than the cushion applies to the user's face around the sensitive facial feature;
the variation of the one or more characteristics of the lattice structure results in lesser stiffness at and/or proximate the location corresponding to the sensitive facial feature;
the cushion comprises a recess configured to be aligned in use with a sensitive facial feature on the user's face, the recess shaped to receive the sensitive facial feature;
the recess is shaped to provide clearance between the cushion and the sensitive facial feature at least in an undeformed state;
the cushion comprises one or more force redistribution features configured to in use at least partially redirect forces received on the non-user facing side of the cushion in a region of the cushion aligned with the sensitive facial feature into one or more regions of cushion alongside or spaced from the sensitive facial feature;
the one or more force redistribution features comprises a beam structure within the cushion positioned to in use span from a first region of the cushion located on a first side of the sensitive facial feature through a second region of the cushion overlying the sensitive facial feature and into a third region of the cushion on a second side of the sensitive facial feature;
at least one of the one or more force redistribution features comprises a stiffened region within the cushion being stiffer than one or more adjacent regions within the cushion, the stiffened region being positioned to in use span from a first region of the cushion located on a first side of the sensitive facial feature through a second region of the cushion overlying the sensitive facial feature and into a third region of the cushion on a second side of the sensitive facial feature, the stiffened region being stiffened by a variation in one or more characteristics of the lattice structure at the stiffened region;
the variation in one or more characteristics of the lattice structure includes variation in shape, thickness, density, spacing, relative orientation and/or material of unit cells forming the lattice structure;
the cushion is stiffer proximate the user's face in the first region and in the third region than in the second region;
the user-facing side of the cushion is defined by unit cells of the lattice structure exposed to contact the face engaging flange;
the cushion comprises a uniform surface on the user-facing side of the cushion covering unit cells of the lattice structure; and/or
the uniform surface is integrally formed with unit cells of the lattice structure.

In further examples:
the face engaging flange comprises a cross sectional shape comprising a first end connected to the display unit housing in use, a second end and a face engaging region at which the face engaging flange contacts the user's face in use, wherein the face engaging flange curls between the first end and the second end to form an at least partially enclosed cross-section, the cushion being positioned within the at least partially enclosed cross-section;
the face engaging flange is shaped to curl towards the user's face between the first end and the face engaging region and is shaped to curl away from the user's face between the face engaging region and the second end;
between the face engaging region and the second end, the face engaging flange curls over a portion of the cushion;
the interfacing structure comprises a pair of cheek portions configured to engage the user's cheeks in use, a forehead portion configured to engage the user's forehead in use, and a pair of sphenoid portions located on respective lateral sides of the interfacing structure connecting between the forehead portion and the cheek portions and configured to engage the user's head proximate the sphenoid bone;
the face engaging flange forms at least one closed loop portion having an enclosed cross section;
the face engaging flange forms a pair of closed loop portions, each closed loop portion located in or medially adjacent to a respective cheek portion of the interfacing structure;
the face engaging flange forms a pair of open loop portions each having a partially open cross section, each open loop portion located in or laterally adjacent to a respective one of the cheek portions;
in each of the cheek portions the face engaging flange extends inferiorly from the first end of the face engaging flange and then posteriorly, superiorly, and anteriorly;
in the forehead portion the face engaging flange may extend superiorly from the first end of the face engaging flange and then posteriorly, inferiorly, and anteriorly;
the face engaging flange is formed from an elastomeric material;
the interfacing structure comprises a nasal portion between the cheek portions, the nasal portion configured to engage the user's nose in use and configured to at least partially block light from reaching the user's eyes from the user's nose region;
the nasal portion is attached to the cheek portions; and/or
the nasal portion comprises a pronasale portion configured to be positioned proximate the user's pronasale in use, and a first bridge portion and a second bridge portion extending at least partially posteriorly from the pronasale portion to engage the user's nose, the first bridge portion configured to bridge between one of the cheek portions and a first lateral side of the user's nose, and the second bridge portion configured to bridge between the other of the cheek portions and a second lateral side of the user's nose.

Another aspect of the present technology relates to an interfacing structure for a head-mounted display system, the interfacing structure configured to engage a user's face around at least a portion of a periphery of a user's eye region in use, the interfacing structure comprising:
a cushion at least partially formed by a lattice structure;
wherein the interfacing structure comprises a pair of cheek portions configured to engage the user's cheeks in use, a forehead portion configured to engage the user's forehead in use, and a pair of sphenoid portions located on respective lateral sides of the interfacing structure connecting between the forehead portion and the cheek portions and configured to engage the user's head proximate the sphenoid bone, the cushion being provided within each of the cheek portions, forehead portion and sphenoid portion; and
wherein the lattice structure comprises one or more characteristics that vary between locations corresponding to two or more of the cheek portions, forehead portion and sphenoid portions of the interfacing structure.

In some examples: (a) the cushion is formed in two or more parts; (b) the cushion is formed of unitary construction as a single part; (c) the one or more characteristics of the lattice structure that vary between locations include stiffness of the lattice structure; (d) the one or more characteristics of the lattice structure that vary include shape, thickness, density, spacing, relative orientation and/or material of unit cells forming the lattice structure; (e) the cushion is stiffer in the forehead portion and/or the cheek portions in comparison to the sphenoid portions; (f) the cushion is able to deform to accommodate anthropometric variation to a greater extent in the sphenoid portions than in the forehead portion and/or the cheek portions.

Another aspect of the present technology relates to an interfacing structure for a head-mounted display system, the interfacing structure configured to engage a user's face around at least a portion of a periphery of a user's eye region in use, the interfacing structure comprising:
a cushion at least partially formed by a lattice structure;
wherein the lattice structure comprises one or more characteristics that vary between a user-facing side of the cushion corresponding to a side of the interfacing structure configured to contact the user's face in use and a non-user facing side of the cushion corresponding to a side of the interfacing structure configured to face away from the user's face in use.

In examples:
the lattice structure comprises smaller unit cells on the user-facing side than on the non-user facing side;
the variation in the one or more characteristics of the lattice structure causes the cushion to be less stiff on the user-facing side of the cushion than on the non-user facing side of the cushion;
the material forming the unit cells of the lattice structure is thinner on the user-facing side of the cushion than on the non-user facing side of the cushion;
the material forming the unit cells of the lattice structure has a thickness within the range of 0.3-0.5mm on the user-facing side of the cushion;
the material forming the unit cells of the lattice structure has a thickness of within a range of 0.8-1.2mm on the non-user facing side of the cushion, such as 1 mm;
the cushion is formed flat and bent into a three-dimensional shape during assembly with the face engaging flange;
the cushion is formed in a three-dimensional shape;
the lattice structure is 3D printed;
the lattice structure is 3D printed in a shape corresponding to a unique user's face;
the lattice structure is injection moulded;
the lattice structure is formed from TPU;
the lattice structure is formed from silicone;
the cushion is formed from foam having holes therein forming the lattice structure;
the size, shape and/or spacing of the holes varies along a length of the cushion and/or between a first side of the cushion and a second side of the cushion;
the one or more characteristics of the lattice structure that vary include shape, thickness, density, spacing, relative orientation and/or material of unit cells forming the lattice structure;
the user-facing side of the cushion is defined by unit cells of the lattice structure exposed to contact the face engaging flange;
the cushion comprises a uniform surface on the user-facing side of the cushion covering unit cells of the lattice structure; and/or
the uniform surface is integrally formed with unit cells of the lattice structure.

Another aspect of the present technology relates to an interfacing structure for a head-mounted display system, the interfacing structure configured to engage a user's face around at least a portion of a periphery of a user's eye region in use, the interfacing structure comprising:
a cushion at least partially formed by a lattice structure;
wherein the cushion comprises a length lying in use along at least the portion of the periphery of the user's eye region,
wherein the lattice structure comprises one or more characteristics that vary along the length of the cushion.

In examples:
in use the cushion receives a distributed load along said length of the cushion applied to a non-user facing side of the cushion, and wherein due to the variation in the one or more characteristics the cushion applies a different distributed load to the user's face along said length of the cushion;
the variation of the one or more characteristics is at least at and/or proximate a location corresponding to a sensitive facial feature on the user's face;
the variation of the one or more characteristics causes the cushion to apply less pressure on the sensitive facial feature in use than would be applied without the variation of the one or more characteristics;
the variation of the one or more characteristics causes the cushion to apply less pressure on the sensitive facial feature in use than the cushion applies to the user's face around the sensitive facial feature;
the variation of the one or more characteristics of the lattice structure results in lesser stiffness in the cushion at and/or proximate the location corresponding to the sensitive facial feature;
the cushion comprises a recess configured to be aligned in use with a sensitive facial feature on the user's face, the recess shaped to receive the sensitive facial feature;
the recess is shaped to provide clearance between the cushion and the sensitive facial feature at least in an undeformed state;
the cushion comprises one or more force redistribution features configured to in use at least partially redirect forces received on the non-user facing side of the cushion in a region of the cushion aligned with the sensitive facial feature into one or more regions of cushion alongside or spaced from the sensitive facial feature;
the one or more force redistribution features comprises a beam structure within the cushion positioned to in use span from a first region of the cushion located on a first side of the sensitive facial feature through a second region of the cushion overlying the sensitive facial feature and into a third region of the cushion on a second side of the sensitive facial feature;
at least one of the one or more force redistribution features comprises a stiffened region within the cushion being stiffer than one or more adjacent regions within the cushion, the stiffened region being positioned to in use span from a first region of the cushion located on a first side of the sensitive facial feature through a second region of the cushion overlying the sensitive facial feature and into a third region of the cushion on a second side of the sensitive facial feature, the stiffened region being stiffened by a variation in one or more characteristics of the lattice structure at the stiffened region;
the variation in one or more characteristics of the lattice structure includes variation in shape, thickness, density, spacing, relative orientation and/or material of unit cells forming the lattice structure; and/or
the cushion is stiffer proximate the user's face in the first region and in the third region than in the second region.

Another aspect of the present technology relates to a head-mounted display system, comprising:
a head-mounted display unit comprising a display unit housing, a display and the interfacing structure according to any one or more of the aspects above, the interfacing structure being configured to connect to the display unit housing; and
a positioning and stabilising structure structured and arranged to hold the head-mounted display unit in an operable position on the user's head in use.

In another aspect of the disclosed technology, an interfacing structure for a head-mounted display system is configured to engage a user's face around at least a portion of a periphery of a user's eye region in use, the interfacing structure comprising a cushion shaped to conform to a user's face, in use.

In an example, the cushion includes a plurality of interconnected struts forming a plurality of voids.

In a further example, in use, when the interfacing structure is in engagement with the user's face, the struts are configured to flex thereby altering the size, shape and/or orientation of the voids to allow the cushion to conform to the user's face.

In further examples: (a) the struts are resilient; (b) a characteristic of the cushion varies across the cushion such that in a first portion of the cushion the characteristic is different than in a second portion of the cushion, the first portion of the cushion having a level of flexibility that is different than the second portion of the cushion; (c) the characteristic of the cushion is 1) a thickness of the struts, 2) a density of the struts, 3) an orientation of the struts, 4) a spacing of the struts, 5) a size of the voids, 6) an orientation of the voids, and/or 7) a density of the voids; (d) the thickness of the struts in a first portion of the cushion is different than the thickness of the struts in a second portion of the cushion; (e) the size of the voids in the first portion of the cushion is different than the size of the voids in the second portion of the cushion; (f) the first portion of the cushion corresponds to a sensitive facial feature of the user, and the second portion of the cushion does not correspond to a sensitive facial feature; (g) the sensitive facial feature is the user's nasal ridge; (h) the first portion of the cushion has greater flexibility as compared to the second portion of the cushion; and/or (i) the struts and voids form a lattice structure.

In further examples: (a) the cushion is not formed from a foam material; (b) the cushion is constructed from a foam material and has a plurality of macroscopic holes formed therein to form the voids; and/or (c) the user interfacing structure further comprises a face engaging portion covering the cushion and configured to directly engage the user's face in use.

In another aspect of the disclosed technology, as an alternative to a lattice structure, the interfacing structure includes a cushion resembling bubble wrap.

In another aspect of the disclosed technology, a interfacing structure includes a cushion having a plurality of bladders (e.g., air-filled bladders).

In a further example, a plurality of hinge portions is interspersed between the bladders such that each bladder is movable relative to an adjacent bladder via a hinge portion.

In a further example, the hinge portions are thinned regions (e.g., living hinges).

In a further example, a stiffness or flexibility of the plurality of bladders may vary from bladder to bladder. In a further example, the stiffness or flexibility may vary by adjusting the amount of fluid in each bladder.

In another aspect of the disclosed technology, an interfacing structure includes a cushion having a plurality of relatively flexible, relatively thin hinge portions interspersed between relatively stiff portions. In a further example, the hinge portions and the relatively stiff portions form a grid.

### 3.2 Automatic Sizing

One form of the present technology comprises automatic sizing of a Augmented Reality (AR)/ Virtual Reality (VR)/ Mixed Reality (MR) interfacing structure (also referred to as “facial interface” hereinafter) or cushion therefor without the assistance of a trained individual or others. References to sizing of an interfacing structure/facial interface are to be understood to also be applicable to sizing of components of said interfacing structure, such as a cushion formed from a lattice structure.

Another aspect of one form of the present technology is the automatic measurement of a subject's (e.g. a user's) facial features based on data collected from the user.

Another aspect of one form of the present technology is the automatic recommendation of a facial interface size based on a comparison between data collected from a user to a corresponding data record.

Another aspect of one form of the present technology is the automatic recommendation of a customized facial interface size based on a data collected from a user. The customized facial interface may be unique to a given user based on his/her facial geometry.

Another aspect of one form of the present technology is a mobile application that conveniently determines an appropriate facial interface size for a particular user based on a two-dimensional image.

Another aspect of one form of the present technology is a mobile application that conveniently determines an appropriate facial interface size for a particular user based on a three-dimensional image.

Some versions of the present technology include automated method(s) for selecting a facial interface according to facial interface size. The method(s) may operate in one or more processors. The method may include receiving image data captured by an image sensor. The captured image data may contain one or more facial features of an intended user of the facial interface in association with a predetermined reference feature having a known dimension. The method may include detecting one or more facial features of the user in the captured image data. The method may include detecting the predetermined reference feature in the captured image data. The method may include processing image pixel data of the image to measure an aspect of the one or more facial features detected in the image based on the predetermined reference feature. The method may include selecting a facial interface size from a group of standard facial interface sizes based on a comparison between the measured aspect of the one or more facial features and a data record relating sizing information of the group of standard facial interface sizes and the measured aspect of the one or more facial features.

In some versions, the aspect of the one or more facial features may include a distance between a sellion and supramenton of the user. The method may include calculating a value of the measured aspect based on a scaling factor derived from the reference feature. The method may include adjusting a value of the measured aspect with an anthropometric correction factor. The anthropometric correction factor may be calculated based on facial interface return data. The method may include calculating the scaling factor as a function of the known dimension of the predetermined reference feature and a detected pixel count for the detected reference feature. The predetermined reference feature may be a coin. The detecting the reference feature may include applying a cascade classifier to the captured image data. The method may include calculating a value of the measured aspect based on a scaling factor derived from the coin. The method may include calculating the scaling factor as a function of the known dimension of the coin in the captured image data and a detected pixel count for the coin that is detected. The detected pixel count for the coin that is detected may be a width of an ellipse fitted to the coin. The predetermined reference feature may be a cornea or iris of the user.

In some versions, the method may include, for image capture, displaying the reference feature on a display interface of a display device coupled with the image sensor. The display interface may include a targeting guide and a live action preview of content detected by the image sensor. The content may include the reference feature as displayed on the display interface. The method may include controlling capturing of the image data to satisfy at least one alignment condition. The at least one alignment condition may include detection of positioning of the reference feature of the live action preview within a box of the targeting guide. The at least one alignment condition may include detection of a tilt condition being within about +/−10 degrees of a superior-inferior extending axis. The at least one alignment condition may include detection of a tilt condition being within about +/−5 degrees of a superior-inferior extending axis. Detection of a tilt condition may be performed by reading an inertial measurement unit (IMU).

In some versions, the predetermined reference feature may be a QR code. Optionally, the processing image pixel data may include counting pixels. The method may include generating an automated electronic offer for purchase and/or automated shipment instructions for a facial interface based on the selected facial interface size. The method may include calculating an average of the measured aspect of the facial feature from a plurality of captured images of the one or more facial features. Optionally, the method may include automatic recommendation of a customized facial interface size based on a data collected from a user and the customized facial interface may be unique to a given user based on his/her facial geometry.

Some versions of the present technology include a system(s) for automatically recommending a facial interface size complementary to a particular user's facial features. The system(s) may include one or more servers. The one or more servers may be configured to communicate with a computing device over a network. The one or more servers may be configured to receive image data captured by an image sensor, where the captured image data may contain one or more facial features of an intended user of the facial interface in association with a predetermined reference feature having a known dimension. The one or more servers may be configured to detect one or more facial features of the user in the captured image data. The one or more servers may be configured to detect the predetermined reference feature in the captured image data. The one or more servers may be configured to process image pixel data of the image to measure an aspect of the one or more facial features detected in the image based on the predetermined reference feature. The one or more servers may be configured to select a facial interface size from a group of standard facial interface sizes based on a comparison between the measured aspect of the one or more facial features and a data record relating sizing information of the group of standard facial interface sizes and the measured aspect of the one or more facial features.

In some versions, the aspect of the one or more facial features may include a distance between a sellion and supramenton of the user. The one or more servers may be configured to calculate a value of the measured aspect based on a scaling factor derived from the reference feature. The one or more servers may be configured to adjust a value of the measured aspect with an anthropometric correction factor. The anthropometric correction factor may be calculated based on facial interface return data. The one or more servers may be configured to calculate the scaling factor as a function of the known dimension of the predetermined reference feature and a detected pixel count for the detected reference feature. The predetermined reference feature may include a coin. The one or more servers may be configured to detect the reference feature by applying a cascade classifier to the captured image data. The one or more servers may be further configured to calculate a value of the measured aspect based on a scaling factor derived from the coin. The one or more servers may be configured to calculate the scaling factor as a function of the known dimension of the coin in the captured image data and a detected pixel count for the coin that is detected. The detected pixel count for the coin that is detected may be a width of an ellipse fitted to the coin. The predetermined reference feature may be a cornea of the user.

In some versions, the system may include the computing device. The computing devices may be configured to, for image capture, generate a display of the reference feature on a display interface of a display device that may be coupled with the image sensor. The display interface may include a targeting guide and a live action preview of content detected by the image sensor. The content may include the reference feature as displayed on the display interface. The computing device may be further configured to control capturing of the image data to satisfy at least one alignment condition. The at least one alignment condition may include detection of positioning of the reference feature of the live action preview within a box of the targeting guide. The at least one alignment condition may include detection of a tilt condition being within about +/−10 degrees of a superior-inferior extending axis. The at least one alignment condition may include detection of a tilt condition being within about +/−5 degrees of a superior-inferior extending axis. The detection of a tilt condition may be performed by reading an inertial measurement unit (IMU).

In some versions, the predetermined reference feature may include a QR code. In some cases, to process image pixel data, the one or more servers may be configured to count pixels. The one or more servers may be configured to generate an automated electronic offer for purchase and/or automated shipment instructions for a facial interface based on the selected facial interface size. The one or more servers may be configured to calculate an average of the measured aspect of the facial feature from a plurality of captured images of the facial features. The one or more servers may be configured to communicate the selected facial interface size to the computing device over the network. Optionally, the server may be configured to automatically recommend a customized facial interface size based on a data collected from a user and the customized facial interface may be unique to a given user based on his/her facial geometry.

Some versions of the present technology include a system(s) for automatically recommending a facial interface size complementary to a particular user's facial features. The system(s) may include a mobile computing device. The mobile computing device may be configured to communicate with one or more servers over a network. The mobile computing device may be configured to receive captured image data of an image. The captured image data may contain one or more facial features of a user in association with a predetermined reference feature having a known dimension. The image data may be captured with an image sensor. The mobile computing device may be configured to detect one or more facial features of the user in the captured image data. The mobile computing device may be configured to detect the predetermined reference feature in the captured image data. The mobile computing device may be configured to process image pixel data of the image to measure an aspect of the one or more facial features detected in the image based on the predetermined reference feature. The mobile computing device may be configured to select a facial interface size from a group of standard facial interface sizes based on a comparison between the measured aspect of the one or more facial features and a data record relating sizing information of the group of standard facial interface sizes and the measured aspect of the one or more facial features.

In some versions, the aspect of the one or more facial features may include a distance between a sellion and supramenton of the user. The mobile computing device may be configured to calculate a value of the measured aspect based on a scaling factor derived from the reference feature. The mobile computing device may be further configured to adjust a value of the measured aspect with an anthropometric correction factor. The anthropometric correction factor may be calculated based on facial interface return data. The mobile computing device may be configured to calculate the scaling factor as a function of the known dimension of the predetermined reference feature and a detected pixel count for the detected reference feature. The predetermined reference feature may be a coin. The mobile computing device may be configured to detect the reference feature by applying a cascade classifier to the captured image data. The mobile computing device may be configured to calculate a value of the measured aspect based on a scaling factor derived from the coin. The mobile computing device may be configured to calculate the scaling factor as a function of the known dimension of the coin in the captured image data and a detected pixel count for the coin that is detected. The detected pixel count for the coin that is detected may be a width of an ellipse fitted to the coin. In some versions, the predetermined reference feature may be a cornea or iris of the user.

The mobile computing device may be configured to, for the image capture, generate a display of the reference feature on a display interface of a display device that may be coupled with the image sensor. The display interface may include a targeting guide and a live action preview of content detected by the image sensor. The content may include the reference feature as displayed on the display interface. The mobile computing device may be configured to control capturing of the image data to satisfy at least one alignment condition. The at least one alignment condition may include detection of positioning of the reference feature of the live action preview within a box of the targeting guide. The at least one alignment condition may include detection of a tilt condition being within about +/−10 degrees of a superior-inferior extending axis. The at least one alignment condition may include detection of a tilt condition being within about +/−5 degrees of a superior-inferior extending axis. Detection of a tilt condition may be performed by reading an inertial measurement unit (IMU).

In some versions, the predetermined reference feature may be a QR code. In some cases, to process image pixel data, the mobile computing device may be configured to count pixels. The mobile computing device may be configured to request an automated electronic offer for purchase and/or automated shipment instructions for an interface based on the selected facial interface size. The mobile computing device may be configured to calculate an average of the measured aspect of the facial feature from a plurality of captured images of the facial features. The mobile computing device may be configured to communicate the selected facial interface size to a server over the network. Optionally, the mobile phone may be configured to automatic recommend a customized facial interface size based on a data collected from a user, where the customized facial interface may be unique to a given user based on his/her facial geometry.

Some versions of the present technology include apparatus for automatically recommending a facial interface size complementary to a particular user's facial features. The apparatus may include means for receiving image data captured by an image sensor. The captured image data may contain one or more facial features of an intended user of the facial interface in association with a predetermined reference feature having a known dimension. The apparatus may include means for detecting one or more facial features of the user in the captured image data. The apparatus may include means for detecting the predetermined reference feature in the captured image data. The apparatus may include means for processing image pixel data of the image to measure an aspect of the one or more facial features detected in the image based on the predetermined reference feature. The apparatus may include means for selecting a facial interface size from a group of standard facial interface sizes based on a comparison between the measured aspect of the one or more facial features and a data record relating sizing information of the group of standard facial interface sizes and the measured aspect of the one or more facial features.

### 3.3 Personalisation

An aspect of one form of the present technology is a processor-implemented method for producing a lattice structure of a customised head-mounted display system component, the method comprising:
receiving, using communication circuitry, data representative of one or more landmark features of a head of a human;
identifying, using at least one processor, one or more landmark feature locations of the landmark features based on the data;
determining, using the at least one processor, a set of manufacturing specifications for production of the lattice structure of the head-mounted display system component based on the one or more landmark feature locations; and
controlling one or more manufacturing machines to produce the lattice structure of the head-mounted display system component based on the set of manufacturing specifications.

An aspect of one form of the present technology is a processor-implemented method for producing a lattice structure of a customised head-mounted display system component, the method comprising:
receiving, using communication circuitry, data representative of one or more landmark features of a head of a human;
identifying, using at least one processor, one or more landmark feature locations of the landmark features based on the data;
determining, using the at least one processor, a set of manufacturing specifications for production of the lattice structure of the head-mounted display system component based on the one or more landmark feature locations; and
causing one or more manufacturing machines to produce the lattice structure of the head-mounted display system component based on the set of manufacturing specifications.

In examples: (a) the data is representative of one or more landmark features of a head of an intended user of the head-mounted display system; (b) the data comprises image data; (c) at least a portion of the image data is captured by an image sensor (d) the method comprises the step of capturing at least a portion of the image data with an image sensor; I the data comprises two-dimensional image data; and/or (f) the data comprises three-dimensional image data.

In an example, causing one or more manufacturing machines to produce the lattice structure of the head-mounted display system component includes, controlling the one or more manufacturing machines to produce the lattice structure of the head-mounted display system component based on the set of manufacturing specifications.

In an example, the method is performed by a manufacturing system including the at least one processor and the communication circuitry.

In examples the method comprises; (a) the step of capturing at least a portion of the data with an image sensor; and/or (b) the step of identifying at least one relationship between two or more of the landmark feature locations, wherein determining the set of manufacturing specifications is based at least in part on the at least one relationship between the two or more of the landmark feature locations.

In examples identifying the at least one relationship between the two or more of the landmark feature locations comprises determining distance between two or more of: a subnasale, a sellion, a tragion, a posterior-most point of the head, a superior-most point of the head, a lateral-most point of the right orbital margin, a lateral-most point of the left orbital margin, an inferior-most point of the orbital margin, the Frankfort horizontal plane, and a coronal plane aligned with the tragion.

In examples identifying the at least one relationship between the two or more of the landmark feature locations comprises: (a) determining a distance in the sagittal plane between the subnasale and the tragion; (b) determining a vertical distance in the sagittal plane between the subnasale and the sellion; (c) determining a distance between the subnasale and the coronal plane aligned with the tragion, the distance being normal to said coronal plane; (d) determining a distance between the lateral-most point of the left or right orbital margin and the coronal plane aligned with the tragion, the distance being normal to said coronal plane; (e) determining a vertical distance between the subnasale and the superior-most point of the head; (f) determining a vertical distance between the superior-most point of the head and the Frankfort horizontal plane; (g) determining a distance between the rearmost point of the head and a coronal plane aligned with the tragion, the distance being normal to said coronal plane; and/or (h) determining a distance between the lateral-most points of the left and right orbital margins.

In examples: (a) the method comprises the step of determining at least one performance requirement for the lattice structure of the head-mounted display system component based on the one or more landmark feature locations; (b) the at least one performance requirement comprises one or more of: stiffness, contact pressure, compliance, a force to be applied by or to the component, elasticity, dimensions and positioning on the head; (c) the lattice structure of the head-mounted display system component comprises a plurality of regions, and at least one performance requirement is determined for each region; (d) the at least one performance requirement is determined based at least in part on properties of another component of the head-mounted display system intended for use with the customised head-mounted display system component; and/I(e) determining the set of manufacturing specifications is based at least in part on the at least one performance requirement.

In examples the set of manufacturing specifications comprises: (a) at least one material specification; (b) at least one construction technique specification; and/or (c) at least one dimension specification.

In examples, determining the set of manufacturing specifications comprises: (a) selecting the set of manufacturing specifications from a plurality of pre-existing sets of manufacturing specifications; (b) selecting the set of pre-existing manufacturing specifications is based on a comparison between the one or more landmark feature locations determined for the human, and one or more landmark feature locations associated with the set of pre-existing manufacturing specifications; and/or (c) selecting a plurality of manufacturing specifications to form the set of manufacturing specifications from a plurality of pre-existing manufacturing specifications.

In examples, the method comprises producing manufacturing machine programming instructions for production of the lattice structure of the head-mounted display system component based on the set of manufacturing specifications. In examples, producing the lattice structure of the head-mounted display system component comprises programming at least one manufacturing machine with the manufacturing machine programming instructions, and operating the at least one manufacturing machine according to the manufacturing machine programming instructions.

In examples: (a) producing the manufacturing machine programming instructions comprises generating a map representing the set of manufacturing specifications, and generating the manufacturing machine programming instructions based on the map; and/or (b) producing the manufacturing machine programming instructions comprises generating a model of the lattice structure of the head-mounted display system component based on the set of manufacturing specifications, and generating the manufacturing machine programming instructions based on the model.

In examples, producing the lattice structure of the head-mounted display system component comprises (a) additive manufacturing of the lattice structure; (b) 3D printing the lattice structure; (c) laser cutting the lattice structure; (d) knitting the lattice strucIe; (e) weaving the lattice structure; and/or (f) generating instructions for one or more manufacturing apparatuses configured to produce the lattice structure of controlling the one or more manufacturing apparatuses to produce the lattice structure based on the generated instructions.

In an example the head-mounted display system component comprises a cushion of an interfacing structure of the head-mounted display system.

An aspect of one form of the present technology is a system for producing a lattice structure of a customised head-mounted display system component, the system comprising:
one or more processors for receiving data representative of one or more landmark features of a human;
the one or more processors further configured to identify one or more landmark feature locations of the landmark features based on the data;
the one or more processors further configured to determine a set of manufacturing specifications for production of the lattice structure of the head-mounted display system component based on the one or more landmark feature locations; and
at least one manufacturing machine configured to produce the lattice structure of the head-mounted display system component based on the set of manufacturing specifications.

An aspect of one form of the present technology is a processor-implemented method performed by a processing system including at least one processor and communication circuitry for production of a lattice structure of a head-mounted display system component, the method comprising:
receiving, using the communication circuitry, data representative of one or more landmark features of a head of a human;
identifying, using the processing system, one or more landmark feature locations of the landmark features based on the data;
determining, using the processing system, a set of manufacturing specifications for production of the lattice structure of the head-mounted display system component based on the one or more landmark feature locations; and
communicating, using the communication circuitry, the set of manufacturing specifications to a manufacturing system comprising at least one manufacturing machine configured to produce the lattice structure of the head-mounted display system component based on the set of manufacturing specifications.

An aspect of one form of the present technology is a system for producing a lattice structure of a customised head-mounted display system component, the system comprising:
one or more processors for receiving data representative of one or more landmark features of a head of a human;
the one or more processors further configured to identify one or more landmark feature locations of the landmark features based on the data;
the one or more processors further configured to determine a set of manufacturing specifications for production of the lattice structure of the head-mounted display system component based on the one or more landmark feature locations; and
the one or more processors further configured to communicate the set of manufacturing specifications to a manufacturing system comprising at least one manufacturing machine configured to produce the lattice structure of the head-mounted display system component based on the set of manufacturing specifications.

An aspect of one form of the present technology is a processor-implemented method performed by a processing system including at least one processor and communication circuitry for production of a lattice structure of a head-mounted display system component, the method comprising:
receiving, using the communication circuitry, data representative of one or more landmark feature locations of landmark features of a head of a human;
determining, using the processing system, a set of manufacturing specifications for production of the lattice structure of the head-mounted display system component based on the one or more landmark feature locations; and
communicating, using the communication circuitry, the set of manufacturing specifications to a manufacturing system comprising at least one manufacturing machine configured to produce the lattice structure of the head-mounted display system component based on the set of manufacturing specifications.

An aspect of one form of the present technology is a system for producing a lattice structure of a customised head-mounted display system component, the system comprising:
one or more processors for receiving one or more landmark feature locations of landmark features of a head of a human, the one or more landmark feature locations identified from data representative of the one or more landmark features of the head;
the one or more processors further configured to determine a set of manufacturing specifications for production of the lattice structure of the head-mounted display system component based on the one or more landmark feature locations; and
the one or more processors further configured to communicate the set of manufacturing specifications to a manufacturing system comprising at least one manufacturing machine configured to produce the lattice structure of the head-mounted display system component based on the set of manufacturing specifications.

An aspect of one form of the present technology is a processor-implemented method for production of a lattice structure of a head-mounted display system component, the method comprising:
receiving, using communication circuitry, a set of manufacturing specifications for production of the lattice structure of the head-mounted display system component, wherein the set of manufacturing specifications are determined based on one or more landmark feature locations identified from data representative of one or more landmark features of a head of a human; and
controlling one or more manufacturing machines to produce the lattice structure of the head-mounted display system component using based on the set of manufacturing specifications.

An aspect of one form of the present technology is a processor-implemented method for production of a lattice structure of a head-mounted display system component, the method comprising:
receiving, using communication circuitry, a set of manufacturing specifications for production of the lattice structure of the head-mounted display system component, wherein the set of manufacturing specifications are determined based on one or more landmark feature locations identified from data representative of one or more landmark features of a head of a human; and
causing one or more manufacturing machines to produce the lattice structure of the head-mounted display system component using based on the set of manufacturing specifications.

In one example, causing one or more manufacturing machines to produce the lattice structure of the head-mounted display system component includes controlling the one or more manufacturing machines to produce the lattice structure of the head-mounted display system component.

An aspect of one form of the present technology is a system for producing a lattice structure of a customised head-mounted display system component, the system comprising:
one or more processors for receiving a set of manufacturing specifications for production of the lattice structure of the head-mounted display system component, wherein the set of manufacturing specifications are determined based on one or more landmark feature locations identified from data representative of one or more landmark features of a head of a human; and
at least one manufacturing machine configured to produce the lattice structure of the head-mounted display system component based on the set of manufacturing specifications.

An aspect of one form of the present technology is a processor-implemented method for production of a lattice structure of a head-mounted display system component, the method comprising:
obtaining, based on data received from a device using communication circuitry, information representative of one or more landmark feature locations for a human head;
determining, using at least one processor, a set of manufacturing specifications for production of the lattice structure of the head-mounted display system component based on the one or more landmark feature locations; and
causing one or more manufacturing machines to produce the lattice structure of the head-mounted display system component based on the set of manufacturing specifications.

An aspect of one form of the present technology is a system for producing a lattice structure of a head-mounted display system component, the system comprising:
one or more processors for obtaining information representative of one or more landmark feature locations for a human head;
the one or more processors further configured to determine a set of manufacturing specifications for production of the lattice structure of a head-mounted display system component based on the one or more landmark feature locations; and
the one or more processors further configured to produce the lattice structure of the head-mounted display system component based on the set of manufacturing specifications.

An aspect of one form of the present technology is an apparatus for producing a lattice structure of a head-mounted display system component, the apparatus comprising:
means for obtaining information representative of one or more landmark feature locations for a human's head;
means for determining a set of manufacturing specifications for production of the lattice structure of the head-mounted display system component based on the one or more landmark feature locations; and
means for producing the lattice structure of the head-mounted display system component based on the set of manufacturing specifications.

In examples, the head-mounted display system component comprises: (a) a cushion for an interfacing structure of the head-mounted display system.

Another form of the present technology comprises a cushion for a head-mounted display system produced by any one of the above methods and/or systems.

Another form of the present technology comprises a cushion for a head-mounted display system, the cushion comprising a lattice structure being formed by 3D printing based on instructions generated based on identification of facial landmarks and/or distances between said landmarks.

The methods, systems, devices and apparatus described may be implemented so as to improved stability, comfort, cost, ease of use and manufacturability of customized head-mounted display system and/or component thereof.

The methods, systems, devices and apparatus described may be implemented so as to improve the functionality of a processor, such as a processor of a specific purpose computer used to identify landmark features and/or their locations, identifying relationships between the landmark features, determining functional requirements (e.g., for a head-mounted display system and/or one or more components thereof), determining manufacturing specifications, and/or producing or generating manufacturing machine programmable instructions. Moreover, the described methods, systems, devices and apparatus can provide improvements in the technological field of automated generation of machine programming instructions for producing a customized head-mounted display system and/or component thereof. Moreover, the described methods systems, devices and apparatus provide increased flexibility in producing customized head-mounted display system and/or components thereof that will properly fit a user and provide the most stability, comfort, and/or faster production of the customized head-mounted display system and/or component thereof. Examples of the present technology provide customized head-mounted display system and/or component thereof faster than conventional methods (e.g., from the time they are requested) and/or with accuracy that cannot be provided by conventional methods, at least because a user, vendor and/or manufacturer cannot accurately consider and implement all of the factors that go into providing a customized head-mounted display system and/or component thereof with accuracy, improved stability, comfort and/or without significant cost and/or time.

Another form of the present technology comprises a head mounted display system for a person comprising:
a head-mounted display unit comprising a display;
a control system for operation of the head-mounted display system; and
a positioning and stabilizing structure configured to configured to hold the head-mounted display unit anterior to a user's eyes such that the display is viewable by the user in use.

The head-mounted display system may be helmet mounted, may be configured for virtual reality display, may be configured for augmented reality display, may be configured for mixed reality display.

Another form of the present technology comprises a head-mounted display system for a person comprising:
a head-mounted display unit comprising a display;
a control system for operation of the head-mounted display system; and
a positioning and stabilizing structure comprising an anterior support portion and a posterior support portion, wherein:
the posterior portion is configured to engage in use a posterior region of the person's head;
the anterior support portion comprises:
   a left lateral portion configured to interconnect the posterior support portion and the head-mounted display system; and
   a right lateral portion configured to interconnect the posterior portion and the head-mounted display system.

In some examples: a) the head mounted display apparatus further comprises a light shield; b) the light shield is constructed and arranged to substantially obstruct in use the receipt of ambient light upon an eye region of the person; c) the light shield is configured for use in virtual reality display; d) the head-mounted display system comprises an interfacing structure constructed and arranged to contact in use an eye region of the person's face; e) the interfacing structure is constructed from foam, silicone, and/or gel; f) the interfacing structure is constructed from a light absorbing material; and/or g) the interfacing structure is configured to function as a light shield.

In some examples: a) the head mounted display apparatus further comprises a sound system; b) a left ear transducer; and/or c) a right ear transducer.

In some examples: a) the head-mounted display unit comprises a binocular display unit; and/or b) the positioning and stabilizing structure is configured to maintain the binocular display unit in an operation position in use.

In some examples: a) the control system comprises a visual display controller and at least one battery; b) the at least one battery includes a first battery and a second battery; c) the first battery is a lower power system battery configured to power an RT clock; d) the second battery is a main battery; e) a battery support configured to retain the battery; f) the battery support is connected to the positioning and stabilizing structure using a tether; g) an orientation sensor configured to sense the orientation of the person's head in use; and/or h) a control support system.

In some examples: a) the positioning and stabilising structure comprises a frontal support portion configured to contact a region overlying a frontal bone of the person's head; and/or (b) the positioning and stabilising structure comprises a length adjustment mechanism for adjusting a length of a portion of the positioning and stabilising structure.

Another form of the present technology comprises a head mounted display apparatus for a person comprising: a display unit; a light shield; a control system comprising a visual display controller, at least one battery, a battery support, an orientation sensor, and a control support system; a sound system; and a positioning and stabilizing structure comprising an anterior portion, a frontal portion, a left lateral portion, a right lateral portion, a posterior portion, and a length adjustment mechanism, wherein: the anterior portion comprises an eye cushion constructed and arranged to contact in use an eye region of the user; the posterior portion is configured to engage in use a region of the person's head adjacent to a junction between the occipital bone and the trapezius muscle; the left lateral portion is configured to interconnect the anterior portion and the posterior portion; the right lateral portion is configured to interconnect the anterior portion and the posterior portion; the frontal portion configured to interconnect the anterior portion and the posterior portion; and the length adjustment mechanism adjustable to a first position and to a second position; wherein: the display unit comprises a binocular display unit; the light shield is constructed and arranged to substantially obstruct in use the receipt of ambient light upon an eye region of the person; the orientation sensor configured to sense the orientation of the person's head in use the sound system comprises a left ear transducer and a right ear transducer; and the positioning and stabilizing structure is configured to maintain the binocular display unit in an operational position in use. The head-mounted display apparatus may comprise a positioning and stabilising structure and/or an interfacing structure substantially as described in any example disclosed herein.

Another form of the present technology comprises a head mounted display interface comprising:
an electronic display screen configured to output multiple images to a user;
a display housing configured to at least partially house the electronic display screen; and
a positioning and stabilizing structure coupled to the display housing and supporting the display housing and the electronic display screen in an operating position, the positioning and stabilizing structure being configured to provide a force against a user's head in order to counteract a moment produced by a combined weight of the electronic display screen and the display housing, and maintain a position of the electronic display screen anterior to the user's eyes while in the operating position;
wherein the positioning and stabilising structure is substantially as described in any example disclosed herein.

Another form of the present technology comprises a positioning and stabilizing structure for supporting an electronic display screen of a head-mounted display interface, the positioning and stabilizing structure being configured to provide a force against a user's head in order to counteract a moment produced by a weight of the electronic display screen, and maintain a position of the electronic display screen anterior to the user's eyes while in use, the positioning and stabilizing structure comprising:
a rear strap configured to contact a region of the user's head posterior to the coronal plane of the user's head, the rear strap configured to anchor the head-mounted display interface to the user's head.

Another form of the present technology comprises a positioning and stabilizing structure for supporting an electronic display unit, the positioning and stabilizing structure being configured to provide a force against a user's head in order to counteract a moment produced by a weight of the electronic display unit, and maintain a position of the electronic display unit anterior to the user's eyes while in use, the positioning and stabilizing structure comprising:
headgear configured to be coupled to a housing of the electronic display unit and engage the user's head in order to support the housing.

Another aspect of the present technology comprises a display interface comprising:
a display screen configured to output a computer generated image observable by a user;
a display housing at least partially supporting the display screen; an interfacing structure coupled to the display screen and/or the display housing, the interfacing structure configured to be positioned and/or arranged to conform to at least a portion of the user's face;
a positioning and stabilizing structure configured to maintain a position of the display screen and/or the display housing relative to the user's eyes, the positioning and stabilizing structure configured to provide a force against a user's head in order to counteract a moment produced by a weight of the display screen and/or the display housing; and
a control system configured to assist in controlling the computer generated image observable by the user, the control system including at least one sensor.

Another aspect of the present technology comprises a virtual reality display interface comprising:
a display screen configured to output a computer generated image observable by a user;
a display housing at least partially supporting the display screen;
an interface structure coupled to the display housing, the interfacing structure configured to be positioned and/or arranged to conform to at least a portion of a user's face, the interface structure including a light shield configured to at least partially block ambient light from reaching the user's eyes;
a positioning and stabilizing structure coupled to the display housing and configured to provide a force against a user's head in order to counteract a moment produced by a weight of the display screen and/or the display housing, the positioning and stabilizing structure comprising,
   a pair of temporal connectors, each temporal connector of the pair of temporal connectors being directly coupled to the display housing, each temporal connector configured to overlay a respective temporal bone when in contact the user's head, and
   a rear support coupled to each of the temporal connectors, the rear support configured to contact a posterior portion of the user's head; and
a control system configured to assist in controlling the computer generated image observable by the user, the control system including at least one sensor configured to measure movement of the user.

In some forms, the light shield is configured to seal against the user's face and prevent ambient light from reaching the user's eyes.

In some forms, the display screen is completely enclosed within the display housing.

In some forms, the light shield is constructed from an opaque material.

In some forms, the interfacing structure is constructed from a resilient material.

In some forms, the positioning and stabilizing structure includes a rotational control configured to allow the display housing and/or the display interface to pivot relative to the rear support.

For example, the temporal arms may rotate with the display housing and/or the display interface. In other examples, the rotational control may couple the display housing to each of the temporal connectors, so that the display housing and/or the display interface pivots relative to the temporal connectors.

In some forms, the temporal connectors may include an adjustable length.

Another aspect of the present technology comprises an augmented reality display interface comprising:
a display screen configured to output a computer generated image observable by a user, the display screen including at least one optical lens constructed from a transparent and/or translucent material configured to allow a user to observe their physical environment while observing the computer generated image;
a display housing at least partially supporting the display screen;
an interface structure coupled to the display housing and/or the display interface, the interfacing structure configured to be positioned and/or arranged to conform to at least a portion of a user's face;
a positioning and stabilizing structure coupled to the display housing and configured to provide a force against a user's head in order to counteract a moment produced by a weight of the display screen and/or the display housing, the positioning and stabilizing structure comprising,
a pair of temporal connectors, each temporal connector of the pair of temporal connectors being directly coupled to the display housing, each temporal connector configured to overlay a respective temporal bone when in contact the user's head; and
a control system configured to assist in controlling the computer generated image observable by the user, the control system including at least one sensor configured to measure movement of the user.

In some forms, the positioning and stabilizing structure further includes a rear support configured to overlay the user's occiput, each temporal connector coupled to the rear support.

In some forms, the augmented reality display interface further comprises a power source coupled to the display interface and/or to the positioning and stabilizing structure.

For example, the power source may be a rechargeable battery.

In some forms, the display screen configured to selectively output a computer generated image observable by a user.

For example, the computer generated image may be displayed on the transparent and/or translucent material. The user may be able to see observe their physical environment regardless of whether the computer generated image is displayed on the transparent and/or translucent material.

Another aspect of the present technology comprises a virtual reality display interface comprising examples of the aspects of the head-mounted display system described above.

In examples of the aspects of the head-mounted display system described above, the display unit comprises a display configured to selectively output computer generated images that are visible to the user in an operational position.

In examples of the aspects of the head-mounted display system described above, the display unit comprises a housing.

In some forms, the housing supports a display.

In examples of the aspects of the head-mounted display system described above, the display unit comprises an interfacing structure coupled to the housing and arranged to be in opposing relation with the user's face in the operational position.

In some forms, the interfacing structure at least partially forms a viewing opening configured to at least partially receive the user's face in the operational position.

In some forms, the interfacing structure being constructed at least partially from an opaque material configured to at least partially block ambient light from reaching the viewing opening in the operational position.

In examples of the aspects of the head-mounted display system described above, the display unit comprises at least one lens coupled to the housing and disposed within the viewing opening and aligned with the display so that in the operational position.

In some forms, the user can view the display through the at least one lens.

In examples of the aspects of the head-mounted display system described above, a control system having at least one sensor in communication with a processor.

In some forms, the at least one sensor configured to measure a parameter and communicate a measured value to the processor.

In some forms, the processor configured to change the computer generated images output by the display based on the measured value.

Another aspect of the present technology comprises an augmented reality display interface comprising examples of the aspects of the head-mounted display system described above.

In examples of the aspects of the head-mounted display system described above, the display unit comprises a display constructed from a transparent or translucent material and configured to selectively provide computer generated images viewable by the user.

In examples of the aspects of the head-mounted display system described above, the display unit comprises a housing.

In some forms, the housing that supports a display.

In examples of the aspects of the head-mounted display system described above, the display unit comprises an interfacing structure coupled to the housing and arranged to be in opposing relation with the user's face in the operational position.

In examples of the aspects of the head-mounted display system described above, in an operational position, the positioning and stabilizing structure configured to support the display unit.

In examples of the aspects of the head-mounted display system described above, the display configured to be aligned with the user's eyes in an operation position such that the user may at least partially view a physical environment through the display regardless of the computer generated images output by the display.

In examples of the aspects of the head-mounted display system described above, the head-mounted display system further comprising a control system having at least one sensor in communication with a processor.

In some forms, the at least one sensor configured to measure a parameter and communicate a measured value to the processor.

In some forms, the processor configured to change the computer generated images output by the display based on the measured value.

In some forms, the at least one lens includes a first lens configured to be aligned with the user's left eye in the operational position and a second lens configured to be aligned with the user's right eye in the operational position

In some forms, the first lens and the second lens are Fresnel lenses.

In some forms, the display comprises a binocular display partitioned into a first second and a second section, the first section aligned with the first lens and the second section aligned with the second lens.

In some forms, a controller having at least one button selectively engageable by a user's finger, the controller being in communication with the processor and configured to send a signal to the processor when the at least one button is engaged, the processor configured to change the computer generated images output by the display based on the signal.

In some forms, the at least one lens includes a first lens configured to be aligned with the user's left eye in the operational position and a second lens configured to be aligned with the user's right eye in the operational position.

Another aspect of one form of the present technology is a positioning and stabilizing structure that is constructed with a shape which is complementary to that of an intended wearer.

Another aspect of one form of the present technology is an interfacing structure that is constructed with a shape which is complementary to that of an intended wearer.

An aspect of one form of the present technology is a method of manufacturing apparatus.

An aspect of certain forms of the present technology is a positioning and stabilizing structure that is easy to use, e.g. by a person who has limited dexterity, vision or by a person with limited experience in using a head-mounted display.

An aspect of certain forms of the present technology is an interfacing structure that is easy to use, e.g. by a person who has limited dexterity, vision or by a person with limited experience in using a head-mounted display.

The methods, systems, devices and apparatus described may be implemented so as to improve the functionality of a head-mounted display, such as an electronic display or computer. Moreover, the described methods, systems, devices and apparatus can provide improvements in the technological field of virtual reality, augmented reality, and/or mixed reality.

Of course, portions of the aspects may form sub-aspects of the present technology. Also, various ones of the sub-aspects and/or aspects may be combined in various manners and also constitute additional aspects or sub-aspects of the present technology.

Other features of the technology will be apparent from consideration of the information contained in the following detailed description, abstract, drawings and claims.

### 4 BRIEF DESCRIPTION OF THE DRAWINGS

The present technology is illustrated by way of example, and not by way of limitation, in the figures of the accompanying drawings, in which like reference numerals refer to similar elements including:

### 4.1 Head-Mounted Display Systems

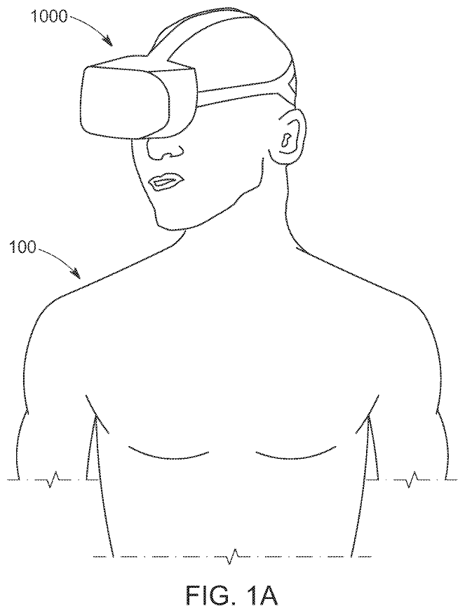

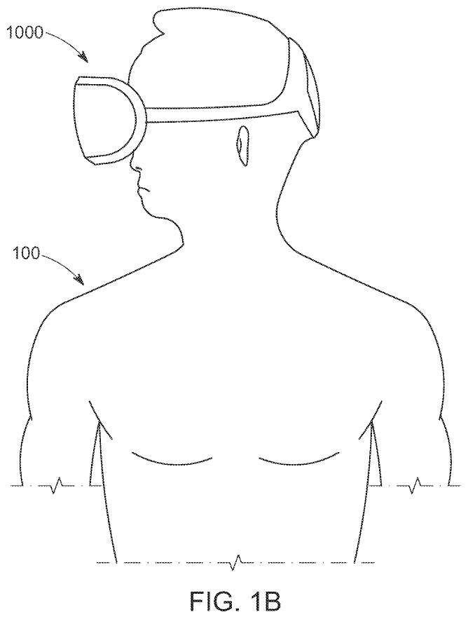

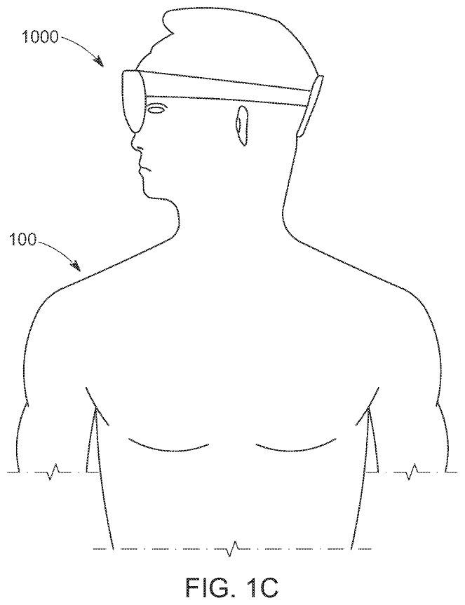

FIG. 1A shows a system including a user 100 wearing a head-mounted display system 1000, in the form of a face-mounted, virtual reality (VR) headset, displaying various images to the user 100. The user is standing while wearing the head-mounted display system 1000.

FIG. 1B shows a system including a user 100 wearing a head-mounted display system 1000, in the form of a floating virtual reality (VR) headset, displaying various images to the user. The user is sitting while wearing the display interface 100.

FIG. 1C shows a system including a user 100 wearing a head-mounted display system 1000, in the form of a floating augmented reality (AR) headset, displaying various images to the user. The user is standing while wearing the head-mounted display system 1000.

### 4.2 Display System and Facial Anatomy

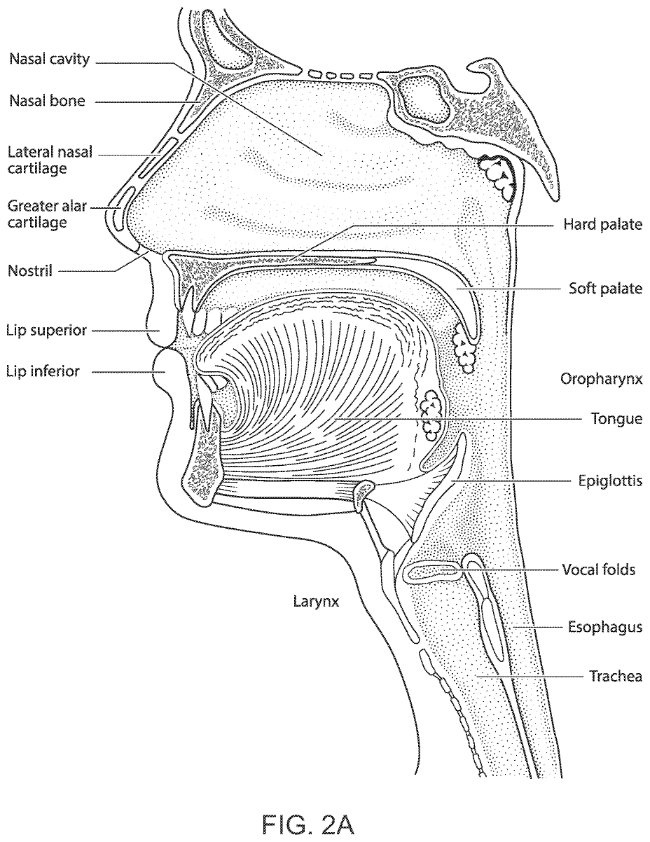

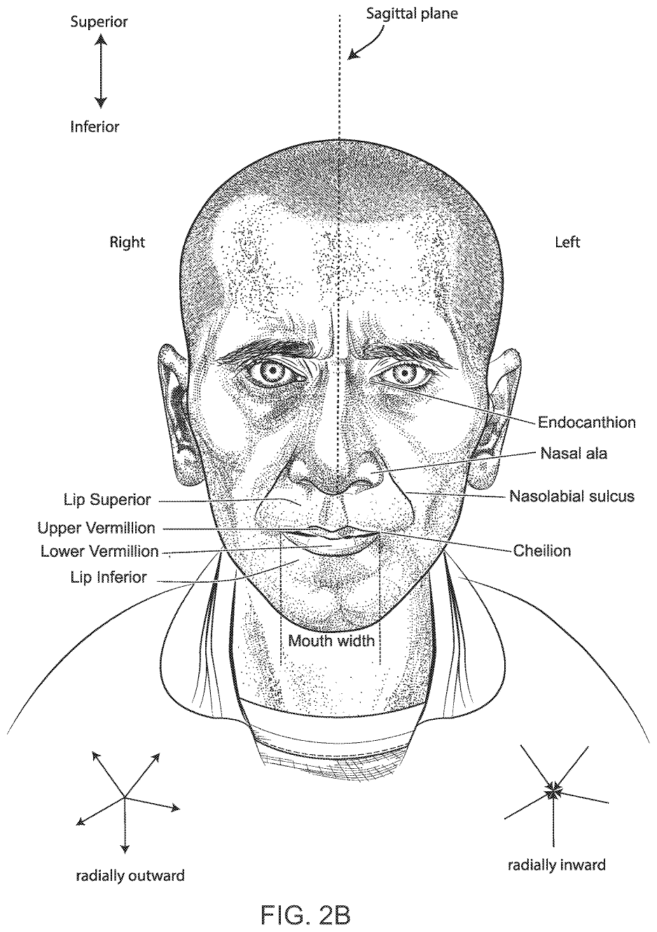

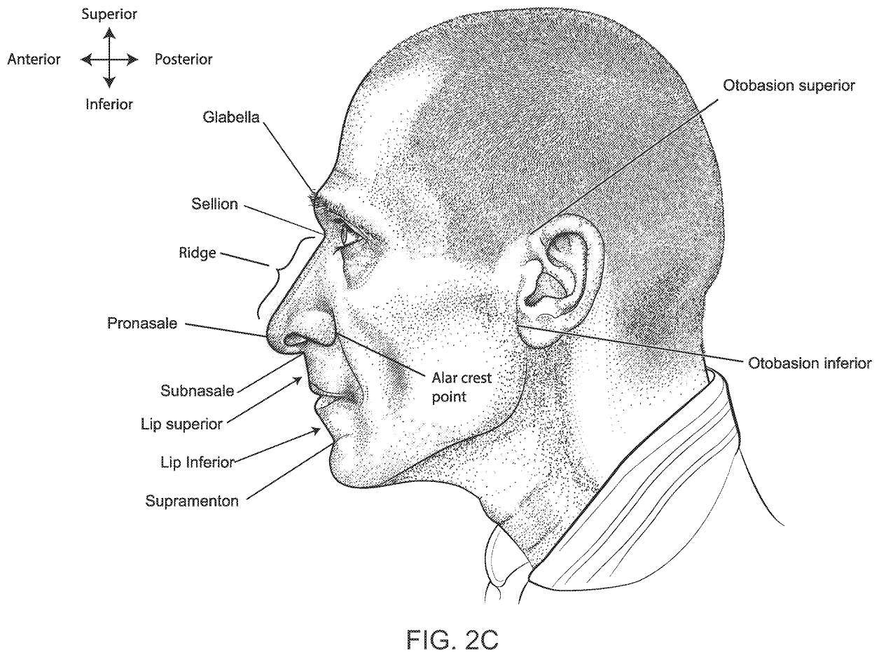

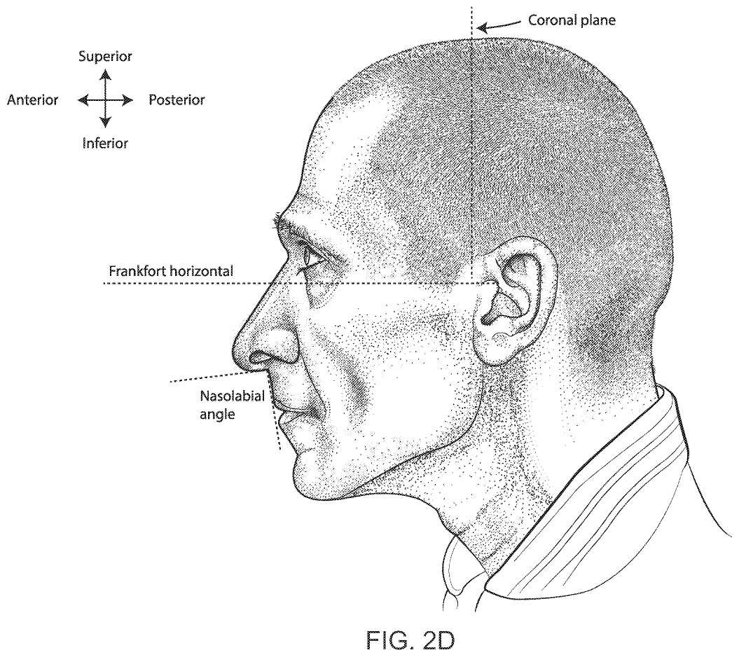

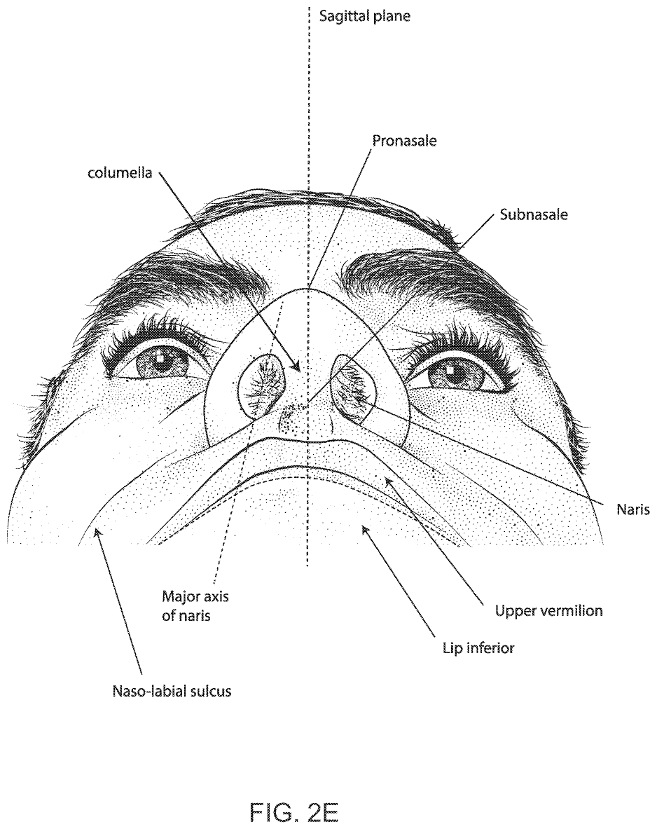

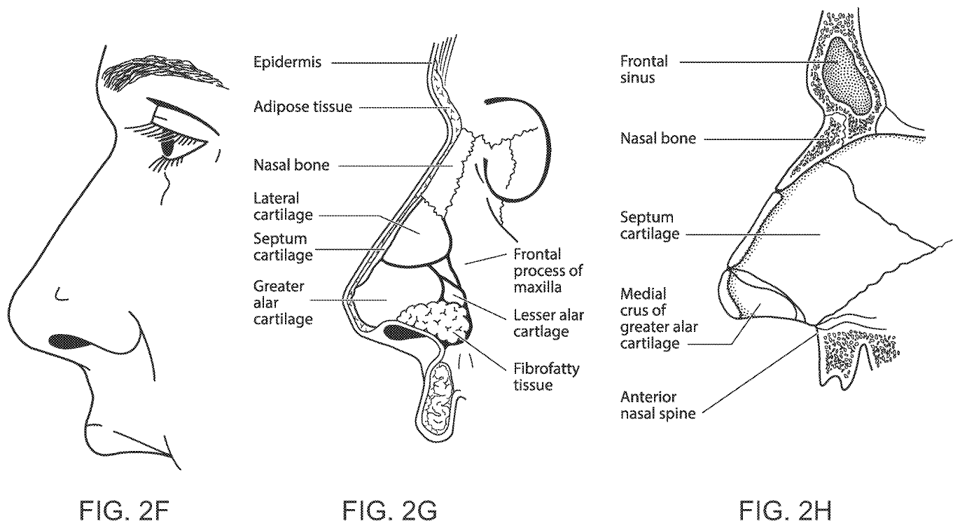

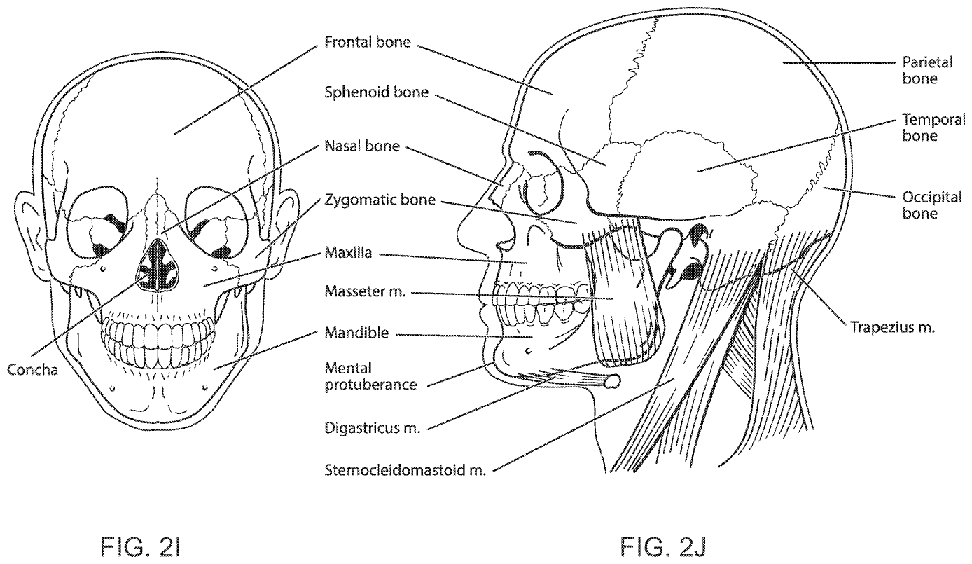

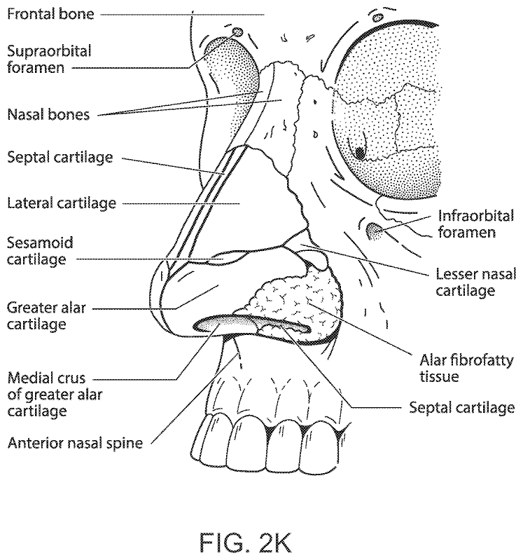

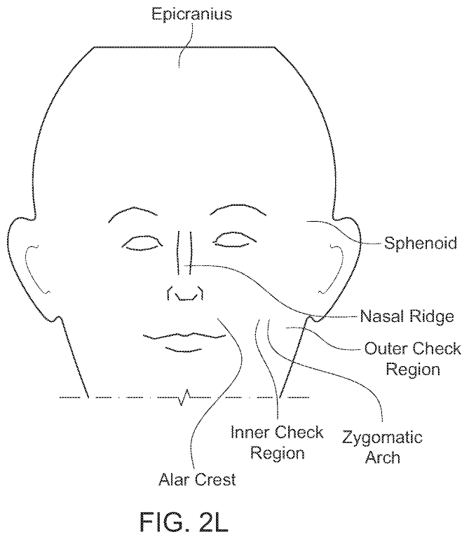

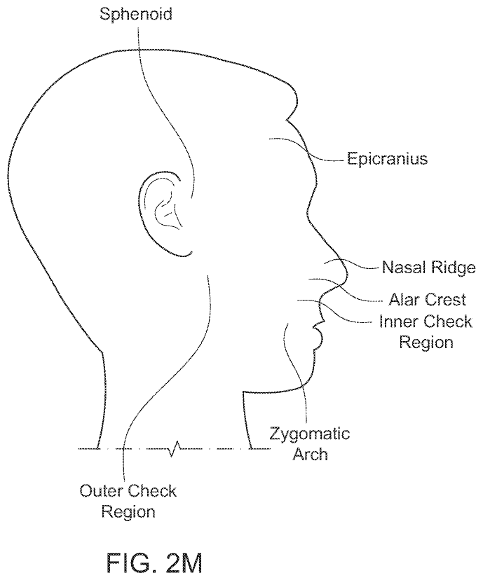

FIG. 2A shows a view of a human upper airway including the nasal cavity, nasal bone, lateral nasal cartilage, greater alar cartilage, nostril, lip superior, lip inferior, larynx, hard palate, soft palate, oropharynx, tongue, epiglottis, vocal folds, oesophagus and trachea.

FIG. 2B is a front view of a face with several features of surface anatomy identified including the lip superior, upper vermilion, lower vermilion, lip inferior, mouth width, endocanthion, a nasal ala, nasolabial sulcus and cheilion. Also indicated are the directions superior, inferior, radially inward and radially outward.

FIG. 2C is a side view of a head with several features of surface anatomy identified including glabella, sellion, pronasale, subnasale, lip superior, lip inferior, supramenton, nasal ridge, alar crest point, otobasion superior and otobasion inferior. Also indicated are the directions superior & inferior, and anterior & posterior.

FIG. 2D is a further side view of a head. The approximate locations of the Frankfort horizontal and nasolabial angle are indicated. The coronal plane is also indicated.

FIG. 2E shows a base view of a nose with several features identified including naso-labial sulcus, lip inferior, upper Vermilion, naris, subnasale, columella, pronasale, the major axis of a naris and the midsagittal plane.

FIG. 2F shows a side view of the superficial features of a nose.

FIG. 2G shows subcutaneal structures of the nose, including lateral cartilage, septum cartilage, greater alar cartilage, lesser alar cartilage, sesamoid cartilage, nasal bone, epidermis, adipose tissue, frontal process of the maxilla and fibrofatty tissue.

FIG. 2H shows a medial dissection of a nose, approximately several millimeters from the midsagittal plane, amongst other things showing the septum cartilage and medial crus of greater alar cartilage.

FIG. 2I shows a front view of the bones of a skull including the frontal, nasal and zygomatic bones. Nasal concha are indicated, as are the maxilla, and mandible.

FIG. 2J shows a lateral view of a skull with the outline of the surface of a head, as well as several muscles. The following bones are shown: frontal, sphenoid, nasal, zygomatic, maxilla, mandible, parietal, temporal and occipital. The mental protuberance is indicated. The following muscles are shown: digastricus, masseter, sternocleidomastoideod trapezius.

FIG. 2K shows an anterolateral view of a nose. The following bones are shown: frontal, supraorbital foramen, nasal, septal cartilage, lateral cartilage, orbit and infraorbital foramen.

FIG. 2L shows another front view of the face with several features of surface anatomy identified including the epicranius, the sphenoid, the nasal ridge, the outer and inner cheek regions, the zygomatic arch, and the alar crest.

FIG. 2M shows another side view of the face with several features of surface anatomy identified including the epicranius, the sphenoid, the nasal ridge, the outer and inner cheek regions, the zygomatic arch, and the alar crest.

### 4.3 Shape Of Structures

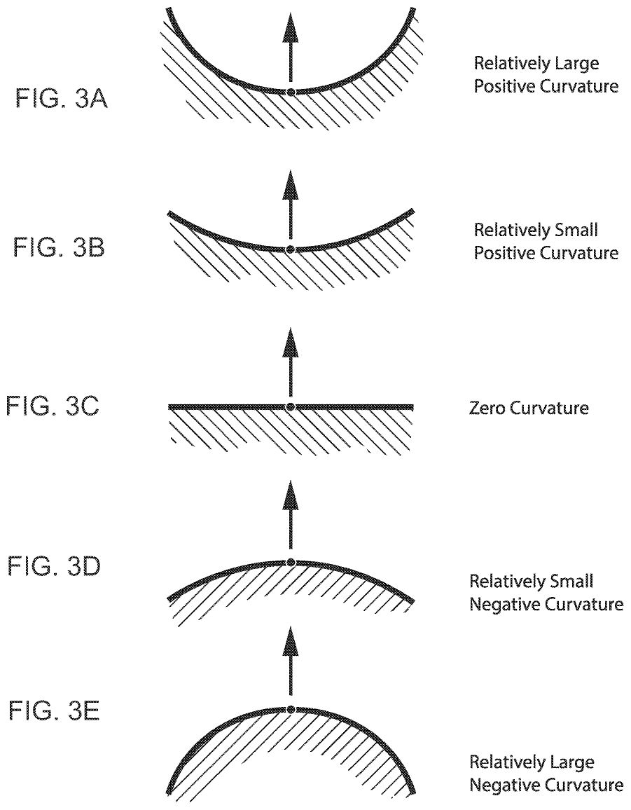

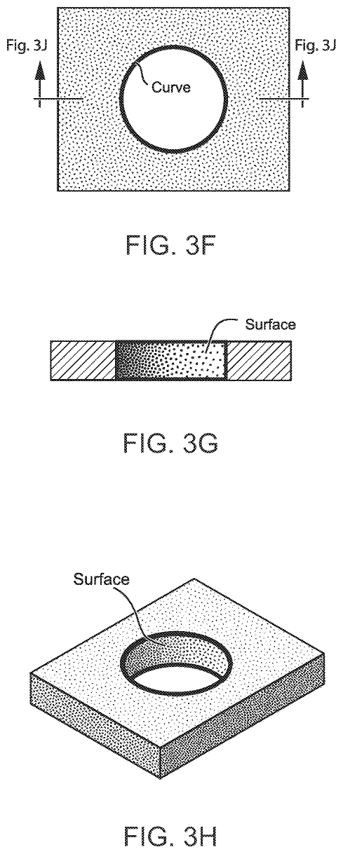

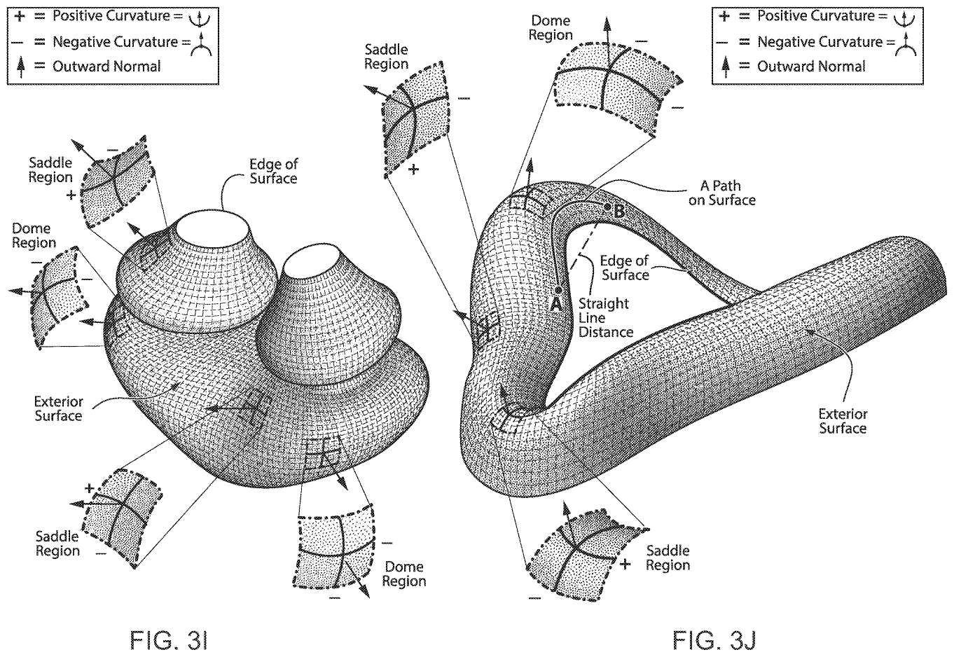

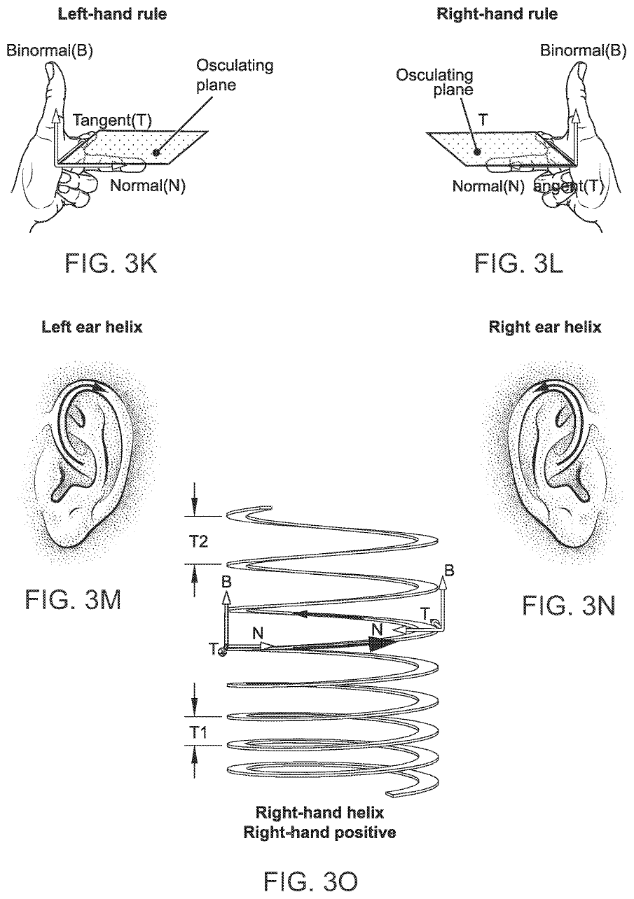

FIG. 3A shows a schematic of a cross-section through a structure at a point. An outward normal at the point is indicated. The curvature at the point has a positive sign, and a relatively large magnitude when compared to the magnitude of the curvature shown in FIG. 3B.

FIG. 3B shows a schematic of a cross-section through a structure at a point. An outward normal at the point is indicated. The curvature at the point has a positive sign, and a relatively small magnitude when compared to the magnitude of the curvature shown in FIG. 3A.

FIG. 3C shows a schematic of a cross-section through a structure at a point. An outward normal at the point is indicated. The curvature at the point has a value of zero.

FIG. 3D shows a schematic of a cross-section through a structure at a point. An outward normal at the point is indicated. The curvature at the point has a negative sign, and a relatively small magnitude when compared to the magnitude of the curvature shown in FIG. 3E.

FIG. 3E shows a schematic of a cross-section through a structure at a point. An outward normal at the point is indicated. The curvature at the point has a negative sign, and a relatively large magnitude when compared to the magnitude of the curvature shown in FIG. 3D.

FIG. 3F shows the surface of a structure, with a one dimensional hole in the surface. The illustrated plane curve forms the boundary of a one dimensional hole.

FIG. 3G shows a cross-section through the structure of FIG. 3F. The illustrated surface bounds a two dimensional hole in the structure of FIG. 3F.

FIG. 3H shows a perspective view of the structure of FIG. 3F, including the two dimensional hole and the one dimensional hole. Also shown is the surface that bounds a two dimensional hole in the structure of FIG. 3F.

FIGS. 3I-3J shows a seal forming structure. An exterior surface of the cushion is indicated. An edge of the surface is indicated. A path on the surface between points A and B is indicated. A straight-line distance between A and B is indicated. Two saddle regions and a dome region are indicated.

FIG. 3K illustrates a left-hand rule.

FIG. 3L illustrates a right-hand rule.

FIG. 3M shows a left ear, including the left ear helix.

FIG. 3N shows a right ear, including the right ear helix.

FIG. 3O shows a right-hand helix.

### 4.4 Head-Mounted Virtual Reality Display

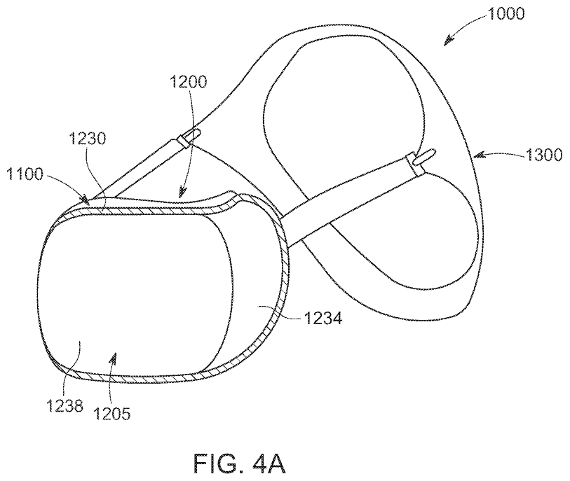

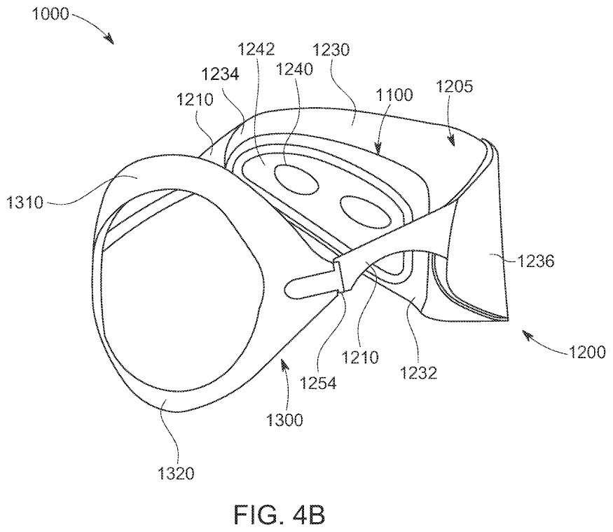

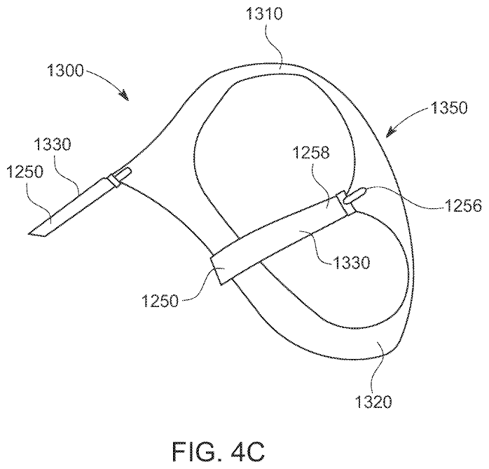

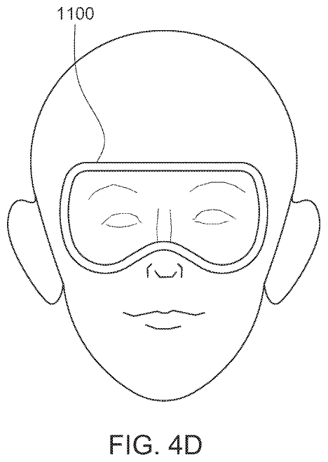

FIG. 4A shows a front perspective view of a head-mounted display interface in accordance with one form of the present technology.

FIG. 4B shows a rear perspective view of the head-mounted display of FIG. 4A.

FIG. 4C shows a perspective view of a positioning and stabilizing structure used with the head-mounted display of FIG. 4A.

FIG. 4D shows a front view of a user's face, illustrating a location of an interfacing structure, in use.

### 4.5 Head-Mounted Augmented Reality Display

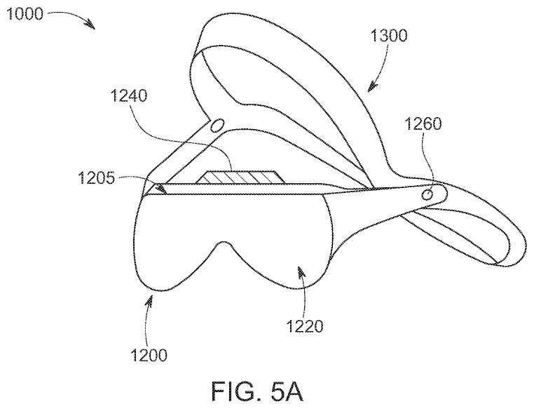

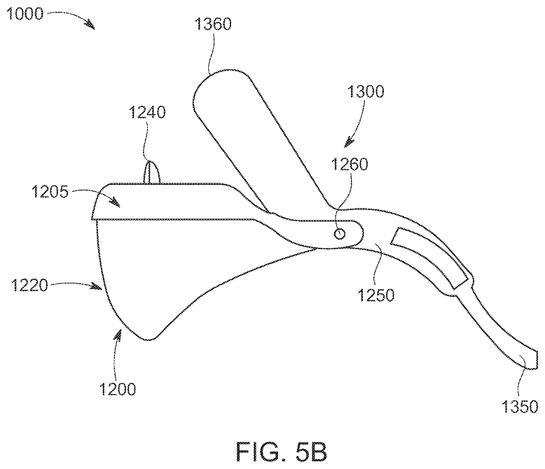

FIG. 5A shows a front perspective view of a head-mounted display interface in accordance with one form of the present technology.

FIG. 5B shows a side view of the head-mounted display interface of FIG. 5A.

### 4.6 Controls

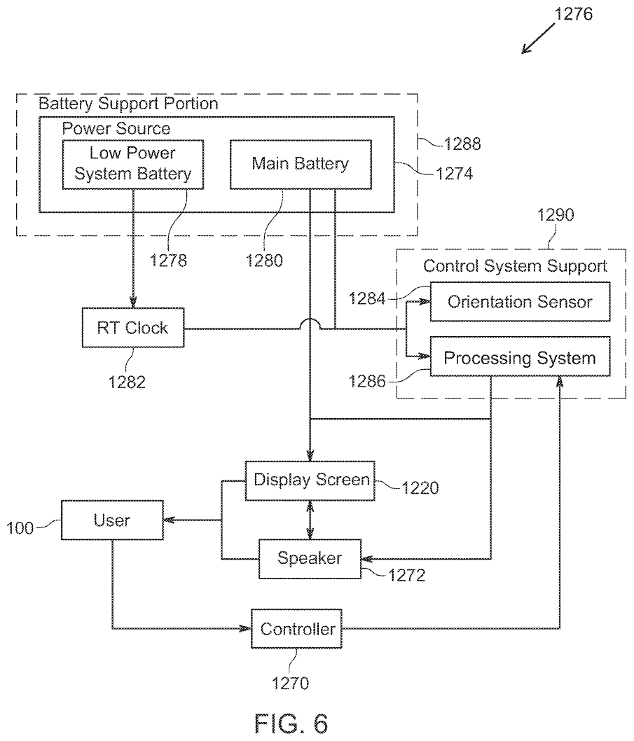

FIG. 6 shows a schematic view of a control system of one form of the present technology.

### 4.7 Automatic Sizing

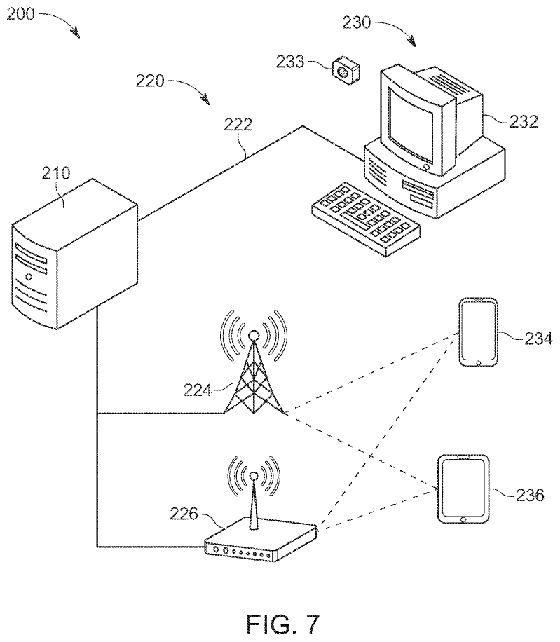

FIG. 7 is a diagram of an example system for automatically sizing a facial interface which includes a computing device.

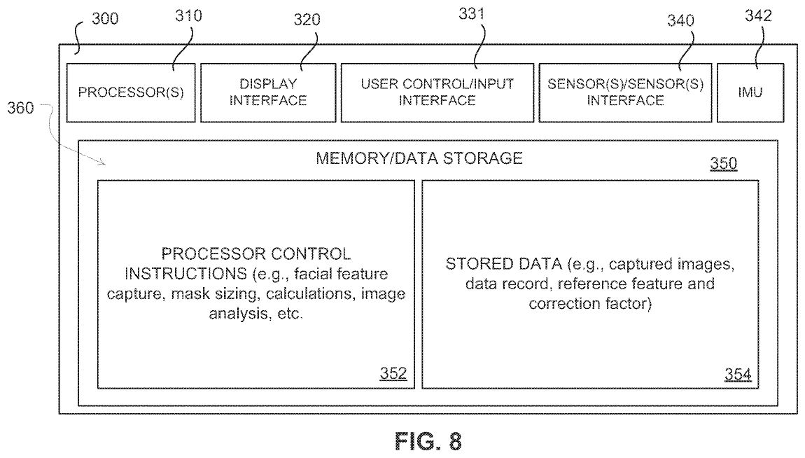

FIG. 8 is a block diagram of an example architecture of a computing device for the system of FIG. 7 including example components suitable for implementing the methodologies of the present technology.

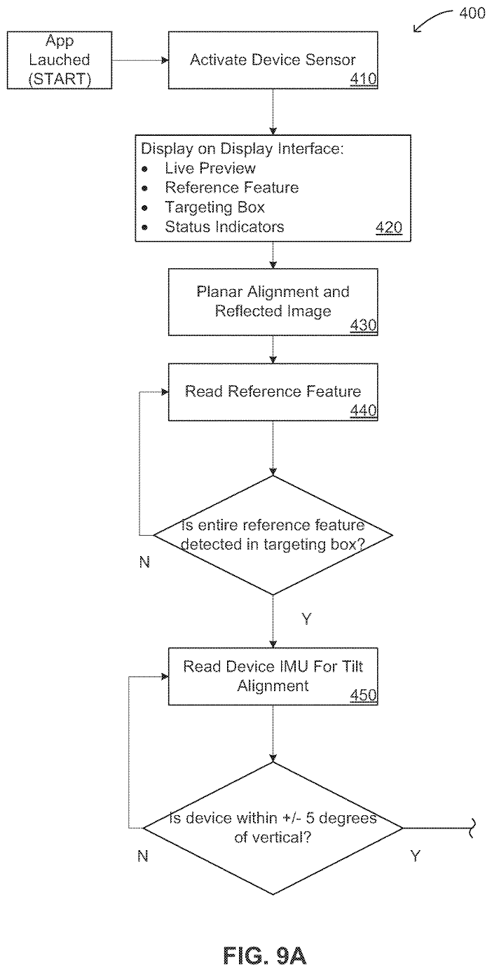

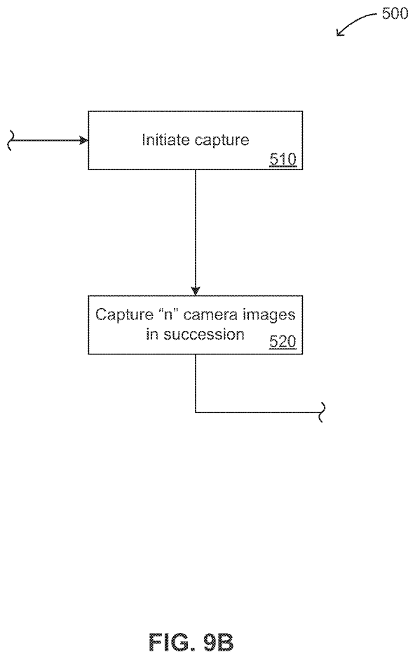

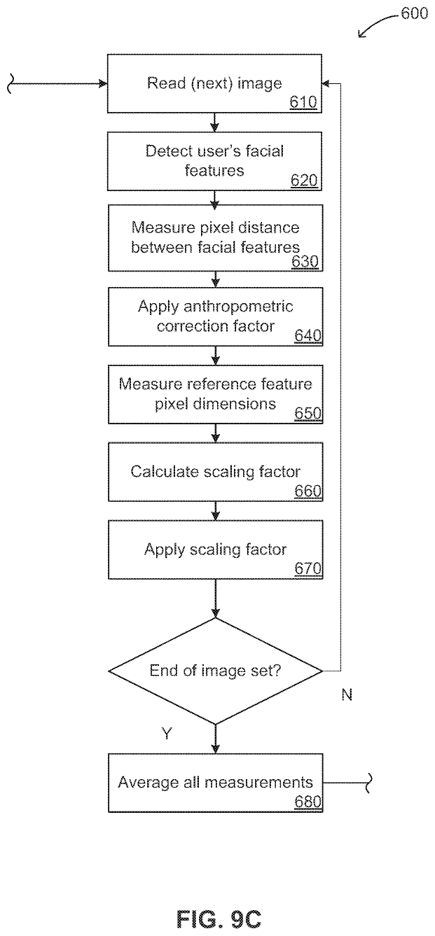

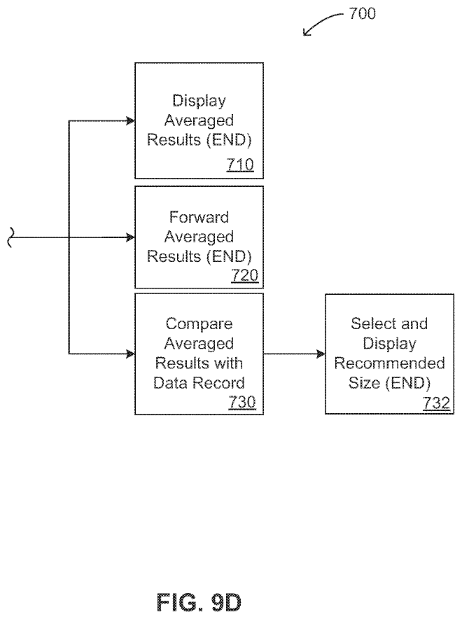

FIG. 9A is a flow diagram of a pre-capture phase method of an example version of the present technology.

FIG. 9B is a flow diagram of a capture phase method of some versions of the present technology.

FIG. 9C is a flow diagram of a post-capture image processing phase method of some versions of the present technology.

FIG. 9D is a flow diagram of a comparison and output phase method of some versions of an exemplary method embodiment of the present technology.

### 4.8 Interfacing Structures

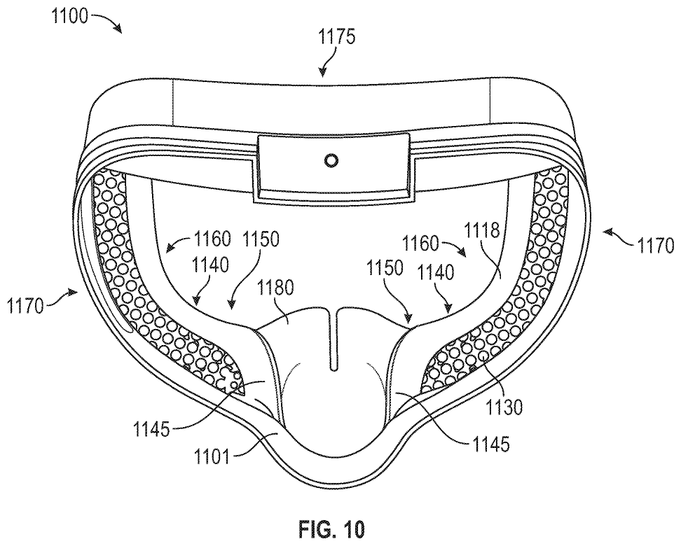

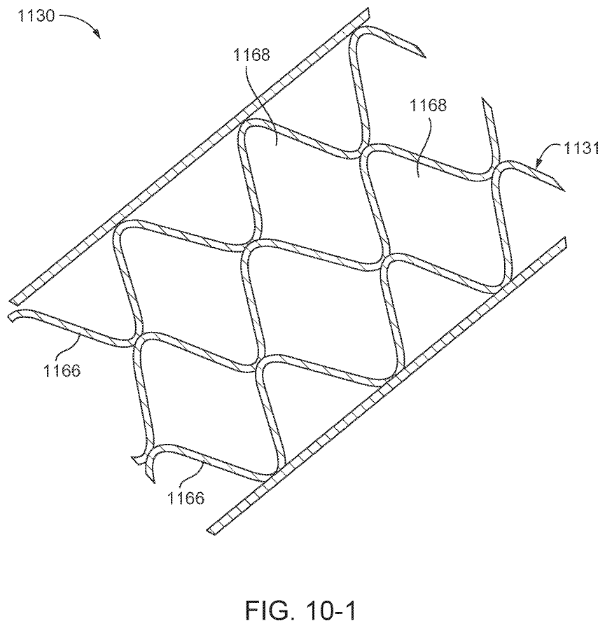

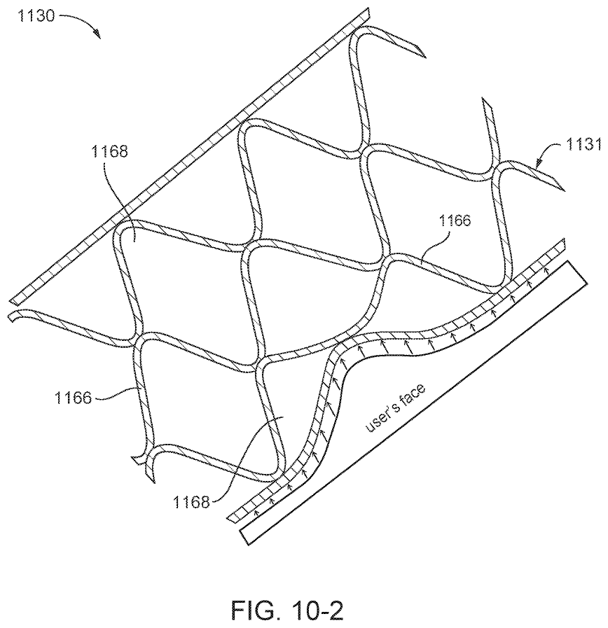

FIG. 10 shows an interfacing structure according to an example of the present technology.

FIG. 10-1 is a schematic view of a cushion according to an example of the present technology.

FIG. 10-2 is a schematic view of the cushion of FIG. 10-1 when in use.

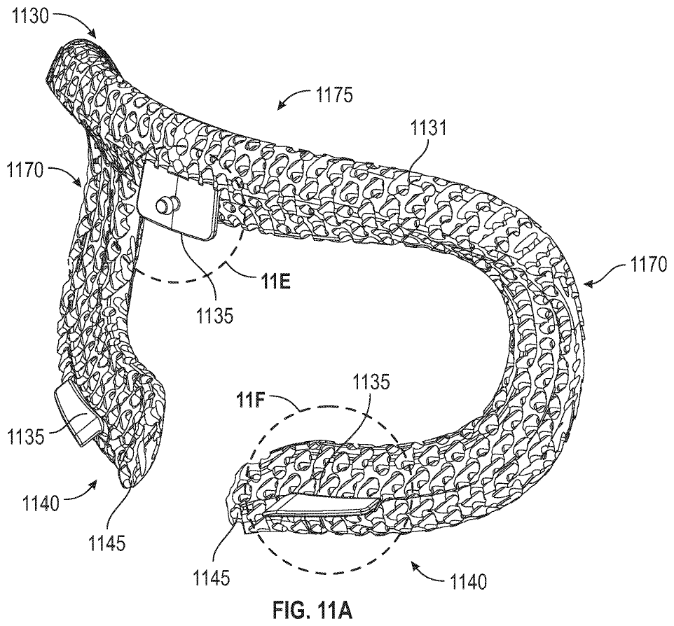

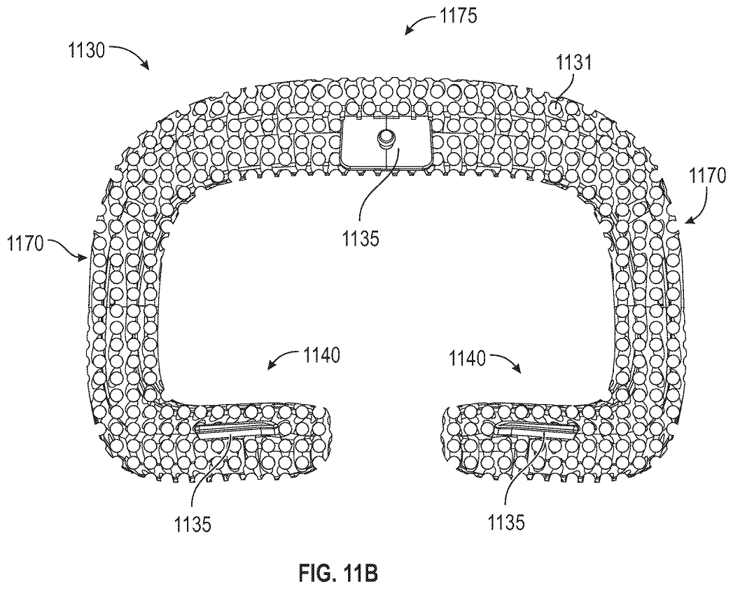

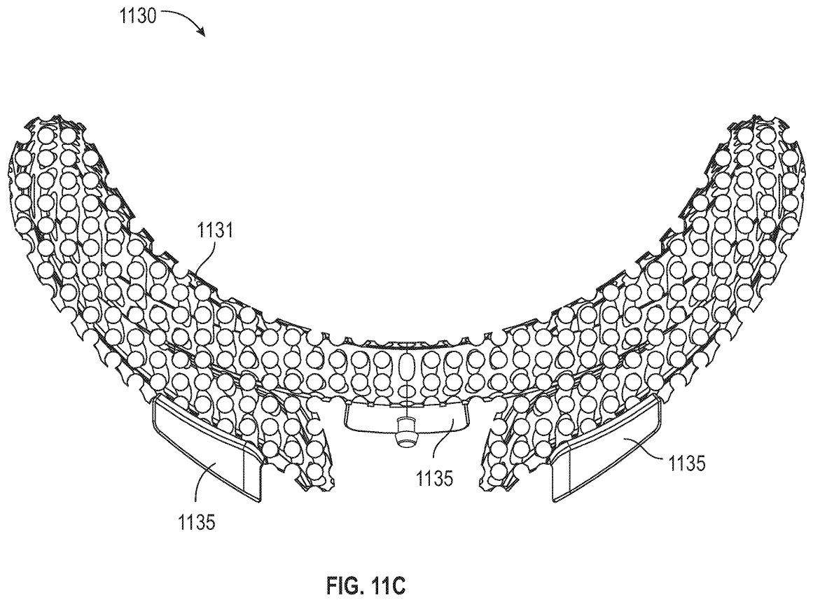

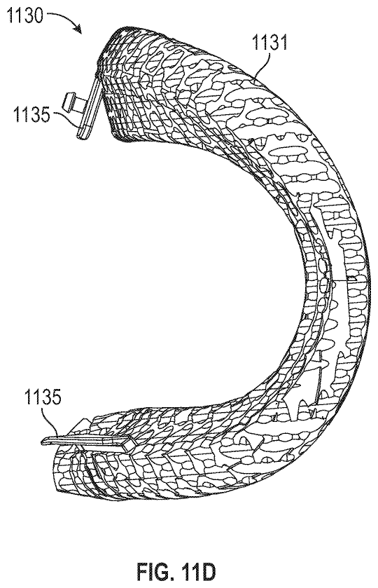

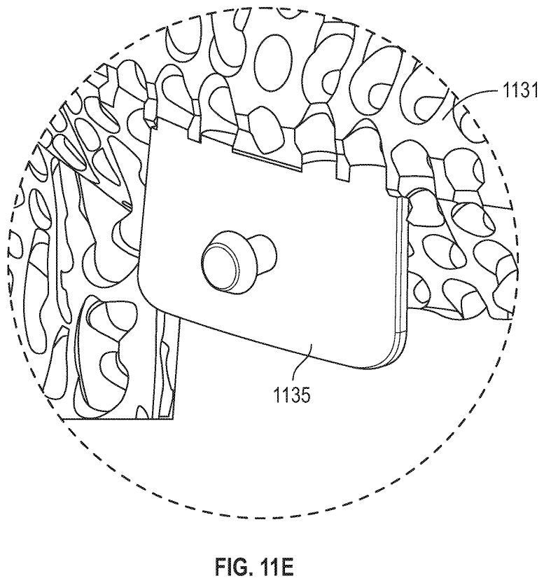

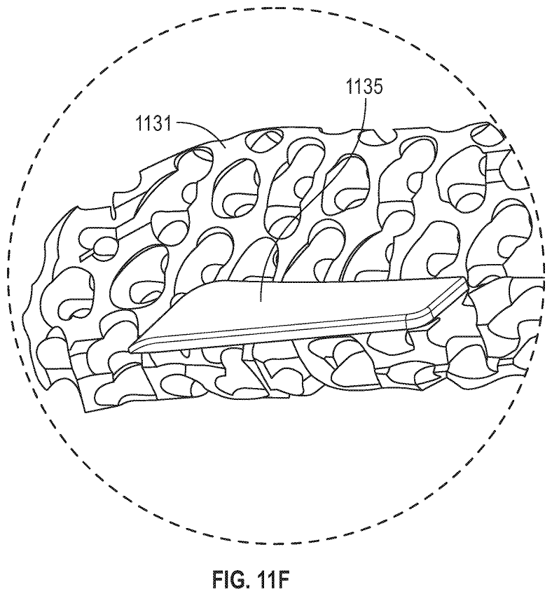

FIG. 11A is a perspective view of a cushion according to an example of the present technology.

FIG. 11B is a front view of the cushion shown in FIG. 11A.

FIG. 11C is a top view of the cushion shown in FIG. 11A.

FIG. 11D is a side view of the cushion shown in FIG. 11A.

FIG. 11E is a detail view of a cushion clip of the cushion shown in FIG. 11A.

FIG. 11F is a detail view of a cushion clip of the cushion shown in FIG. 11A.

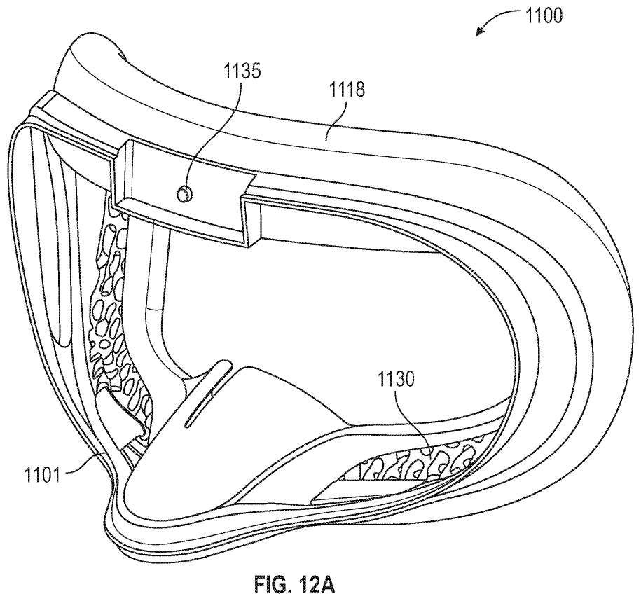

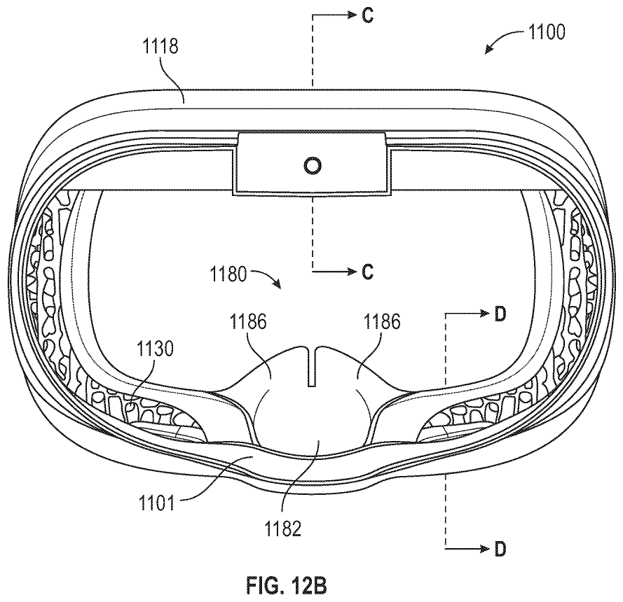

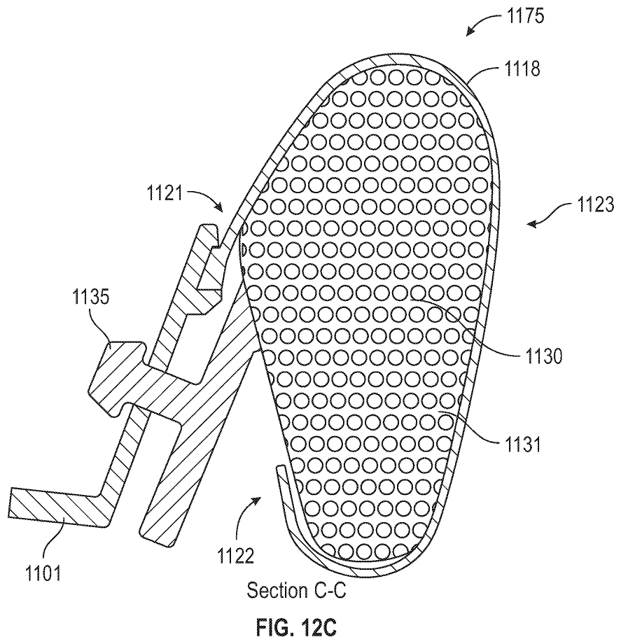

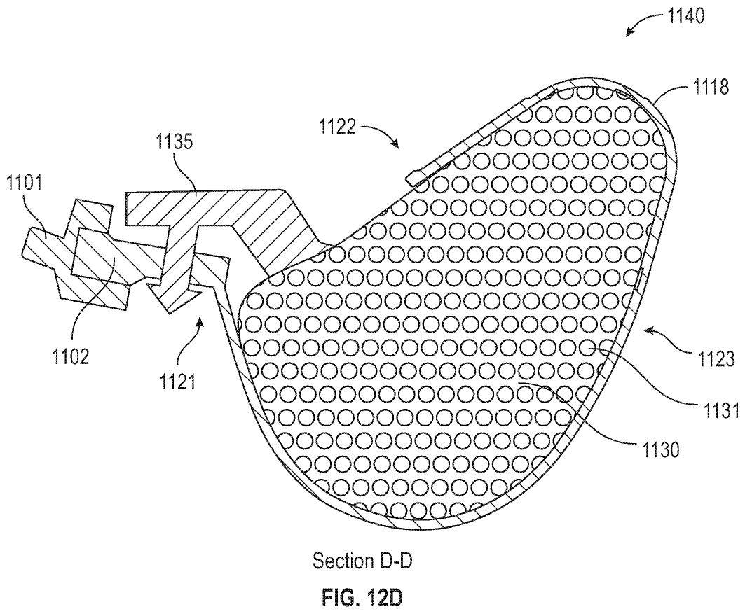

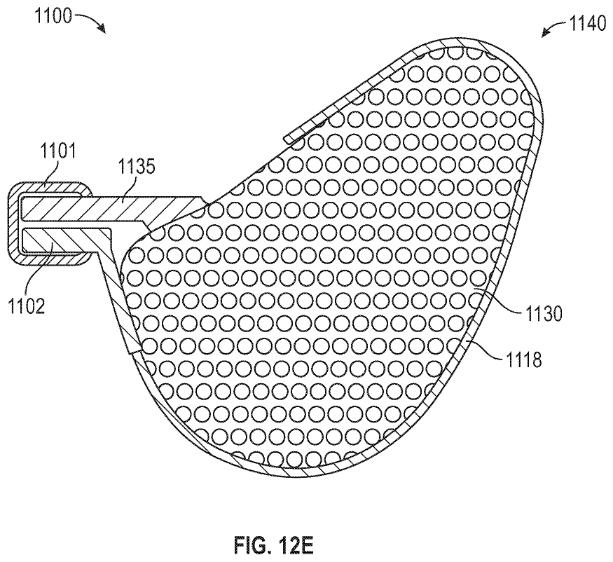

FIG. 12A is a perspective view of an interfacing structure according to another example of the present technology.

FIG. 12B is a front view of the interfacing structure shown in FIG. 12A.

FIG. 12C is a cross section view through the interfacing structure shown in FIG. 12A at line 12C-12C indicated in FIG. 12A.

FIG. 12D is a cross section view through the interfacing structure shown in FIG. 12A at line 12D-12D indicated in FIG. 12A.

FIG. 12E is a cross section view through a cheek portion of an interfacing structure according to another example of the present technology.

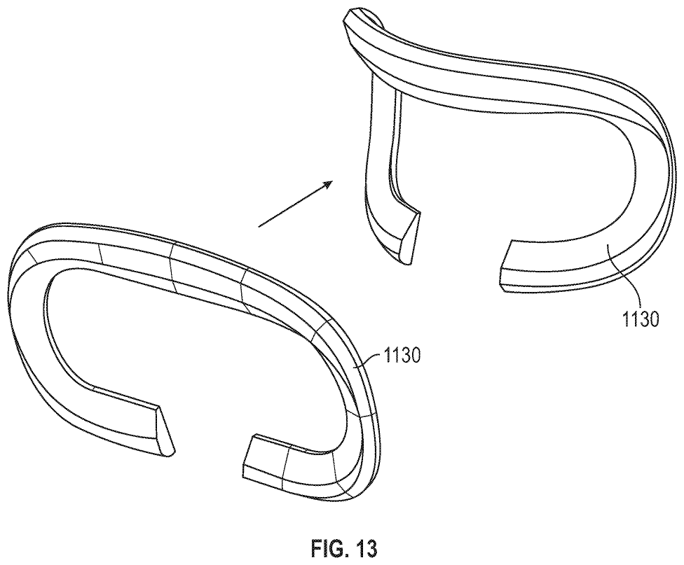

FIG. 13 is a perspective view of a cushion according to an example of the present technology in a flat figuration and in a three-dimensional configuration.

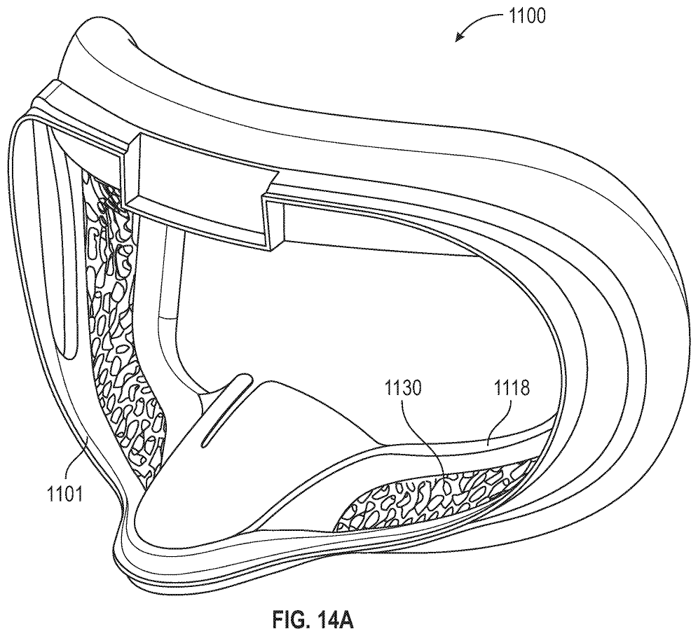

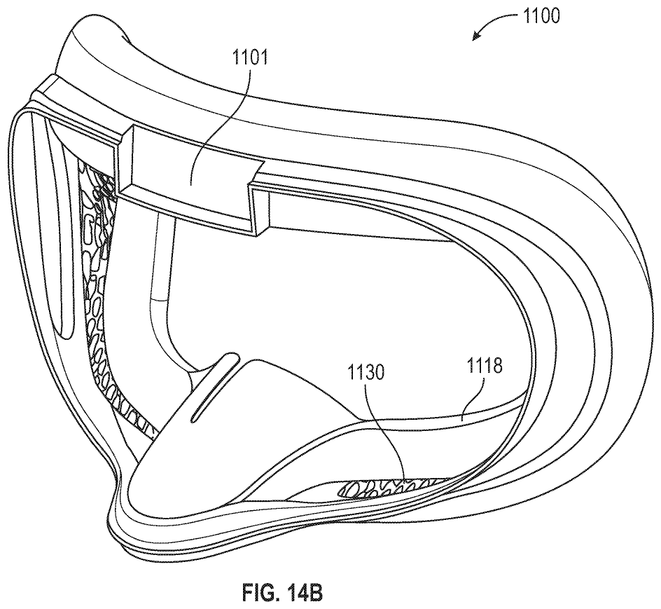

FIG. 14A is a perspective view of an interfacing structure according to another example of the present technology.

FIG. 14B is a perspective view of an interfacing structure according to another example of the present technology.

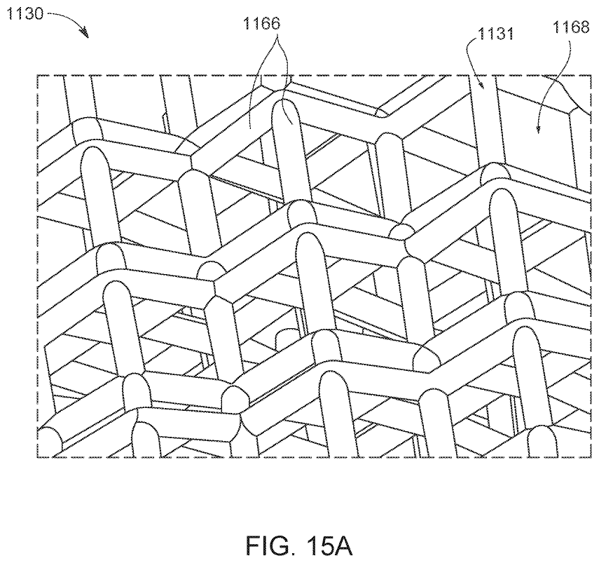

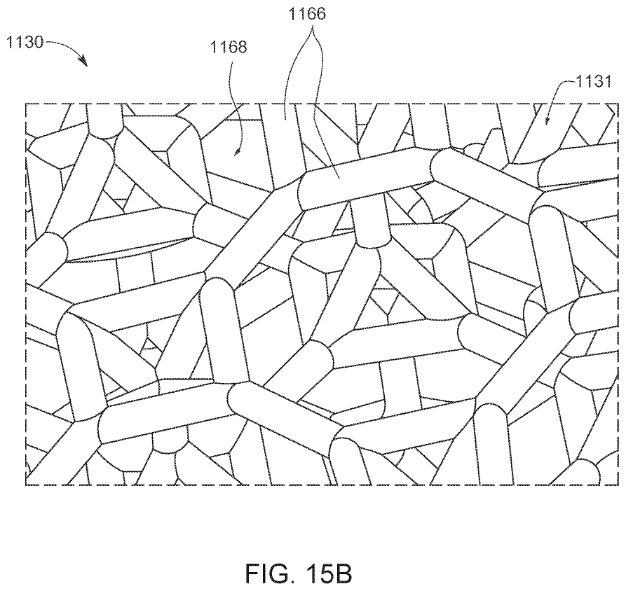

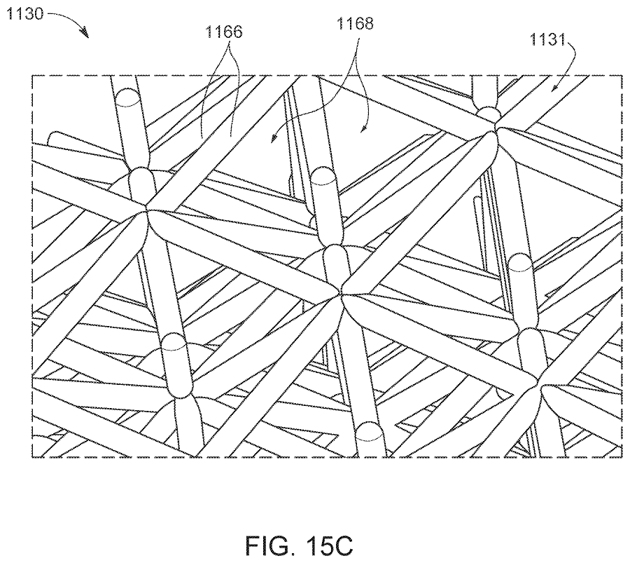

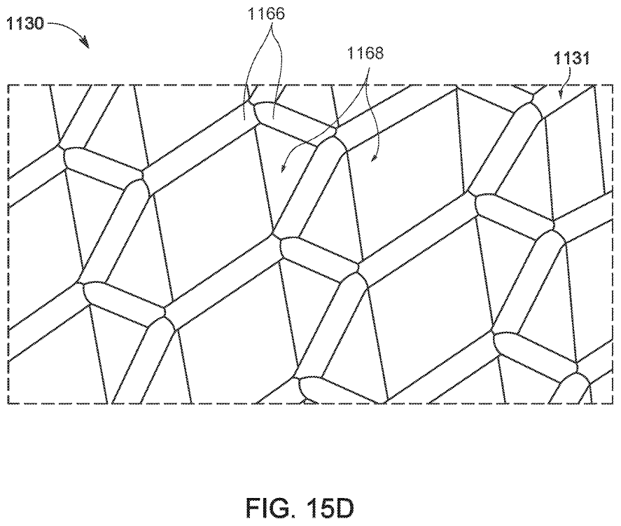

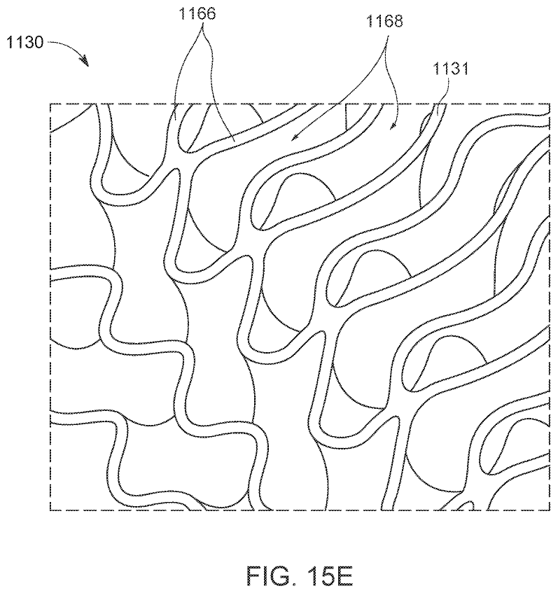

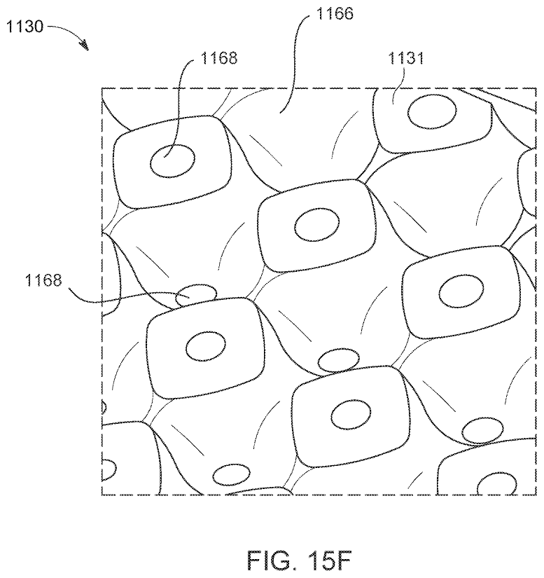

FIG. 15A is a schematic view of a lattice structure having a fluorite pattern.

FIG. 15B is a schematic view of a lattice structure having a truncated cube pattern.

FIG. 15C is a schematic view of a lattice structure having an IsoTruss pattern.

FIG. 15D is a schematic view of a lattice structure having a hexagonal honeycomb pattern.

FIG. 15E is a schematic view of a lattice structure having a gyroid pattern.

FIG. 15F is a schematic view of a lattice structure having a Schwarz pattern.

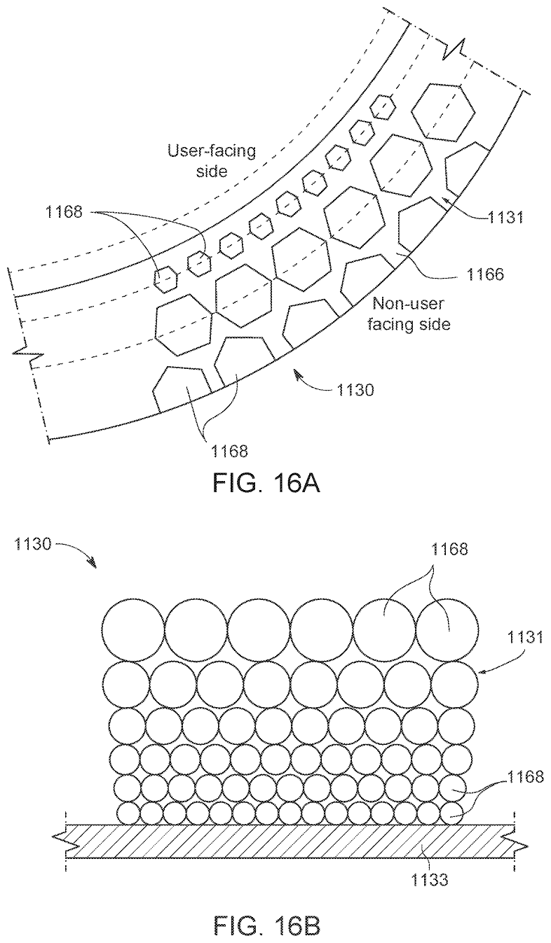

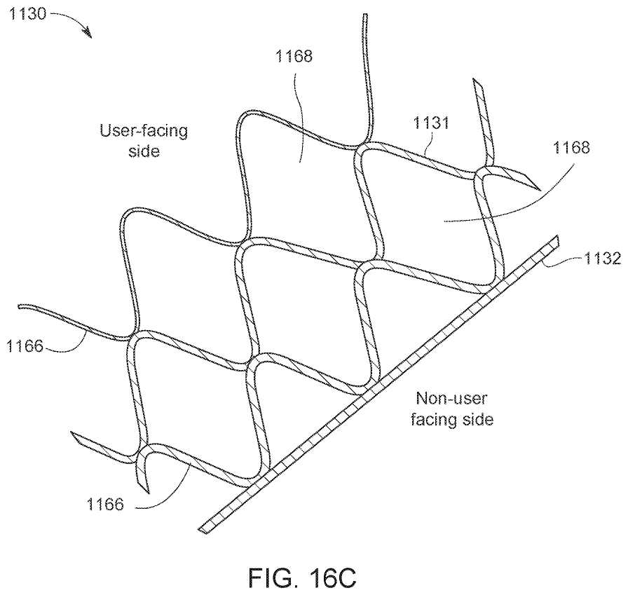

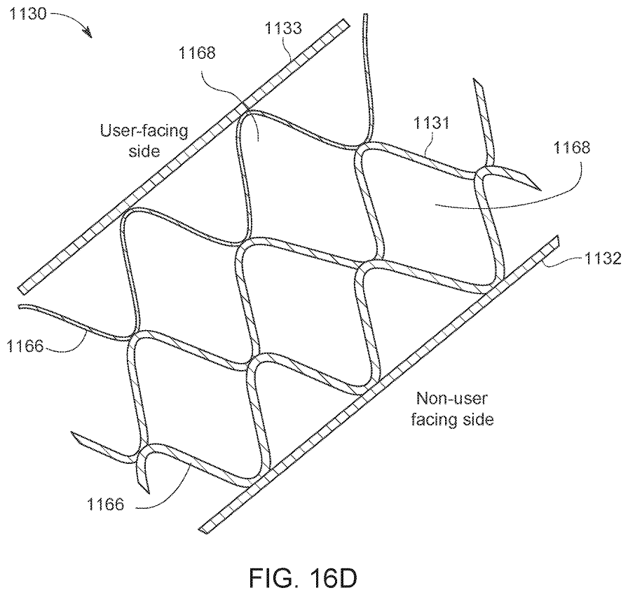

FIG. 16A is a schematic view of a cushion according to another example of the present technology.

FIG. 16B is a schematic view of a portion of a cushion according to another example of the present technology.

FIG. 16C is a schematic view of a cushion according to another example of the present technology.

FIG. 16D is a schematic view of a cushion according to another example of the present technology.

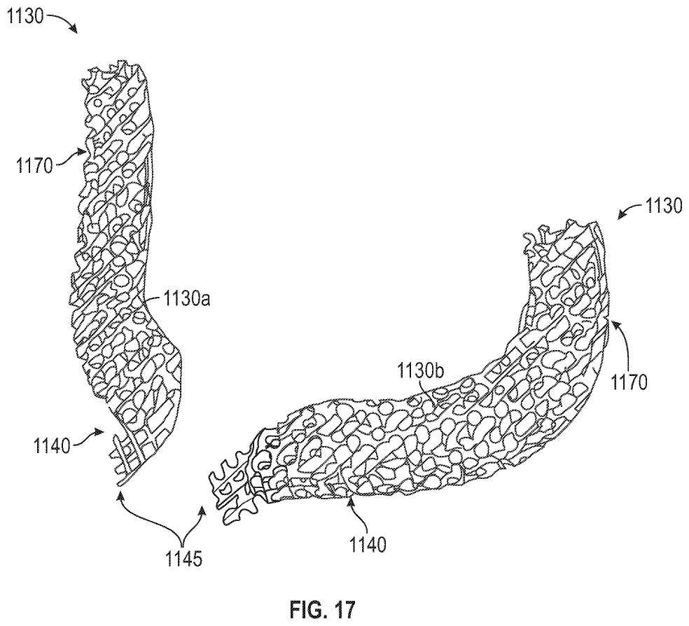

FIG. 17 is a perspective view of a pair of cushions according to another example of the present technology.

FIG. 18 is a schematic view of a cushion according to another example of the present technology.

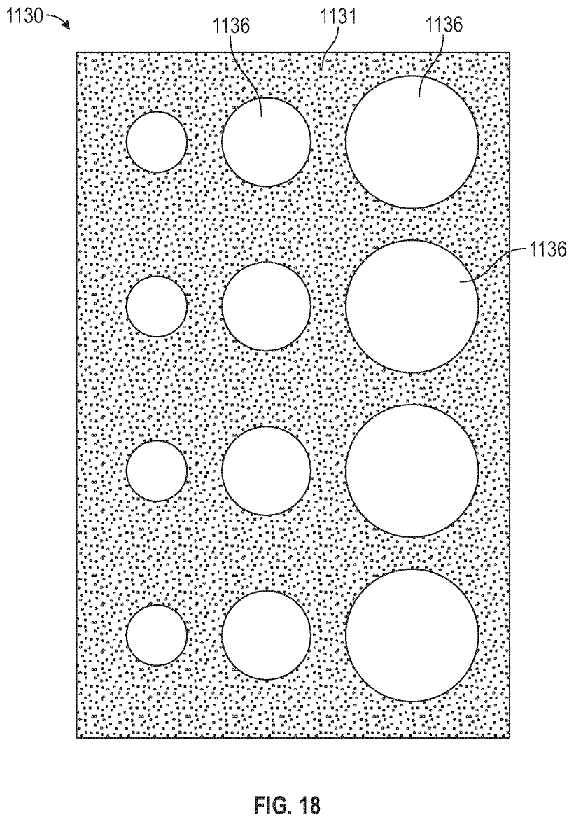

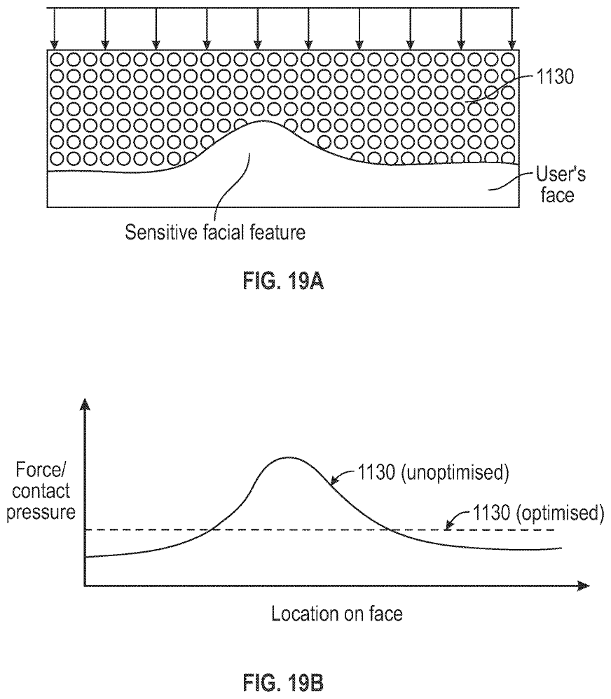

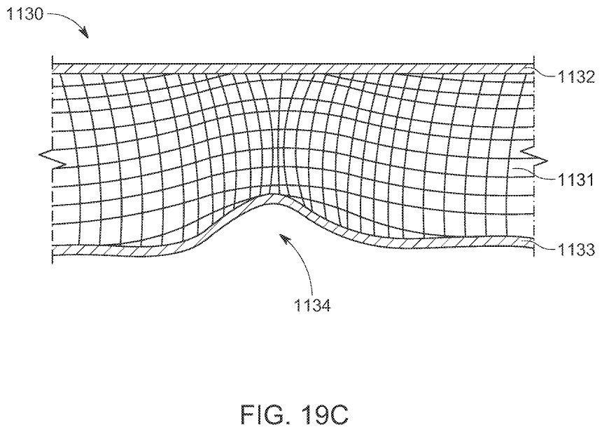

FIG. 19A is a schematic view of a cushion according to another example of the present technology in contact with a user's face, subjected to loading.

FIG. 19B is a plot of force/contact pressure over the user's face for cushions according to examples of the present technology, when subjected to loading as shown in FIG. 19A.

FIG. 19C is a schematic view of a cushion according to another example of the present technology.

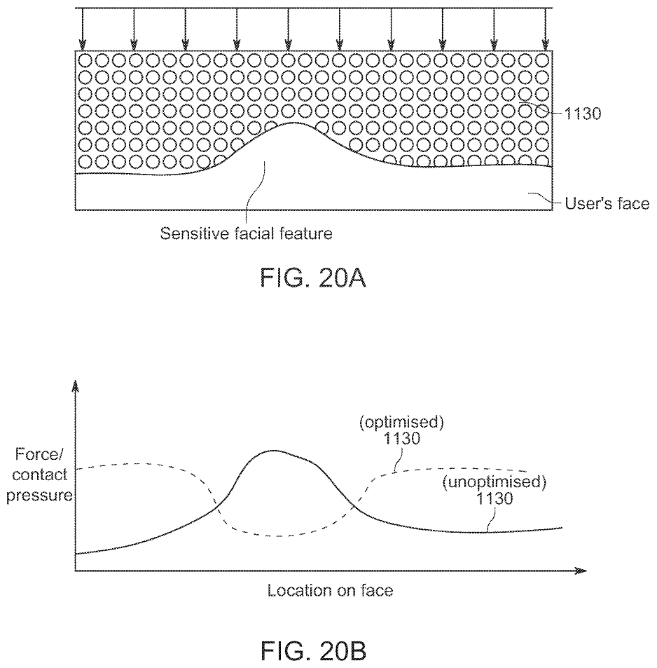

FIG. 20A is a schematic view of a cushion according to another example of the present technology in contact with a user's face, subjected to loading.

FIG. 20B is a plot of force/contact pressure over the user's face for cushions according to examples of the present technology, when subjected to loading as shown in FIG. 20A.

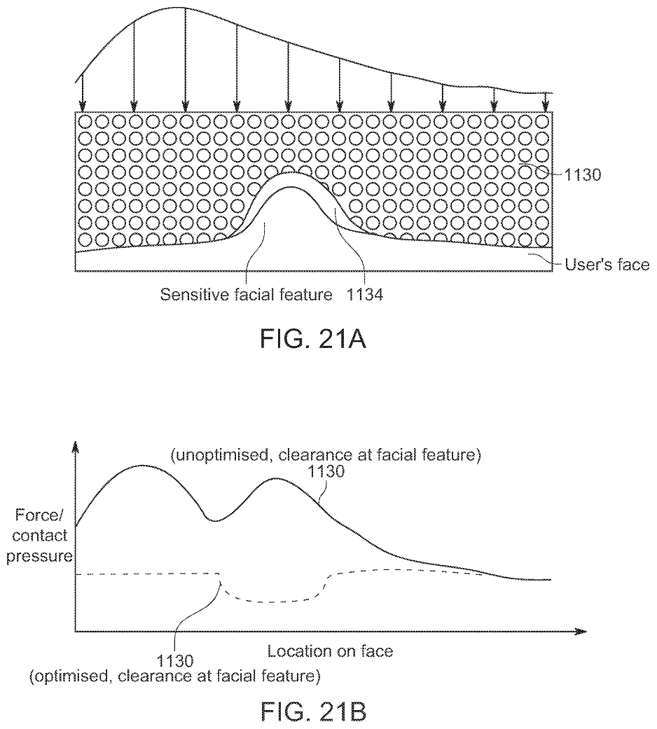

FIG. 21A is a schematic view of a cushion according to another example of the present technology in contact with a user's face, subjected to loading.

FIG. 21B is a plot of force/contact pressure over the user's face for cushions according to examples of the present technology, when subjected to loading as shown in FIG. 21A.

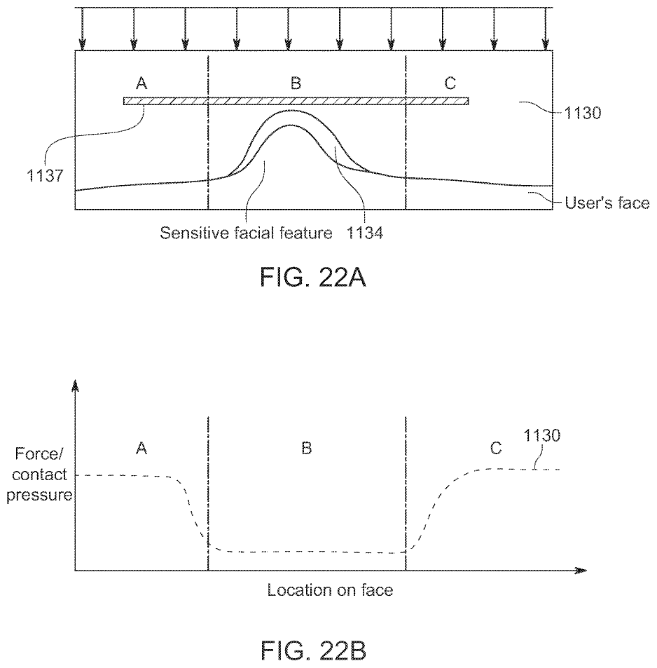

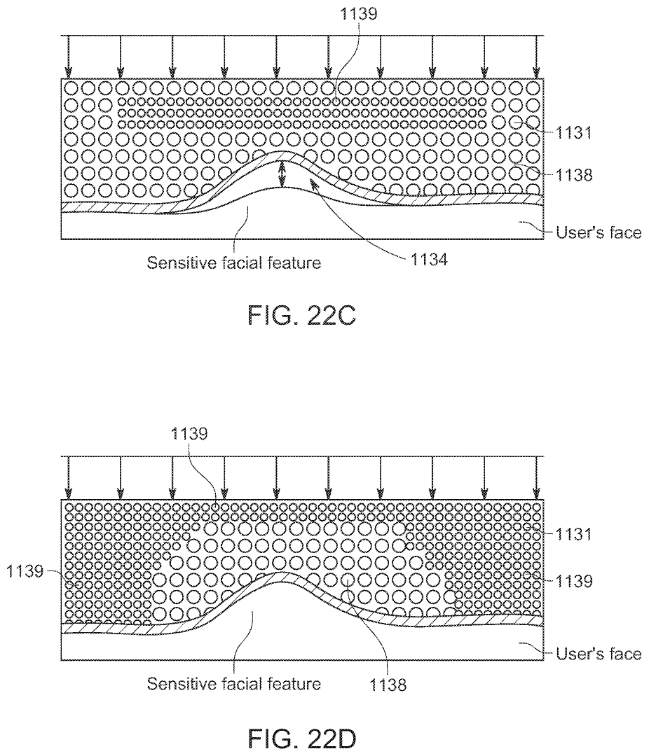

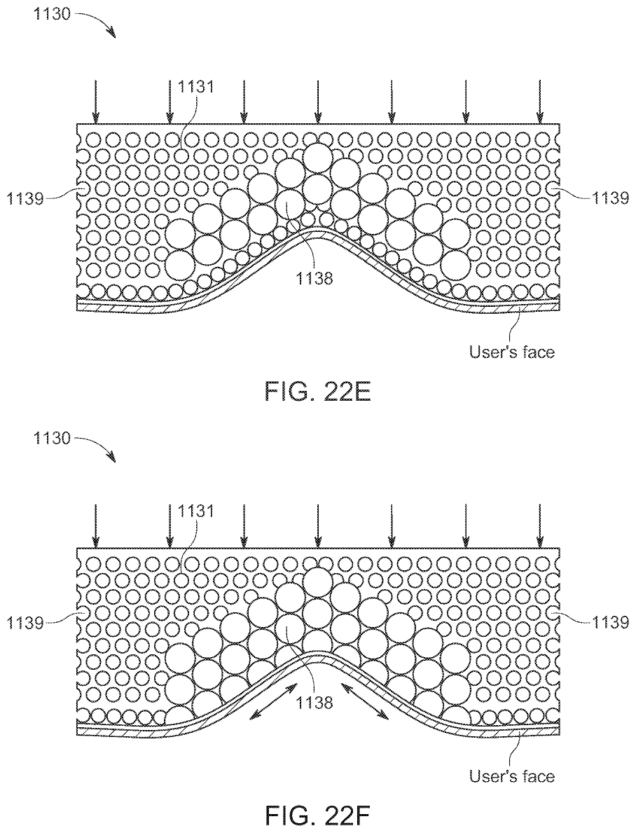

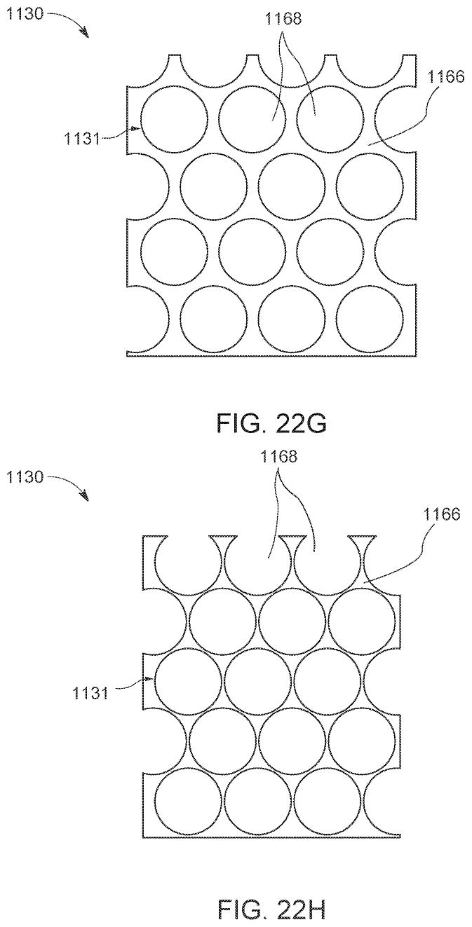

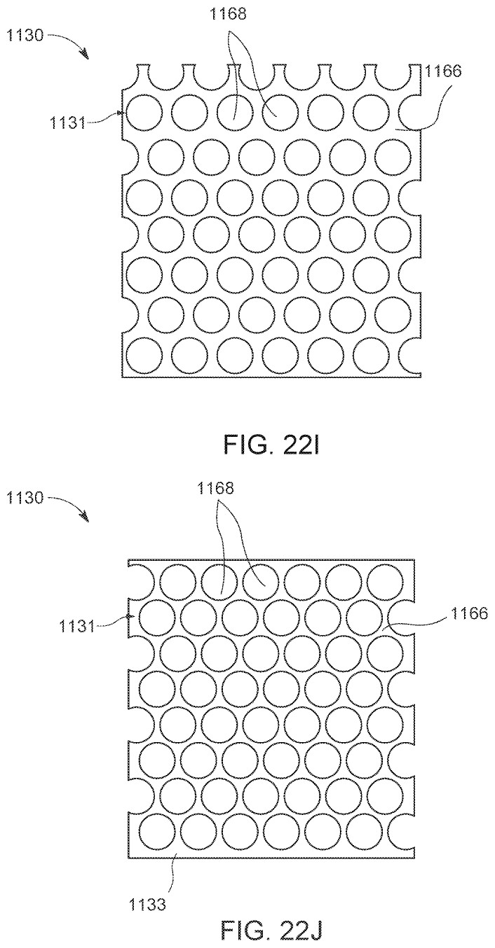

FIG. 22A is a schematic view of a cushion according to another example of the present technology in contact with a user's face, subjected to loading.

FIG. 22B is a plot of force/contact pressure over the user's face for the cushion of FIG. 22A when subjected to loading as shown in FIG. 22A.

FIG. 22C is a schematic view of a cushion according to another example of the present technology in contact with a user's face, subjected to loading.

FIG. 22D is a schematic view of a cushion according to another example of the present technology in contact with a user's face, subjected to loading.

FIG. 22E is a schematic view of a cushion according to another example of the present technology in contact with a user's face, subjected to loading.

FIG. 22F is a schematic view of a cushion according to another example of the present technology in contact with a user's face, subjected to loading.

FIG. 22G is a schematic view of a cushion having a cushion body comprising a lattice structure according to another example of the present technology.

FIG. 22H is a schematic view of a cushion having a cushion body comprising a lattice structure according to another example of the present technology.

FIG. 22I is a schematic view of a cushion having a cushion body comprising a lattice structure according to another example of the present technology.

FIG. 22J is a schematic view of a cushion having a cushion body comprising a lattice structure according to another example of the present technology.

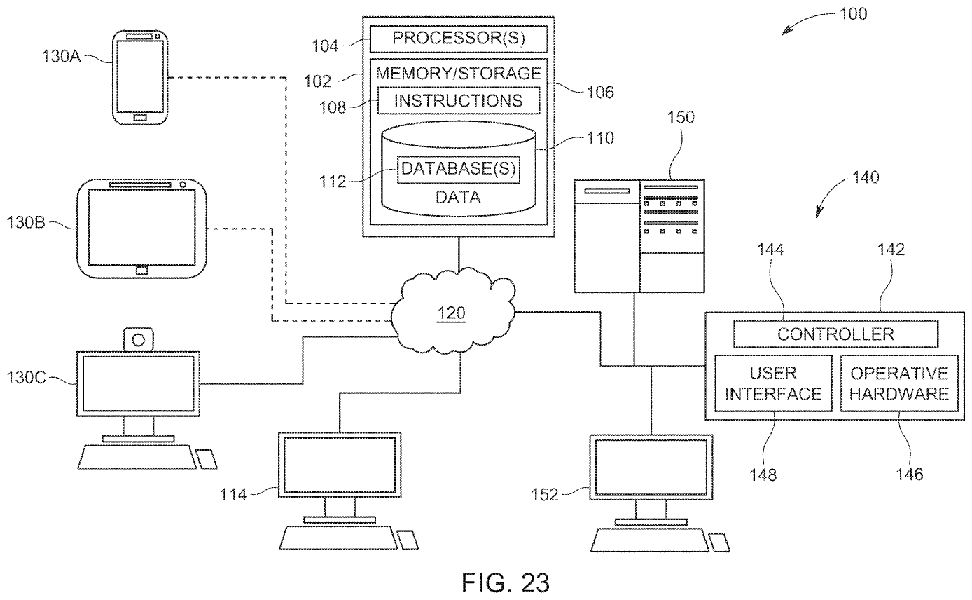

FIG. 23 shows a schematic view of a system 100 according to another example of the present technology.

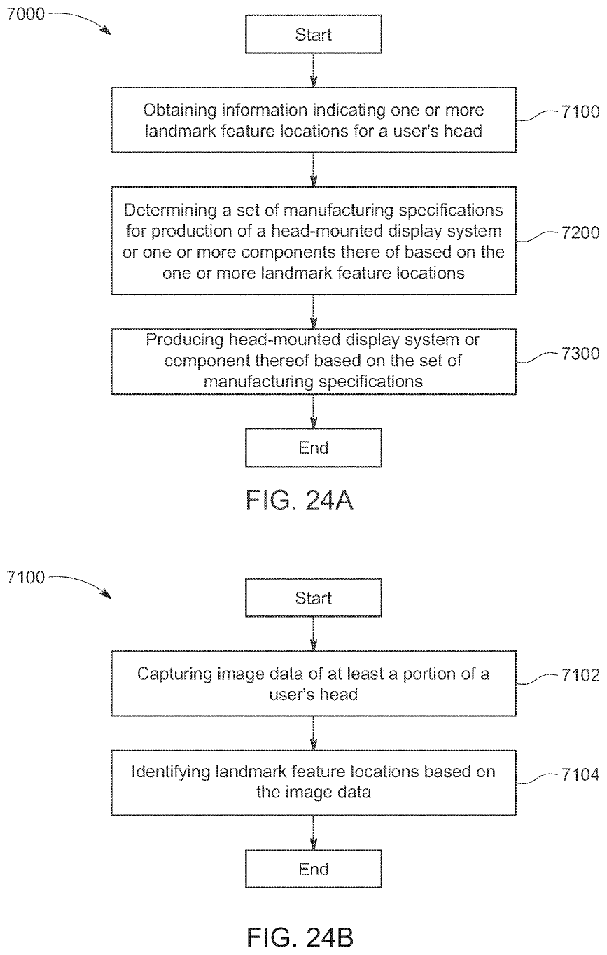

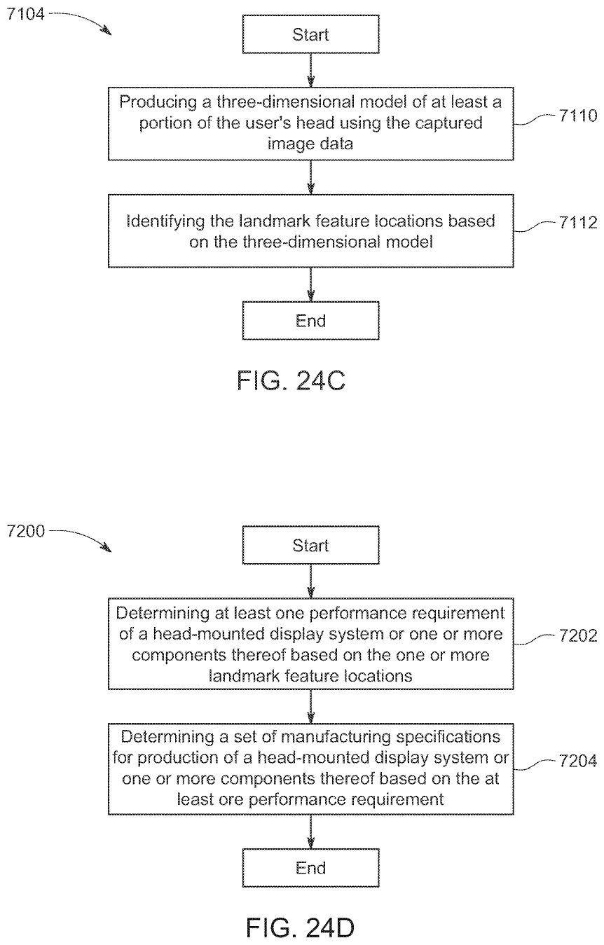

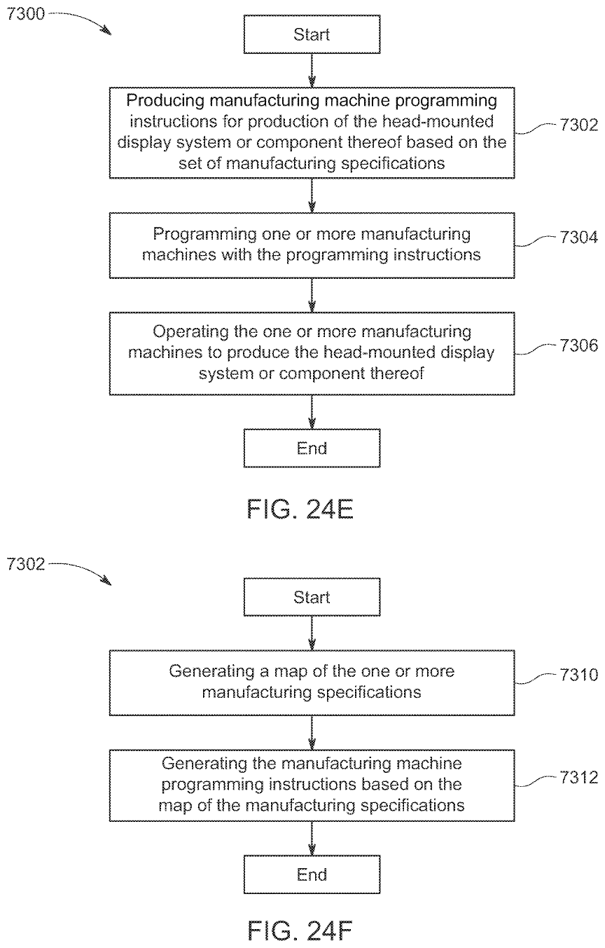

FIG. 24A to 24F show flow charts of a method 7000 and aspects thereof according to another example of the present technology.

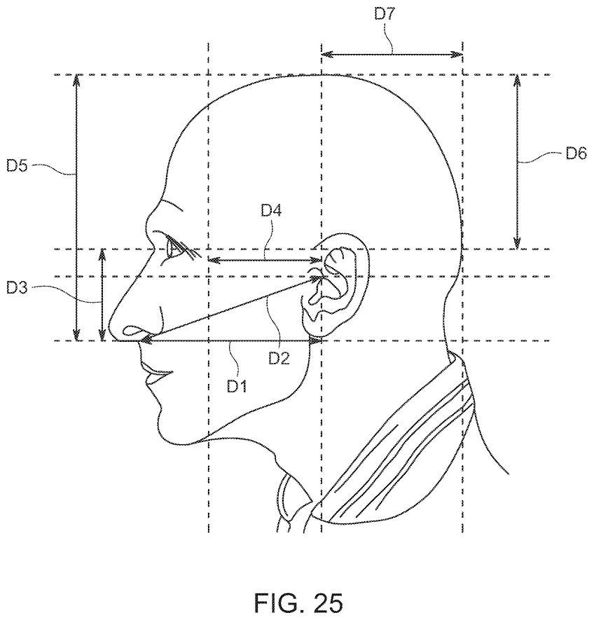

FIG. 25 shows a side view of a user's head having a number of distances identified, relevant to the method 7000.

### 5 DETAILED DESCRIPTION OF EXAMPLES OF THE TECHNOLOGY

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to various examples which may share one or more common characteristics and/or features. It is to be understood that one or more features of any one example may be combinable with one or more features of another example or other examples. In addition, any single feature or combination of features in any of the examples may constitute a further example.

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

### 5.1 Immersive Technologies

Immersive technologies may present a user with a combination of a virtual environment and the user's physical environment, or the real world. The user may interact with the resulting immersive or combined reality.

The device immerses the user by augmenting or replacing stimuli associated with one of the user's five senses with a virtual stimuli. Typically this is a virtual stimuli, although there could be additional stimuli that augment or replace stimuli associated with one of the additional four senses.

In some forms, a particular immersive technology may present a user with a combination of a virtual environment and the user's environment. At least a portion of the resulting environment may include a virtual environment. In some examples, the entire resulting environment may be a virtual environment (e.g., meaning the user's environment may be block from view or otherwise obstructed). In other forms, at least a portion of the user's physical environment may still be visually observable.

In some forms, the user may use different types of immersive technologies, which may include, but are not limited to, virtual reality (VR), augmented reality (AR), or mixed reality (MR). Each type of immersive technology may present the user with a different environment and/or a different way to interact with the environment.

In some forms, a display system may be used with each type of immersive technology. A display screen of the display system may provide a virtual environment component to the combination environment (i.e., the combination of the virtual and user's environments). In certain forms, the display screen may be an electronic screen.

In at least some types of immersive technologies (e.g., VR, AR, MR, etc.), positioning and stabilizing the electronic screen may be useful in operating a respective device. For example, the user may desire the electronic screen to be positioned close enough to their eyes to allow for easy viewing, but far enough away so as not to cause discomfort. Additionally, the electronic screen may need to be spaced far enough away so that users may simultaneously wear corrective lenses, like glasses. In addition, users may seek to maintain the orientation of the electronic screen relative to their eyes. In other words, users who walk, or otherwise move, while using these devices may not want the device to bounce or otherwise move on their head (e.g., particularly relative to their eyes), as this may cause dizziness and/or discomfort to the user. Therefore, these devices may be supported snuggly against the user's head in order to limit relative movement between the user's eyes and the device.

In one form, the present technology comprises a method for using a VR device comprising supporting the device on the user's head proximate to at least one of the user's eyes, and within the user's line of sight.

In certain examples of the present technology, a head-mounted display unit is supported in front of both of the user's eyes in order to block, obstruct, and/or limit ambient light from reaching the user's eyes.

Any features disclosed below in the context of a device configured for VR are to be understood as being applicable to devices configured for AR, unless the context clearly requires otherwise. Likewise features disclosed below in the context of a device configured for AR are to be understood as being applicable to devices configured for VR, unless the context clearly requires otherwise. For the avoidance of doubt, a feature disclosed in the context of a device that does not have a transparent display, through which the user can view the real world, is to be understood as being applicable to a device having such a transparent display unless the context clearly requires otherwise. Likewise a feature disclosed in the context of a device that has a transparent display, through which the real-world can be viewed, is to be understood to be applicable to a device in which the display is electronic and through which the real-world cannot be viewed directly through a transparent material.

### 5.2 Virtual Reality Display System

As shown in FIGS. 4A and 4B, a display apparatus, display system, display interface or head-mounted display system 1000 in accordance with one aspect of the present technology comprises the following functional aspects: an interfacing structure 1100, a head-mounted display unit 1200, and a positioning and stabilizing structure 1300. In some forms, a functional aspect may provide one or more physical components. In some forms, one or more physical components may provide one or more functional aspects. The head-mounted display unit 1200 may comprise a display. In use, the head-mounted display unit 1200 is arranged to be positioned proximate and anterior to the user's eyes, so as to allow the user to view the display.

In other aspects, the head-mounted display system 1000 may also include a display unit housing 1205, an optical lens 1240, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

### 5.2.1 Head-mounted Display Unit

The head-mounted display unit 1200 may include a structure for providing an observable output to a user. Specifically, the head-mounted display unit 1200 is arranged to be held (e.g., manually, by a positioning and stabilizing structure, etc.) in an operational position in front of a user's face.

In some examples, the head-mounted display unit 1200 may include a display screen 1220, a display unit housing 1205, an interfacing structure 1100, and/or an optical lens 1240. These components may be permanently assembled in a single head-mounted display unit 1200, or they may be separable and selectively connected by the user to form the head-mounted display unit 1200. Additionally, the display screen 1220, the display unit housing 1205, the interfacing structure 1100, and/or the optical lens 1240 may be included in the head-mounted display system 1000, but may not be part of the head-mounted display unit 1200.

### 5.2.1.1 Display Screen

Some forms of the head-mounted display unit 1200 include a display, for example a display screen—not shown in FIG. 4B, but provided within the display housing 1205. The display screen may include electrical components that provide an observable output to the user.

In one form of the present technology, a display screen provides an optical output observable by the user. The optical output allows the user to observe a virtual environment and/or a virtual object.

The display screen may be positioned proximate to the user's eyes, in order to allow the user to view the display screen. For example, the display screen may be positioned anterior to the user's eyes. The display screen can output computer generated images and/or a virtual environment.

In some forms, the display screen is an electronic display. The display screen may be a liquid crystal display (LCD), or a light emitting diode (LED) screen.

In certain forms, the display screen may include a backlight, which may assist in illuminating the display screen. This may be particularly beneficial when the display screen is viewed in a dark environment.

In some forms, the display screen may extend wider a distance between the user's pupils. The display screen may also be wider than a distance between the user's cheeks.

In some forms, the display screen may display at least one image that is observable by the user. For example, the display screen may display images that change based on predetermined conditions (e.g., passage of time, movement of the user, input from the user, etc.).

In certain forms, portions of the display screen may be visible to only one of the user's eyes. In other words, a portion of the display screen may be positioned proximate and anterior to only one of the user's eyes (e.g., the right eye), and is blocked from view from the other eye (e.g., the left eye).

In one example, the display screen may be divided into two sides (e.g., a left side and a right side), and may display two images at a time (e.g., one image on either side).

Each side of the display screen may display a similar image. In some examples, the images may be identical, while in other examples, the images may be slightly different.

Together, the two images on the display screen may form a binocular display, which may provide the user with a more realistic VR experience. In other words, the user's brain may process the two images from the display screen 1220 together as a single image. Providing two (e.g., un-identical) images may allow the user to view virtual objects on their periphery, and expand their field of view in the virtual environment.

In certain forms, the display screen may be positioned in order to be visible by both of the user's eyes. The display screen may output a single image at a time, which is viewable by both eyes. This may simplify the processing as compared to the multi-image display screen.

### 5.2.1.2 Display Housing

In some forms of the present technology as shown in FIGS. 4A and 4B, a display unit housing 1205 provides a support structure for the display screen, in order to maintain a position of at least some of the components of the display screen relative to one another, and may additionally protect the display screen and/or other components of the head-mounted display unit 1200. The display unit housing 1205 may be constructed from a material suitable to provide protection from impact forces to the display screen. The display unit housing 1205 may also contact the user's face, and may be constructed from a biocompatible material suitable for limiting irritation to the user.

A display unit housing 1205 in accordance with some forms of the present technology may be constructed from a hard, rigid or semi-rigid material, such as plastic.

In certain forms, the rigid or semi-rigid material may be at least partially covered with a soft and/or flexible material (e.g., a textile, silicone, etc.). This may improve biocompatibility and/or user comfort because the at least a portion of the display unit housing 1205 that the user engages (e.g., grabs with their hands) includes the soft and/or flexible material.

A display unit housing 1205 in accordance with other forms of the present technology may be constructed from a soft, flexible, resilient material, such as silicone rubber.

In some forms, the display unit housing 1205 may have a substantially rectangular or substantially elliptical profile. The display unit housing 1205 may have a three-dimensional shape with the substantially rectangular or substantially elliptical profile.

In certain forms, the display unit housing 1205 may include a superior face 1230, an inferior face 1232, a lateral left face 1234, a lateral right face 1236, and an anterior face 1238. The display screen 1220 may be held within the faces in use.

In certain forms, the superior face 1230 and the inferior face 1232 may have substantially the same shape.

In one form, the superior face 1230 and the inferior face 1232 may be substantially flat, and extend along parallel planes (e.g., substantially parallel to the Frankfort horizontal in use).

In certain forms, the lateral left face 1234 and the lateral right face 1236 may have substantially the same shape.

In one form, the lateral left face 1234 and the lateral right face 1236 may be curved and/or rounded between the superior and inferior faces 1230, 1232. The rounded and/or curved faces 1234, 1236 may be more comfortable for a user to grab and hold while donning and/or doffing the head-mounted display system 1000.

In certain forms, the anterior face 1238 may extend between the superior and inferior faces 1230, 1232. The anterior face 1238 may form the anterior most portion of the head-mounted display system 1000.

In one form, the anterior face 1238 may be a substantially planar surface, and may be substantially parallel to the coronal plane, while the head-mounted display system 1000 is worn by the user.

In one form, the anterior face 1238 may not have a corresponding opposite face (e.g., a posterior face) with substantially the same shape as the anterior face 1238. The posterior portion of the display unit housing 1205 may be at least partially open (e.g., recessed in the anterior direction) in order to receive the user's face.

In some forms, the display screen is permanently integrated into the head-mounted display system 1000. The display screen may be a device usable only as a part of the head-mounted display system 1000.

In some forms, the display unit housing 1205 may enclose the display screen, which may protect the display screen and/or limit user interference (e.g., moving and/or breaking) with the components of the display screen.

In certain forms, the display screen may be substantially sealed within the display unit housing 1205, in order to limit the collection of dirt or other debris on the surface of the display screen, which could negatively affect the user's ability to view an image output by the display screen. The user may not be required to break the seal and access the display screen, since the display screen is not removable from the display unit housing 1205.

In some forms, the display screen is removably integrated into the head-mounted display system 1000. The display screen may be a device usable independently of the head-mounted display system 1000 as a whole. For example, the display screen may be provided on a smart phone, or other portable electronic device.

In some forms, the display unit housing 1205 may include a compartment. A portion of the display screen may be removably receivable within the compartment. For example, the user may removably position the display screen in the compartment. This may be useful if the display screen performs additional functions outside of the head-mounted display unit 1200 (e.g., is a portable electronic device like a cell phone). Additionally, removing the display screen from the display unit housing 1205 may assist the user in cleaning and/or replacing the display screen.

Certain forms of the display housing include an opening to the compartment, allowing the user to more easily insert and remove the display screen from the compartment. The display screen may be retained within the compartment via a frictional engagement.

In certain forms, a cover may selectively cover the compartment, and may provide additional protection and/or security to the display screen 1220 while positioned within the compartment.

In certain forms, the compartment may open on the superior face. The display screen may be inserted into the compartment in a substantially vertical direction while the display interface 1000 is worn by the user.

### 5.2.1.3 Interfacing Structure

As shown in FIGS. 4A and 4B, some forms of the present technology include an interfacing structure 1100 is positioned and/or arranged in order to conform to a shape of a user's face, and may provide the user with added comfort while wearing and/or using the head-mounted display system 1000.

In some forms, the interfacing structure 1100 is coupled to a surface of the display unit housing 1205.

In some forms, the interfacing structure 1100 may extent at least partially around the display unit housing 1205, and may form a viewing opening. The viewing opening may at least partially receive the user's face in use. Specifically, the user's eyes may be received within the viewing opening formed by the interfacing structure 1100.

In some forms, the interfacing structure 1100 in accordance with the present technology may be constructed from a biocompatible material.

In some forms, the interfacing structure 1100 in accordance with the present technology may be constructed from a soft, flexible, and/or resilient material.

In certain forms, the interfacing structure 1100 in accordance with the present technology may be constructed from silicone rubber and/or foam.

In some forms, the interfacing structure 1100 may contact sensitive regions of the user's face, which may be locations of discomfort. The material forming the interfacing structure 1100 may cushion these sensitive regions, and limit user discomfort while wearing the head-mounted display system 1000.

In certain forms, these sensitive regions may include the user's forehead. Specifically, this may include the region of the user's head that is proximate to the frontal bone, like the Epicranius and/or the glabella. This region may be sensitive because there is limited natural cushioning from muscle and/or fat between the user's skin and the bone. Similarly, the ridge of the user's nose may also include little to no natural cushioning.

In some forms, the interfacing structure 1100 may comprise a single element. In some embodiments the interfacing structure 1100 may be designed for mass manufacture. For example, the interfacing structure 1100 may be designed to comfortably fit a wide range of different face shapes and sizes.

In some forms, the interfacing structure 1100 may include different elements that overlay different regions of the user's face. The different portions of the interfacing structure 1100 may be constructed from different materials, and provide the user with different textures and/or cushioning at different regions.

### 5.2.1.3.1 Light Shield

Some forms of the head-mounted display system 1000 may include a light shield that may be constructed from an opaque material and can block ambient light from reaching the user's eyes. The light shield may be part of the interfacing structure 1100 or may be a separate element. In some examples the interfacing structure 1100 may form a light shield by shielding the user's eyes from ambient light, in addition to providing a comfortable contacting portion for contact between the head-mounted display 1200 and the user's face. In some examples a light shield may be formed from multiple components working together to block ambient light.

In certain forms, the light shield can obstruct ambient light from reaching an eye region, which may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween.

In one form, the light shield may not contact the user's face around its entire perimeter. For example, the light shield may be spaced from the user's nasal rigid. The width of this spacing may be substantially small, so as to substantially limit the ingress of ambient light. However, the user's nasal ridge may be sensitive and easily irritated. Thus, avoiding direct contact with the user's nasal ridge may improve user comfort while wearing the head-mounted display system 1000.

In certain forms, the light shield may be a portion of the display unit housing 1205, and may be integrally or removably coupled to the display unit housing 1205. In one form, if the display unit housing 1205 is usable with a display screen outputting AR or MR, and VR, the light shield may be removable from the display unit housing 1205, and only coupled to the display unit housing 1205 while using VR.

### 5.2.1.3.1.1 Seal-forming Structure

As shown in FIG. 4D, in one form of the present technology, the interfacing structure 1100 acts as a seal-forming structure, and provides a target seal-forming region. The target seal-forming region is a region on the seal-forming structure where sealing may occur. The region where sealing actually occurs-the actual sealing surface-may change within a given session, from day to day, and from user to user, depending on a range of factors including but not limited to, where the display unit housing 1205 is placed on the face, tension in the positioning and stabilizing structure 1300, and/or the shape of a user's face.

In one form the target seal-forming region is located on an outside surface of the interfacing structure 1100.

In some forms, the light shield may form the seal-forming structure and seal against the user's face.

In certain forms, the entire perimeter of the light shield or interfacing structure 1100 may seal against the user's skin, and can block ambient light from reaching an eye region. The eye region may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween.

When acting as a seal-forming structure, the light shield or interfacing structure 1100 may contact sensitive areas the user's face, like the user's nasal ridge. This contact may entirely prevent the ingress of ambient light. Sealing around the entire perimeter of the display unit housing 1205 may improve performance of the head-mounted display system 1000. Additionally, biocompatible materials may be selected so that direct contact with the user's nasal ridge does not significantly reduce user comfort while wearing the head-mounted display system 1000.

In certain forms of the present technology, a system is provided comprising more than one interfacing structure 1100, each being configured to correspond to a different size and/or shape range. For example the system may comprise one form of interfacing structure 1100 suitable for a large sized head, but not a small sized head and another suitable for a small sized head, but not a large sized head. The different interfacing structures 1100 may be removable and replaceable so that different users with different sized heads may use the same head-mounted display system 1000.

In some forms, the seal-forming structure may be formed on regions of the Epicranius, the user's sphenoid, across the outer cheek region between the sphenoid to the left or right zygomatic arch, over the zygomatic arch, across the inner cheek region from the zygomatic arches towards the alar crests, and on the users' nasal ridge inferior to the sellion to enclose a portion of the users' face therebetween. This defined region may be an eye region.

In certain forms, this may seal around the user's eyes. The seal created by the seal-forming structure or interfacing structure 1100 may create a light seal, in order to limit ambient light from reaching the user's eyes.

### 5.2.1.3.2 Material Biocompatibility

Biocompatible materials are considered to be materials that undergo a full evaluation of their biological responses, relevant to their safety in use, according to ISO 10993-1 standard. The evaluation considers the nature and duration of anticipated contact with human tissues when in-use. In some forms of the present technology, the materials utilised in the positioning and stabilizing structure and interfacing structure may undergo at least some of the following biocompatibility tests: Cytotoxicity—Elution Test (MeM Extract): ANSI/AAMI/ISO 10993-5; Skin Sensitisation: ISO 10993-10; Irritation: ISO 10993-10; Genotoxicity-Bacterial Mutagenicity Test: ISO 10993-3; Implantation: ISO 10993-6.

### 5.2.1.4 Optical Lenses

As shown in FIG. 4B, at least one lens 1240 may be disposed between the user's eyes and the display screen 1220. The user may view an image provided by the display screen 1220 through the lens 1240. The at least one lens 1240 may assist in spacing the display screen 1220 away from the user's face to limit eye strain. The at least one lens 1240 may also assist in better observing the image being displayed by the display screen 1220.

In some forms, the lenses 1240 are Fresnel lenses.

In some forms, the lens 1240 may have a substantially frustoconical shape. A wider end of the lens 1240 may be disposed proximate to the display screen 1220, and a narrower end of the lens 1240 may be disposed proximate to the user's eyes, in use.

In some forms, the lens 1240 may have a substantially cylindrical shape, and may have substantially the same width proximate to the display screen 1220, and proximate to the user's eyes, in use.

In some forms, the at least one lens 1240 may also magnify the image of the display screen 1220, in order to assist the user in viewing the image.

In some forms, the head-mounted display system 1000 includes two lenses 1240 (e.g., binocular display), one for each of the user's eyes. In other words, each of the user's eyes may look through a separate lens positioned anterior to the respective pupil. Each of the lenses 1240 may be identical, although in some examples, one lens 1240 may be different than the other lens 1240 (e.g., have a different magnification).

In certain forms, the display screen 1220 may output two images simultaneously. Each of the user's eyes may be able to see only one of the two images. The images may be displayed side-by-side on the display screen 1220. Each lens 1240 permits each eye to observe only the image proximate to the respective eye. The user may observe these two images together as a single image.

In some forms, the posterior perimeter of each lens 1240 may be approximately the size of the user's orbit. The posterior perimeter may be slightly larger than the size of the user's orbit in order to ensure that the user's entire eye can see into the respective lens 1240. For example, the outer edge of the each lens 1240 may be aligned with the user's frontal bone in the superior direction (e.g., proximate the user's eyebrow), and may be aligned with the user's maxilla in the inferior direction (e.g., proximate the outer cheek region).

The positioning and/or sizing of the lenses 1240 may allow the user to have approximately 360° of peripheral vision in the virtual environment, in order to closely simulate the physical environment.

In some forms, the head-mounted display system 1000 includes a single lens 1240 (e.g., monocular display). The lens 1240 may be positioned anterior to both eyes (e.g., so that both eyes view the image from the display screen 1220 through the lens 1240), or may be positioned anterior to only one eye (e.g., when the image from the displace screen 1220 is viewable by only one eye).

### 5.2.1.4.1 Lens Mounting

The lenses 1240 may be coupled to a spacer positioned proximate to the display screen 1220 (e.g., between the display screen 1220 and the interfacing structure 1100), so that the lenses 1240 are not in direct contact with the display screen 1220 (e.g., in order to limit the lenses 1240 from scratching the display screen 1220).

For example, the lenses 1240 may be recessed relative to the interfacing structure 1100 so that the lenses 1240 are disposed within the viewing opening. In use, each of the user's eyes are aligned with the respective lens 1240 while the user's face is received within the viewing opening (e.g., an operational position).

In some forms, the anterior perimeter of each lens 1240 may encompass approximately half of the display screen 1220. A substantially small gap may exist between the two lenses 1240 along a center line of the display screen 1220. This may allow a user looking through both lenses 1240 to be able to view substantially the entire display screen 1220, and all of the images being output to the user.

In certain forms, the center of the display screen 1220 (e.g., along the center line between the two lenses 1240) may not output an image. For example, in a binocular display (e.g., where each side of the display screen 1220 outputs substantially the same image), each image may be spaced apart on the display screen 1220. This may allow two lenses 1240 to be positioned in close proximity to the display screen 1220, while allowing the user to view the entirety of the image displayed on the display screen 1220.

In some forms, a protective layer 1242 may be formed around at least a portion of the lenses 1240. In use, the protective layer 1242 may be positioned between the user's face and the display screen 1220.

In some forms, a portion of each lens 1240 may project through the protective layer 1242 in the posterior direction. For example, the narrow end of each lens 1240 may project more posterior than the protective layer 1242 in use.

In some forms, the protective layer 1242 may be opaque so that light from the display screen 1220 is unable to pass through. Additionally, the user may be unable to view the display screen 1220 without looking through the lenses 1240.

In some forms, the protective layer 1242 may be non-planar, and may include contours that substantially match contours of the user's face. For example, a portion of the protective layer 1242 may be recessed in the anterior direction in order to accommodate the user's nose.

In certain forms, the user may not contact the protective layer 1242 while wearing the head-mounted display system 1000. This may assist in reducing irritation from additional contact with the user's face (e.g., against the sensitive nasal ridge region).

### 5.2.1.4.2 Corrective Lenses

In some examples, additional lenses may be coupled to the lenses 1240 so that the user looks through both the lens 1240 and the additional lens in order to view the image output by the display screen 1220.

In some forms, the additional lenses are more posterior than the lenses 1240, in use. Thus, the additional lenses are positioned closer to the user's eyes, and the user looks through the additional lenses before looking through the lenses 1240.

In some forms, the additional lenses may have a different magnification than the lenses 1240.

In some forms, the additional lenses, may be prescription strength lenses. The additional lenses may allow a user to view the display screen 1220 without glasses, which may be uncomfortable to wear while using the head-mounted display system 1000. The additional lenses may be removable so that users that do not require the additional lenses may still clearly view the display screen 1220.

### 5.2.2 Positioning and Stabilizing Structure

As shown in FIGS. 4A and 4B, the display screen 1220 and/or the display unit housing 1205 of the head-mounted display system 1000 of the present technology may be held in position in use by the positioning and stabilizing structure 1300.

To hold the display screen 1220 and/or the display unit housing 1205 in its correct operational position, the positioning and stabilizing structure 1300 is ideally comfortable against the user's head in order to accommodate the induced loading from the weight of the display unit in a manner that minimise facial markings and/or pain from prolonged use. There is also need to allow for a universal fit without trading off comfort, usability and cost of manufacture. The design criteria may include adjustability over a predetermined range with low-touch simple set up solutions that have a low dexterity threshold. Further considerations include catering for the dynamic environment in which the head-mounted display system 1000 may be used. As part of the immersive experience of a virtual environment, users may communicate, i.e. speak, while using the head-mounted display system 1000. In this way, the jaw or mandible of the user may move relative to other bones of the skull. Additionally, the whole head may move during the course of a period of use of the head-mounted display system 1000. For example, movement of a user's upper body, and in some cases lower body, and in particular, movement of the head relative to the upper and lower body.

In one form the positioning and stabilizing structure 1300 provides a retention force to overcome the effect of the gravitational force on the display screen 1220 and/or the display unit housing 1205.

In one form of the present technology, a positioning and stabilizing structure 1300 is provided that is configured in a manner consistent with being comfortably worn by a user. In one example the positioning and stabilizing structure 1300 has a low profile, or cross-sectional thickness, to reduce the perceived or actual bulk of the apparatus. In one example, the positioning and stabilizing structure 1300 comprises at least one strap having a rectangular cross-section. In one example the positioning and stabilizing structure 1300 comprises at least one flat strap.

In one form of the present technology, a positioning and stabilizing structure 1300 is provided that is configured so as not to be too large and bulky to prevent the user from comfortably moving their head from side to side.

In one form of the present technology, a positioning and stabilizing structure 1300 comprises a strap constructed from a laminate of a textile user-contacting layer, a foam inner layer and a textile outer layer. In one form, the foam is porous to allow moisture, (e.g., sweat), to pass through the strap. In one form, a skin contacting layer of the strap is formed from a material that helps wick moisture away from the user's face. In one form, the textile outer layer comprises loop material to engage with a hook material portion.

In certain forms of the present technology, a positioning and stabilizing structure 1300 comprises a strap that is extensible, e.g. resiliently extensible. For example the strap may be configured in use to be in tension, and to direct a force to draw the display screen 1220 and/or the display unit housing 1205 toward a portion of a user's face, particularly proximate to the user's eyes and in line with their field of vision. In an example the strap may be configured as a tie.

In one form of the present technology, the positioning and stabilizing structure 1300 comprises a first tie, the first tie being constructed and arranged so that in use at least a portion of an inferior edge thereof passes superior to an otobasion superior of the user's head and overlays a portion of a parietal bone without overlaying the occipital bone.

In one form of the present technology, the positioning and stabilizing structure 1300 includes a second tie, the second tie being constructed and arranged so that in use at least a portion of a superior edge thereof passes inferior to an otobasion inferior of the user's head and overlays or lies inferior to the occipital bone of the user's head.

In one form of the present technology, the positioning and stabilizing structure 1300 includes a third tie that is constructed and arranged to interconnect the first tie and the second tie to reduce a tendency of the first tie and the second tie to move apart from one another.

In certain forms of the present technology, a positioning and stabilizing structure 1300 comprises a strap that is bendable and e.g. non-rigid. An advantage of this aspect is that the strap is more comfortable against a user's head.

In certain forms of the present technology, a positioning and stabilizing structure 1300 comprises a strap constructed to be breathable to allow moisture vapour to be transmitted through the strap.

In certain forms of the present technology, a system is provided comprising more than one positioning and stabilizing structure 1300, each being configured to provide a retaining force to correspond to a different size and/or shape range. For example the system may comprise one form of positioning and stabilizing structure 1300 suitable for a large sized head, but not a small sized head, and another. Suitable for a small sized head, but not a large sized head.

In some forms, the positioning and stabilizing structure 1300 may include cushioning material (e.g., a foam pad) for contacting the user's skin. The cushioning material may provide added wearability to the positioning and stabilizing structure 1300, particularly if positioning and stabilizing structure 1300 is constructed from a rigid or semi-rigid material.

### 5.2.2.1 Temporal Connectors

As shown in FIG. 4C, some forms of the head-mounted display system 1000 or positioning and stabilizing structure 1300 include temporal connectors 1250, each of which may overlay a respective one of the user's temporal bones in use. A portion of the temporal connectors 1250, in-use, are in contact with a region of the user's head proximal to the otobasion superior, i.e. above each of the user's ears. In some examples, temporal connectors are strap portions of a positioning and stabilising structure 1300. In other examples, temporal connectors are arms of a head-mounted display unit 1200. In some examples a temporal connector of a head-mounted display system 1000 may be formed partially by a strap portion (e.g. a lateral strap portion 1330) of a positioning and stabilising structure 1300 and partially by an arm 1210 of a head-mounted display unit 1200.

The temporal connectors 1250 may be lateral portions of the positioning and stabilizing structure 1300, as each temporal connector 1250 is positioned on either the left or the right side of the user's head.

In some forms, the temporal connectors 1250 may extend in an anterior-posterior direction, and may be substantially parallel to the sagittal plane.

In some forms, the temporal connectors 1250 may be coupled to the display unit housing 1205. For example, the temporal connectors 1250 may be connected to lateral sides of the display unit housing 1205. For example, each temporal connector 1250 may be coupled to a respective one of the lateral left face 1234 and the lateral right face 1236.

In certain forms, the temporal connectors 1250 may be pivotally connected to the display unit housing 1205, and may provide relative rotation between each temporal connector 1250, and the display unit housing 1205.

In certain forms, the temporal connectors 1250 may be removably connected to the display unit housing 1205 (e.g., via a magnet, a mechanical fastener, hook and loop material, etc.).

In some forms, the temporal connectors 1250 may be arranged in-use to run generally along or parallel to the Frankfort Horizontal plane of the head and superior to the zygomatic bone (e.g., above the user's cheek bone).

In some forms, the temporal connectors 1250 may be positioned against the user's head similar to arms of eye-glasses, and be positioned more superior than the anti-helix of each respective ear.

In some forms, the temporal connectors 1250 may have a generally elongate and flat configuration. In other words, each temporal connector 1250 is far longer and wider (direction from top to bottom in the paper plane) than thick (direction into the paper plane).

In some forms, the temporal connectors 1250 may each have a three-dimensional shape which has curvature in all three axes (X, Y and Z). Although the thickness of each temporal connector 1250 may be substantially uniform, its height varies throughout its length. The purpose of the shape and dimension of each temporal connector 1250 is to conform closely to the head of the user in order to remain unobtrusive and maintain a low profile (e.g., not appear overly bulky).

In some forms, the temporal connectors 1250 may be constructed from a rigid or semi-rigid material, which may include plastic, hytrel (thermoplastic polyester elastomer), or another similar material. The rigid or semi-rigid material may be self-supporting and/or able to hold its shape without being worn. This can make it more intuitive or obvious for users to understand how to use the positioning and stabilizing structure 1300 and may contrast with a positioning and stabilizing structure 1300 that is entirely floppy and does not retain a shape. Maintaining the temporal connectors 1250 in the in-use state prior to use may prevent or limit distortion whilst the user is donning the positioning and stabilizing structure 1300 and allow a user to quickly fit or wear the head-mounted display system 1000.

In certain forms, the temporal connectors 1250 may be rigidizers, which may allow for a more effective (e.g., direct) translation of tension through the temporal connectors 1250 because rigidizers limit the magnitude of elongation or deformation of the arm while in-use.

In certain forms, the positioning and stabilizing structure 1300 may be designed so that the positioning and stabilizing structure 1300 springs ‘out of the box’ and generally into its in-use configuration. In addition, the positioning and stabilizing structure 1300 may be arranged to hold its in-use shape once out of the box (e.g., because rigidizers may be formed to maintain the shape of some or part of the positioning and stabilizing structure 1300). Advantageously, the orientation of the positioning and stabilizing structure 1300 is made clear to the user as the shape of the positioning and stabilizing structure 1300 is generally curved much like the rear portion of the user's head. That is, the positioning and stabilizing structure 1300 is generally dome shaped.

In certain forms, a flexible and/or resilient material may be disposed around the rigid or semi-rigid material of the temporal connectors 1250. The flexible material may be more comfortable against the user's head, in order to improve wearability and provide soft contact with the user's face. In one form, the flexible material is a textile sleeve at is permanently or removably coupled to each temporal connector 1250.

In one form, a textile may be over-moulded onto at least one side of the rigidizer. In one form, the rigidizer may be formed separately to the resilient component and then a sock of user contacting material (e.g., Breath-O-Prene™) may be wrapped or slid over the rigidizer. In alternative forms, the user contacting material may be provided to the rigidizer by adhesive, ultrasonic welding, sewing, hook and loop material, and/or stud connectors.

In some forms, the user contacting material may be on both sides of the rigidizer, or alternatively may only be on the user contacting side (e.g., the user contacting side) of the rigidizer to reduce bulk and cost of materials.

In some forms, the temporal connectors 1250 are constructed from a flexible material (e.g., a textile), which may be comfortable against the user's skin, and may not require an added layer to increase comfort.

### 5.2.2.2 Posterior Support Portion

As shown in FIG. 4C, some forms of the positioning and stabilizing structure 1300 may include a posterior support portion 1350 for assisting in supporting the display screen 1220 and/or the display unit housing 1205 (shown in FIG. 4B) proximate to the user's eyes. The posterior support portion 1350 may assist in anchoring the display screen and/or the display unit housing 1205 to the user's head in order to appropriately orient the display screen proximate to the user's eyes.

In some forms, the posterior support portion 1350 may be coupled to the display unit housing 1205 via the temporal connectors 1250.

In certain forms, the temporal connectors 1250 may be directly coupled to the display unit housing 1205 and to the posterior support portion 1350.

In some forms, the posterior support portion 1350 may have a three-dimensional contour curve to fit to the shape of a user's head. For example, the three-dimensional shape of the posterior support portion 1350 may have a generally round three-dimensional shape adapted to overlay a portion of the parietal bone and the occipital bone of the user's head, in use.

In some forms, the posterior support portion 1350 may be a posterior portion of the positioning and stabilizing structure 1300. The posterior support portion 1350 may provide an anchoring force directed at least partially in the anterior direction.

In certain forms, the posterior support portion 1350 is the inferior-most portion of the positioning and stabilizing structure 1300. For example, the posterior support portion 1350 may contact a region of the user's head between the occipital bone and the trapezius muscle. The posterior support portion 1350 may hook against an inferior edge of the occipital bone (e.g., the occiput). The posterior support portion 1350 may provide a force directed in the superior direction and/or the anterior direction in order to maintain contact with the user's occiput.

In certain forms, the posterior support portion 1350 is the inferior-most portion of the entire head-mounted display system 1000. For example, the posterior support portion 1350 may be positioned at the base of the user's neck (e.g., overlaying the occipital bone and the trapezius muscle more inferior than the user's eyes) so that the posterior support portion 1350 is more inferior than the display screen 1220 and/or the display unit housing 1205.

In some forms, the posterior support portion 1350 may include a padded material, which may contact the user's head (e.g., overlaying the region between the occipital bone and the trapezius muscle). The padded material may provide additional comfort to the user, and limit marks caused by the posterior support portion 1350 pulling against the user's head.

### 5.2.2.3 Forehead Support

Some forms of the positioning and stabilizing structure 1300 may include a forehead support or frontal support portion 1360 configured to contact the user's head superior to the user's eyes, while in use. The positioning and stabilising structure 1300 shown in FIG. 5B includes a forehead support 1360. In some examples the positioning and stabilising structure 1300 shown in FIG. 4A may include a forehead support 1360. The forehead support 1360 may overlay the frontal bone of the user's head. In certain forms, the forehead support 1360 may also be more superior than the sphenoid bones and/or the temporal bones. This may also position the forehead support 1360 more superior than the user's eyebrows.

In some forms, the forehead support 1360 may be an anterior portion of the positioning and stabilizing structure 1300, and may be disposed more anterior on the user's head than any other portion of the positioning and stabilizing structure 1300. The posterior support portion 1350 may provide a force directed at least partially in the posterior direction.

In some forms, the forehead support 1360 may include a cushioning material (e.g., textile, foam, silicone, etc.) that may contact the user, and may help to limit marks caused by the straps of the positioning and stabilizing structure 1300. The forehead support 1360 and the interfacing structure 1100 may work together in order to provide comfort to the user.

In some forms, the forehead support 1360 may be separate from the display unit housing 1205, and may contact the user's head at a different location (e.g., more superior) than the display unit housing 1205.

In some forms, the forehead support 1360 can be adjusted to allow the positioning and stabilizing structure 1300 to accommodate the shape and/or configuration of a user's face.

In some forms, the temporal connectors 1250 may be coupled to the forehead support 1360 (e.g., on lateral sides of the forehead support 1360). The temporal connectors 1250 may extend at least partially in the inferior direction in order to couple to the posterior support portion 1350.

In certain forms, the positioning and stabilizing structure 1300 may include multiple pairs of temporal connectors 1250. For example, one pair of temporal connectors 1250 may be coupled to the forehead support 1360, and one pair of temporal connectors 1250 may be coupled to the display unit housing 1205.

In some forms, the forehead support 1360 can be presented at an angle which is generally parallel to the user's forehead to provide improved comfort to the user. For example, the forehead support 1360 may position the user in an orientation that overlays the frontal bone, and is substantially parallel to the coronal plane. Positioning the forehead support substantially parallel to the coronal plane can reduce the likelihood of pressure sores which may result from an uneven presentation.

In some forms, the forehead support 1360 may be offset from a rear support or posterior support portion that contacts a posterior region of the user's head (e.g., an area overlaying the occipital bone and the trapezius muscle). In other words, an axis along a rear strap would not intersect the forehead support 1360, which may be disposed more inferior and anterior than the axis along the rear strap. The resulting offset between the forehead support 1360 and the rear strap may create moments that oppose the weight force of the display screen 1220 and/or the display unit housing 1205. A larger offset may create a larger moment, and therefore more assistance in maintaining a proper position of the display screen 1220 and/or the display unit housing 1205. The offset may be increased by moving the forehead support 1360 closer to the user's eyes (e.g., more anterior and inferior along the user's head), and/or increasing the angle of the rear strap so that it is more vertical.

### 5.2.2.4 Adjustable Straps

As shown in FIG. 4C, portions of the positioning and stabilizing structure 1300 may be adjustable, in order to impart a selective tensile force on the display screen 1220 and/or the display unit housing 1205 in order to secure a position of the display screen 1220 and/or the display unit housing 1205.

In some forms, the display unit housing 1205 may include at least one loop or eyelet 1254 (as shown in FIG. 4B), and at least one of the temporal connectors 1250 may be threaded through that loop, and doubled back on itself. The length of the temporal connector 1250 threaded through the respective eyelet 1254 may be selected by the user in order to adjust the tensile force provided by the positioning and stabilizing structure 1300. For example, threading a greater length of the temporal connector 1250 through the eyelet 1254 may supply a greater tensile force.

In some forms, at least one of the temporal connectors 1250 may include an adjustment portion 1256 and a receiving portion 1258 (as shown in FIG. 4C). The adjustment portion 1256 may be positioned through the eyelet 1254 on the display unit housing 1205, and may be coupled to the receiving portion 1258 (e.g., by doubling back on itself). The adjustment portion 1256 may include a hook material, and the receiving portion 1258 may include a loop material (or vice versa), so that the adjustment portion 1256 may be removably held in the desired position. In some examples, the hook material and the loop material may be Velcro.

In certain forms, adjusting the position of the adjustment portion 1256 relative to the receiving portion 1258 may apply a posterior force to the display screen 1220 and/or the display unit housing 1205, and increase or decrease a sealing force of the light shield against the user's head (e.g., when the light shield acts as a seal-forming structure).

In certain forms, the adjustment portion 1256 may be constructed from a flexible and/or resilient material, which may conform to a shape of the user's head and/or may allow the adjustment portion to be threaded through the eyelet 1254. For example, the adjustment portion(s) 1256 may be constructed from an elastic textile, which may provide an elastic, tensile force. The remainder of the temporal connectors 1250 may be constructed from the rigid or semi-rigid material described above (although it is contemplated that additional sections of the temporal connectors 1250 may also be constructed from a flexible material).

### 5.2.2.4.1 Top Strap

In some forms, the positioning and stabilizing structure 1300 may include a top strap portion, which may overlay a superior region of the user's head. The head-mounted display system 1000 shown in FIG. 1A has a top strap portion, for example.

In some forms, the top strap portion may extend between an anterior portion of the head-mounted display system 1000 and a posterior region of the head-mounted display system 1000.

In some forms, the top strap portion may be constructed from a flexible material, and may be configured to compliment the shape of the user's head.

In certain forms, the top strap portion may be connected to the display unit housing 1205. For example, the top strap portion may be coupled to the superior face 1230. The top strap portion may also be coupled to the display unit housing 1205 proximate to a posterior end of the display unit housing 1205.

In certain forms, the top strap portion may be coupled to the forehead support 1360. For example, the top strap portion may be coupled to the forehead support 1360 proximate to a superior edge. The top strap portion may be connected to the display unit housing 1205 through the forehead support 1360.

In some forms, the top strap portion may be connected to the posterior support portion 1350. For example, the top strap portion may be connected proximate to a superior edge of the posterior support portion 1350.

In some forms, the top strap portion may overlay the frontal bone and the parietal bone of the user's head.

In certain forms, the top strap portion may extend along the sagittal plane as it extends between the anterior and posterior portions of the head-mounted display system 1000.

In certain forms, the top strap portion may apply a tensile force oriented at least partially in the superior direction, which may oppose the force of gravity.

In certain forms, the top strap portion may apply a tensile force oriented at least partially in the posterior direction, which may pull the interfacing structure 1100 toward the user's face (and supply a portion of the sealing force when the light shield acts as a seal-forming structure).

In some forms, the top strap portion may be adjustable in order to impart a selective tensile force on the display screen 1220 and/or the display unit housing 1205 in order to secure a position of the display screen 1220 and/or the display unit housing 1205.

In certain forms, the display unit housing 1205 and/or the forehead support 1360 (as the case may be) may include at least one loop or eyelet 1254, and the top strap portion may be threaded through that eyelet 1254, and doubled back on itself. The length of the top strap portion threaded through the eyelet 1254 may be selected by the user in order to adjust the tensile force provided by the positioning and stabilizing structure 1300. For example, threading a greater length of the top strap portion through the eyelet 1254 may supply a greater tensile force.

In some forms, the top strap portion may include an adjustment portion and a receiving portion. The adjustment portion may be positioned through the eyelet 1254, and may be coupled to the receiving portion (e.g., by doubling back on itself). The adjustment portion may include a hook material, and the receiving portion may include a loop material (or vice versa), so that the adjustment portion may be removably held in the desired position. In some examples, the hook material and the loop material may be Velcro.

### 5.2.2.5 Rotational Control

In some forms, the display unit housing 1205 and/or the display screen 1220 may pivot relative to the user's face while the user has donned the positioning and stabilizing structure. This may allow the user to see the physical environment while still wearing the user interface 1100. This may be useful for users who want to take a break for viewing the virtual environment, but do not wish to doff the positioning and stabilizing structure 1300.

In some forms, a pivot connection 1260 may be formed between a superior portion of the display unit housing 1205 and the positioning and stabilizing structure 1300. For example, the pivot connection 1260 may be formed on the superior face 1230 of the display unit housing 1205.

In certain forms, the pivot connection 1260 may be coupled to the forehead support 1360. The display unit housing 1205 may be able to pivot about an inferior edge of the forehead support 1360.

In one form, the temporal connectors 1250 may be coupled to the forehead support 1360 in order to allow the display unit housing 1205 to pivot.

In some forms, the pivot connection 1260 may be a ratchet connection, and may maintain the display unit housing 1205 in a raised position without additional user intervention.

### 5.2.3 Controller

As shown in FIG. 6, some forms of the head-mounted display system 1000 include a controller 1270 that can be engageable by the user in order to provide user input to the virtual environment and/or to control the operation of the head-mounted display system 1000. The controller 1270 can be connected to the head-mounted display unit 1200, and provide the user the ability to interact with virtual objects output to the user from the head-mounted display unit 1200.

### 5.2.3.1 Handheld Controller

In some forms, the controller 1270 may include a handheld device, and may be easily grasped by a user with a single hand.

In certain forms, the head-mounted display system 1000 may include two handheld controllers. The handheld controllers may be substantially identical to one another, and each handheld controller may be actuatable by a respective one of the user's hands.

In some forms, the user may interact with the handheld controller(s) in order to control and/or interact with virtual objects in the virtual environment.

In some forms, the handheld controller includes a button that may be actuatable by the user. For example, the user's fingers may be able to press the button while grasping the handheld controller.

In some forms, the handheld controller may include a directional control (e.g., a joystick, a control pad, etc.). The user's thumb may be able to engage the directional control while grasping the handheld controller.

In certain forms, the controller 1270 may be wirelessly connected to the head-mounted display unit 1200. For example, the controller 1270 and the head-mounted display unit 1200 may be connected via Bluetooth, Wi-Fi, or any similar means.

In certain forms, the controller 1270 and the head-mounted display unit 1200 may be connected with a wired connection.

### 5.2.3.2 Fixed Controller

In some forms, at least a portion of the controller 1270 may be integrally formed on the display unit housing 1205.

In some forms, the controller 1270 may include control buttons that are integrally formed on the display unit housing 1205. For example, the control buttons may be formed on the superior face 1230 and/or the inferior face 1232, so as to be engageable by the user's fingers when holding the user's palm rests against the lateral left or right face 1234, 1236 of the display unit housing 1205. Control buttons may also be disposed on other faces of the display unit housing 1205.

In some forms, the user may interact with the control buttons in order to control at least one operation of the head-mounted display system 1000. For example, the control button may be an On/Off button, which may selectively control whether the display screen 1220 is outputting an image to the user.

In certain forms, the control buttons and the head-mounted display unit 1200 may be connected with a wired connection.

In some forms, the head-mounted display system 1000 may include both the handheld controller and the control buttons.

### 5.2.4 Speaker

With reference to FIG. 6, in some forms the head-mounted display system 1000 includes a sound system or speakers 1272 that may be connected to the head-mounted display unit 1200 and positionable proximate to the user's ears in order to provide the user with an auditory output.

In some forms, the speakers 1272 may be positionable around the user's ears, and may block or limit the user from hearing ambient noise.

In certain forms, the speakers 1272 may be wirelessly connected to the head-mounted display unit 1200. For example, the speakers 1272 and the head-mounted display unit 1200 may be connected via Bluetooth, Wi-Fi, or any similar means.

In some forms, the speaker 1272 includes a left ear transducer and a right ear transducer. In some forms, the left and right ear transducers may output different signals, so that the volume and or noise heard by the user in one ear (e.g., the left ear) may be different than the volume and or noise heard by the user in the other ear (e.g., the right ear).

In some forms, the speaker 1272 (e.g., the volume of the speaker 1272) may be controlled using the controller 1270.

### 5.2.5 Power Source

With reference to FIG. 6, some forms of the head-mounted display system 1000 may include an electrical power source 1274 can provide electrical power to the head-mounted display unit 1200 and any other electrical components of the head-mounted display system 1000.

In certain forms, the power source 1274 may include a wired electrical connection that may be coupled to an external power source, which may be fixed to a particular location.

In certain forms, the power source 1274 may include a portable battery that may provide power to the head-mounted display unit 1200. The portable battery may allow the user greater mobility than compared to a wired electrical connection.

In certain forms, the head-mounted display system 1000 and/or other electronic components of the head-mounted display system 1000 may include internal batteries, and may be usable without the power source 1274.

In some forms, the head-mounted display system 1000 may include the power source 1274 in a position remote from the head-mounted display unit 1200. Electrical wires may extend from the distal location to the display unit housing 1205 in order to electrically connect the power source 1274 to the head-mounted display unit 1200.

In certain forms, the power source 1274 may be coupled to the positioning and stabilizing structure 1300. For example, the power source 1274 may be coupled to a strap of the positioning and stabilizing structure 1300, either permanently or removably. The power supply 1274 may be coupled to a posterior portion of the positioning and stabilizing structure 1300, so that it may be generally opposite the display unit housing 1205 and/or the head-mounted display unit 1200. The weight of the power source 1274, and the weight of the head-mounted display unit 1200 and the display unit housing 1205 may therefore be spread throughout the head-mounted display system 1000, instead of concentrated at the anterior portion of the head-mounted display system 1000. Shifting weight to the posterior portion of the head-mounted display system 1000 may limit the moment created at the user's face, which may improve comfort and allow the user to wear the head-mounted display system 1000 for longer periods of time.

In certain forms, the power source 1274 may be supported by a user distal to the user's head. For example, the power source 1274 may connected to the head-mounted display unit 1200 and/or the display unit housing 1205 only through an electrical connector (e.g., a wire). The power source 1274 may be stored in the user's pants pocket, on a belt clip, or a similar way which supports the weight of the power source 1274. This removes weight that the user's head is required to support, and may make wearing the head-mounted display system 1000 more comfortable for the user.

In some forms, the head-mounted display unit 1200 may include the power source 1274. For example, the display unit 1220 may be a cell phone, or other similar electronic device, which includes an internal power source 1274.

### 5.2.6 Control System

With reference to FIG. 6, some forms of the head-mounted display system 1000 include a control system 1276 that assists in controlling the output received by the user. Specifically, the control system 1276 can control visual output from the display screen 1220 and/or auditory output from the speakers 1272.

In some forms, the control system 1276 may include sensors that monitor different parameters (e.g., in the physical environment), and communicates measured parameters to a processor. The output received by the user may be affected by the measured parameters.

In some forms, the control system 1276 is integrated into the head-mounted display unit 1200. In other forms, the control system 1276 is housed in a control system support 1290 that is separate from, but connected to (e.g., electrically connected to) the head-mounted display unit 1200.

### 5.2.6.1 Power Source

In some forms, the control system 1276 may be powered by the power source 1274, which may be at least one battery used for powering components of the control system 1276. For example, sensors of the control system 1276 may be powered by the power source 1274.

In some forms, the at least one battery of the power source 1274 may be a low power system battery 1278 and a main battery 1280.

In certain forms, the low power system battery 1278 may be used to power a real time (RT) clock 1282 of the control system 1276.

### 5.2.6.1.1 Integrated Power Support Portion

In some forms, a battery support portion 1288 may support the low power system battery 1278 and/or the main battery 1280. The battery support portion 1288 may be directly supported on the head-mounted display system 1000.

In some forms, the battery support portion 1288 may be disposed within the display unit housing 1205.

In some forms, the battery support portion 1288 may be disposed on the positioning and stabilizing structure 1300. For example, the battery support portion 1288 may be coupled to the posterior support portion 1350. The weight of the head-mounted display system 1000 may be better balanced around the user's head. One form of a battery support portion 1288 is a battery pack housing, which will be described in more detail herein.

### 5.2.6.1.2 Remote Power Support Portion

In some forms, a battery support portion 1288 may support the low power system battery 1278 and/or the main battery 1280. The battery support portion 1288 may be coupled to the user independently of the positioning and stabilizing structure 1300 and/or the display unit housing 1205 (e.g., it may be coupled via a belt clip). The battery support portion 1288 also may be supported remote from the user's body (e.g., if the head-mounted display system 1000 receives power from a computer or video game console). A tether may couple the battery support portion 1288 to the control system 1276 and/or other electronics. The positioning of the battery support portion may improve comfort for the user, since the weight of the low power system battery 1278 and/or the main battery 1280 are not supported by the user's head.

### 5.2.6.2 Orientation Sensor

In some forms, the control system 1276 includes an orientation sensor 1284 that can sense the orientation of the user's body. For example, the orientation sensor 1284 may sense when the user rotates their body as a whole, and/or their head individually. In other words, the orientation sensor 1284 may measure an angular position (or any similar parameter) of the user's body. By sensing the rotation, the sensor 1284 may communicate to the display screen 1220 to output a different image.

In some examples, an external orientation sensor may be positioned in the physical environment where the user is wearing the head-mounted display system 1000. The external position sensor may track the user's movements similar to the orientation sensor 1284 described above. Using an external orientation sensor may reduce the weight required to be supported by the user.

### 5.2.6.2.1 Camera

In some forms, the control system 1276 may include at least one camera, which may be positioned to view the physical environment of the user.

In some forms, the orientation sensor 1284 is a camera, which may be configured to observe the user's physical environment in order to determine the orientation of the user's head (e.g., in what direction the user's head has tilted).

In some forms, the orientation sensor 1284 includes multiple cameras positioned throughout the head-mounted display system 1000 in order to provide a more complete view of the user's physical environment, and more accurately measure the orientation of the user's head.

In some forms, the cameras 1284 are coupled to the anterior face 1238 of the display unit housing 1205. The cameras 1284 may be positioned in order to in order to provide a “first-person” view.

In certain forms, the display screen 1220 may display the user's physical environment by using the cameras 1284, so that the user may feel as though they are viewing their physical environment without assistance from the head-mounted display system 1000 (i.e., the first person view). This may allow the user to move around their physical environment without removing the head-mounted display system 1000.

In one form, virtual objects may be displayed while the display screen 1220 is displaying the user's physical environment. The cameras 1284 may allow the head-mounted display system 1000 to operate as an MR device. The control system 1276 may include a control to switch operation between a VR device and an MR device.

### 5.2.6.3 Eye Sensor

In some forms, the control system 1276 may include an eye sensor that can track movement of the user's eyes. For example, the eye sensor may be able to measure a position of at least one of the user's eyes, and determine which direction at least one of the user's eyes are looking.

In some forms, the control system 1276 may include two eye sensors. Each sensor may correspond to one of the user's eyes.

In some forms, the eye sensors may be disposed in or proximate to the lenses 1240.

In some forms, the eye sensors may measure an angular position of the user's ears in order to determine the visual output from the display screen 1220.

### 5.2.6.4 Processing System

In some forms, the control system 1276 includes a processing system that may receive the measurements from the various sensors of the control system 1276.

In some forms, the processing system may receive measurements recorded by the orientation sensor 1284 and/or the eye sensors. Based on these measured values, the processor can communicate with the display screen 1220 in order to change the image being output. For example, if the user's eyes and/or the user's head pivots in the superior direction, the display screen 1220 may display a more superior portion of the virtual environment (e.g., in response to direction from the processing system).

### 5.3 Augmented Reality Display Interface

As shown in FIGS. 5A and 5B, a display apparatus or head-mounted display system 1000 in accordance with one aspect of the present technology comprises the following functional aspects: a display screen 1220, a display unit housing 1205, and a positioning and stabilizing structure 1300. In some forms, a functional aspect may provide one or more physical components. In some forms, one or more physical components may provide one or more functional aspects. In use, the display screen 1220 is arranged to be positioned proximate and anterior to the user's eyes, so as to allow the user to view the display screen 1220.

In other aspects, the head-mounted display system 1000 may also include an interfacing structure 1100, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

### 5.3.1 Display Unit

The head-mounted display unit 1200 may include a structure for providing an observable output to a user. Specifically, the head-mounted display unit 1200 is arranged to be held (e.g., manually, by a positioning and stabilizing structure, etc.) in an operational position in front of a user's face.

In some examples, the head-mounted display unit 1200 may include a display screen 1220, a display unit housing 1205, and/or an interfacing structure 1100. These components may be integrally formed in a single head-mounted display unit 1200, or they may be separable and selectively connected by the user to form the head-mounted display unit 1200. Additionally, the display screen 1220, the display unit housing 1205, and/or the interfacing structure 1100 may be included in the head-mounted display system 1000, but may not be part of the head-mounted display unit 1200.

### 5.3.1.1 Display Screen

As shown in FIG. 5A, some forms of the head-mounted display unit 1200 include a display screen 1220. The display screen 1220 may include electrical components that provide an observable output to the user.

In one form of the present technology shown in FIG. 5A and FIG. 5B, a display screen 1220 provides an optical output observable by the user. The optical output allows the user to observe a virtual environment and/or a virtual object.

The display screen 1220 may be positioned proximate to the user's eyes, in order to allow the user to view the display screen 1220. For example, the display screen 1220 maybe positioned anterior to the user's eyes. The display screen 1220 can display computer generated images that can be view by the user in order to augment the user's physical environment (e.g., the computer generated images may appear as though they are present in the user's physical environment).

In some forms, the display screen 1220 is an electronic display. The display screen 1220 may be a liquid crystal display (LCD), or a light emitting diode (LED) screen.

In some forms, the computer generated image may be projected onto the display screen 1220.

In some forms, the display screen 1220 may extend wider a distance between the user's pupils. The display screen 1220 may also be wider than a distance between the user's cheeks.

In some forms, the display screen 1220 may display at least one image that is observable by the user. For example, the display screen 1220 may display images that change based on predetermined conditions (e.g., passage of time, movement of the user, input from the user, etc.).

In certain forms, portions of the display screen 1220 may be visible to only one of the user's eyes. In other words, a portion of the display screen 1220 may be positioned proximate and anterior to only one of the user's eyes (e.g., the right eye), and is blocked from view from the other eye (e.g., the left eye).

In one example, the display screen 1220 may be divided into two sides (e.g., a left side and a right side), and may display two images at a time (e.g., one image on either side).

Each side of the display screen 1220 may display a similar image. In some examples, the images may be identical, while in other examples, the images may be slightly different.

Together, the two images on the display screen 1220 may form a binocular display, which may provide the user with a more realistic AR or MR experience. In other words, the user's brain may process the two images from the display screen 1220 together as a single image. Providing two (e.g., un-identical) images may allow the user to view virtual objects on their periphery, and expand their field of view in the virtual environment.

In certain forms, the display screen 1220 may be positioned in order to be visible by both of the user's eyes. The display screen 1220 may output a single image at a time, which is viewable by both eyes. This may simplify the processing as compared to the multi-image display screen 1220.

In some forms, the head-mounted display system 1000 includes a single lens 1240 (e.g., monocular display). The lens 1240 may be positioned anterior to both eyes (e.g., so that both eyes view the image from the display screen 1220 through the lens 1240), or may be positioned anterior to only one eye (e.g., when the image from the displace screen 1220 is viewable by only one eye). This may be particularly useful in AR or MR, where the user may want limited virtual stimulation, and may wish to observe the physical environment without an overlayed virtual object.

In certain forms, particularly when using the display screen 1220 in an AR or MR environment, the display screen 1220 may be turned off while the user continues to wear the display screen 1220 and interact with the physical environment. This may allow the user to selectively choose when to receive the virtual stimulation, and when to observe only the physical environment.

In certain forms, the display screen 1220 may be transparent (or translucent). For example, the display screen 1220 may be glass, so the user can see through the display screen 1220. This may be particularly beneficial in AR or MR applications, so that the user can continue to see the physical environment.

### 5.3.1.1.1 Optical Lenses

As shown in FIG. 5A, the display screen 1220 may be disposed within a lens 1240. The user may view an image provided by the display screen 1220 through the lens 1240. The lens 1240 may be transparent and/or translucent along with the display screen 1220 so that the user may observe their physical environment while looking through the lens 1240. In some examples, the user may be able to observe (e.g., visually observe) their physical environment regardless of the presence or absence of a computer generated image output by the display screen 1220.

In some forms, the head-mounted display system 1000 includes two lenses 1240, one for each of the user's eyes. In other words, each of the user's eyes may look through a separate lens positioned anterior to the respective pupil. Each of the lenses 1240 may be identical, although in some examples, one lens 1240 may be different than the other lens 1240 (e.g., have a different magnification). For example, the lenses 1240 may be prescription lenses 1240, and each of the user's eyes may have a different prescription.

In certain forms, the display screen 1220 may output two images simultaneously. Each of the user's eyes may be able to see only one of the two images. The images may be displayed side-by-side on the display screen 1220. Each lens 1240 permits each eye to observe only the image proximate to the respective eye. The user may observe these two images together as a single image.

In certain forms, each lens 1240 may include a separate display screen 1220 that outputs different images. For example, different computer generated images may be displayed to the user's eyes.

In one form, the user may control whether both, one, or none of the display screens 1220 are outputting simultaneously. This may be beneficial to a user if they wish to switch which eye is observing the computer generated images.

In some forms, the head-mounted display system 1000 includes a single lens 1240 (e.g., monocular display). The lens 1240 may be positioned anterior to both eyes (e.g., so that both eyes view the image from the display screen 1220 through the lens 1240), or may be positioned anterior to only one eye (e.g., when the image from the displace screen 1220 is viewable by only one eye).

### 5.3.1.2 Display Housing

In some forms of the present technology as shown in FIGS. 5A and 5B, a display unit housing 1205 provides a support structure for the display screen 1220, in order to maintain a position of at least some of the components of the display screen 1220 relative to one another, and may additionally protect the display screen 1220 and/or other components of the head-mounted display unit 1200. The display unit housing 1205 may be constructed from a material suitable to provide protection from impact forces to the display screen 1220. The display unit housing 1205 may also contact the user's face, and may be constructed from a biocompatible material suitable for limiting irritation to the user.

A display unit housing 1205 in accordance with some forms of the present technology may be constructed from a hard, rigid or semi-rigid material, such as plastic.

In certain forms, the rigid or semi-rigid material may be at least partially covered with a soft and/or flexible material (e.g., a textile, silicone, etc.). This may improve biocompatibility and/or user comfort because the at least a portion of the display unit housing 1205 that the user engages (e.g., grabs with their hands) includes the soft and/or flexible material.

A display unit housing 1205 in accordance with other forms of the present technology may be constructed from a soft, flexible, resilient material, such as silicone rubber.

In some forms, the display screen 1220 may project at least partially out of the display unit housing 1205. For example, unlike in a VR head-mounted display system 1000, the display screen 1220 in an AR (or MR) head-mounted display system 1000 may not be completely enclosed by the by the display unit housing 1205. The user may be able to directly view the display screen 1220, and may be able to look through the display screen 1220 (e.g., if the display screen 1220 is transparent or translucent).

In certain forms, the display unit housing 1205 may support sensors or other electronics described below. The display unit housing 1205 may provide protection to the electronics without substantially obstructing the user's view of the display screen 1220.

### 5.3.1.3 Interface Structure

As shown in FIGS. 5A and 5B, some forms of the present technology include an interfacing structure 1100 (also identified as “interface”, “user interface”, “interface structure” or the like) is positioned and/or arranged in order to conform to a shape of a user's face, and may provide the user with added comfort while wearing and/or using the head-mounted display system 1000.

In some forms, the interfacing structure 1100 is coupled to a surface of the display unit housing 1205.

In some forms, the interfacing structure 1100 in accordance with the present technology may be constructed from a biocompatible material.

In some forms, the interfacing structure 1100 in accordance with the present technology may be constructed from a soft, flexible, and/or resilient material.

In certain forms, the interfacing structure 1100 in accordance with the present technology may be constructed from silicone rubber and/or foam.

In some forms, the interfacing structure 1100 may contact sensitive regions of the user's face, which may be locations of discomfort. The material forming the interfacing structure 1100 may cushion these sensitive regions, and limit user discomfort while wearing the head-mounted display system 1000.

In certain forms, these sensitive regions may include the user's forehead. Specifically, this may include the region of the user's head that is proximate to the frontal bone, like the Epicranius and/or the glabella. This region may be sensitive because there is limited natural cushioning from muscle and/or fat between the user's skin and the bone. Similarly, the ridge of the user's nose may also include little to no natural cushioning.

In some forms, the interfacing structure 1100 can comprise a single element. In some embodiments the interfacing structure 1100 may be designed for mass manufacture. For example, the interfacing structure 1100 can be designed to comfortably fit a wide range of different face shapes and sizes.

In some forms, the interfacing structure 1100 may include different elements that overlay different regions of the user's face. The different portions of the interfacing structure 1100 may be constructed from different materials, and provide the user with different textures and/or cushioning at different regions.

In some forms, the interface structure 1100 may include nasal pads (e.g., as used in eye-glasses) that may contact the lateral sides of the user's nose. The nasal pads may apply light pressure to the user's nose to maintain the position of the head-mounted display system 1000, but may not apply a force that causes significant discomfort (e.g., the nasal pads may not receive a posterior directed tensile force).

### 5.3.2 Positioning and Stabilizing Structure

As shown in FIGS. 5A to 5B, the display screen 1220 and/or the display unit housing 1205 of the head-mounted display system 1000 of the present technology may be held in position in use by the positioning and stabilizing structure 1300.

To hold the display screen 1220 and/or the display unit housing 1205 in its correct operational position, the positioning and stabilizing structure 1300 is ideally comfortable against the user's head in order to accommodate the induced loading from the weight of the display unit in a manner that minimise facial markings and/or pain from prolonged use. There is also need to allow for a universal fit without trading off comfort, usability and cost of manufacture. The design criteria may include adjustability over a predetermined range with low-touch simple set up solutions that have a low dexterity threshold. Further considerations include catering for the dynamic environment in which the head-mounted display system 1000 may be used. As part of the immersive experience of a virtual environment, users may communicate, i.e. speak, while using the head-mounted display system 1000. In this way, the jaw or mandible of the user may move relative to other bones of the skull. Additionally, the whole head may move during the course of a period of use of the head-mounted display system 1000. For example, movement of a user's upper body, and in some cases lower body, and in particular, movement of the head relative to the upper and lower body.

In one form the positioning and stabilizing structure 1300 provides a retention force to overcome the effect of the gravitational force on the display screen 1220 and/or the display unit housing 1205.

In one form of the present technology, a positioning and stabilizing structure 1300 is provided that is configured in a manner consistent with being comfortably worn by a user. In one example the positioning and stabilizing structure 1300 has a low profile, or cross-sectional thickness, to reduce the perceived or actual bulk of the apparatus. In one example, the positioning and stabilizing structure 1300 comprises at least one strap having a rectangular cross-section. In one example the positioning and stabilizing structure 1300 comprises at least one flat strap.

In one form of the present technology, a positioning and stabilizing structure 1300 is provided that is configured so as not to be too large and bulky to prevent the user from comfortably moving their head from side to side.

In one form of the present technology, a positioning and stabilizing structure 1300 comprises a strap constructed from a laminate of a textile user-contacting layer, a foam inner layer and a textile outer layer. In one form, the foam is porous to allow moisture, (e.g., sweat), to pass through the strap. In one form, a skin contacting layer of the strap is formed from a material that helps wick moisture away from the user's face. In one form, the textile outer layer comprises loop material to engage with a hook material portion.

In certain forms of the present technology, a positioning and stabilizing structure 1300 comprises a strap that is extensible, e.g. resiliently extensible. For example the strap may be configured in use to be in tension, and to direct a force to draw the display screen 1220 and/or the display unit housing 1205 toward a portion of a user's face, particularly proximate to the user's eyes and in line with their field of vision. In an example the strap may be configured as a tie.

In one form of the present technology, the positioning and stabilizing structure 1300 comprises a first tie, the first tie being constructed and arranged so that in use at least a portion of an inferior edge thereof passes superior to an otobasion superior of the user's head and overlays a portion of a parietal bone without overlaying the occipital bone.

In one form of the present technology, the positioning and stabilizing structure 1300 includes a second tie, the second tie being constructed and arranged so that in use at least a portion of a superior edge thereof passes inferior to an otobasion inferior of the user's head and overlays or lies inferior to the occipital bone of the user's head.

In one form of the present technology, the positioning and stabilizing structure 1300 includes a third tie that is constructed and arranged to interconnect the first tie and the second tie to reduce a tendency of the first tie and the second tie to move apart from one another.

In certain forms of the present technology, a positioning and stabilizing structure 1300 comprises a strap that is bendable and e.g. non-rigid. An advantage of this aspect is that the strap is more comfortable against a user's head.

In certain forms of the present technology, a positioning and stabilizing structure 1300 comprises a strap constructed to be breathable to allow moisture vapour to be transmitted through the strap.

In certain forms of the present technology, a system is provided comprising more than one positioning and stabilizing structure 1300, each being configured to provide a retaining force to correspond to a different size and/or shape range. For example the system may comprise one form of positioning and stabilizing structure 1300 suitable for a large sized head, but not a small sized head, and another. Suitable for a small sized head, but not a large sized head.

In some forms, the positioning and stabilizing structure 1300 may include cushioning material (e.g., a foam pad) for contacting the user's skin. The cushioning material may provide added wearability to the positioning and stabilizing structure 1300, particularly if positioning and stabilizing structure 1300 is constructed from a rigid or semi-rigid material.

### 5.3.2.1 Temporal Connectors

As shown in FIG. 5B, some forms of the positioning and stabilizing structure 1300 include temporal connectors 1250, each of which may overlay a respective one of the user's temporal bones in use. A portion of the temporal connectors 1250, in-use, are in contact with a region of the user's head proximal to the otobasion superior, i.e. above each of the user's ears.

The temporal connectors 1250 may be lateral portions of the positioning and stabilizing structure 1300, as each temporal connector 1250 is positioned on either the left or the right side of the user's head.

In some forms, the temporal connectors 1250 may extend in an anterior-posterior direction, and may be substantially parallel to the sagittal plane.

In some forms, the temporal connectors 1250 may be coupled to the display unit housing 1205. For example, the temporal connectors 1250 may be connected to lateral sides of the display unit housing 1205.

In some forms, the temporal connectors 1250 may be arranged in-use to run generally along or parallel to the Frankfort Horizontal plane of the head and superior to the zygomatic bone (e.g., above the user's cheek bone).

In some forms, the temporal connectors 1250 may be positioned against the user's head similar to arms of eye-glasses, and be positioned more superior than the anti-helix of each respective ear.

In some forms, the temporal connectors 1250 may have a generally elongate and flat configuration. In other words, each temporal connector 1250 is far longer and wider (direction from top to bottom in the paper plane) than thick (direction into the paper plane).

In some forms, the temporal connectors 1250 may each have a three-dimensional shape which has curvature in all three axes (X, Y and Z). Although the thickness of each temporal connector 1250 may be substantially uniform, its height varies throughout its length. The purpose of the shape and dimension of each temporal connector 1250 is to conform closely to the head of the user in order to remain unobtrusive and maintain a low profile (e.g., not appear overly bulky).

In some forms, the temporal connectors 1250 may be constructed from a rigid or semi-rigid material, which may include plastic, Hytrel (thermoplastic polyester elastomer), or another similar material. The rigid or semi-rigid material may be self-supporting and/or able to hold its shape without being worn. This can make it more intuitive or obvious for users to understand how to use the positioning and stabilizing structure 1300 and may contrast with a positioning and stabilizing structure 1300 that is entirely floppy and does not retain a shape. Maintaining the temporal connectors 1250 in the in-use state prior to use may prevent or limit distortion whilst the user is donning the positioning and stabilizing structure 1300 and allow a user to quickly fit or wear the head-mounted display system 1000.

In certain forms, the temporal connectors 1250 may be rigidizers, which may allow for a more effective (e.g., direct) translation of tension through the temporal connectors 1250 because rigidizers limit the magnitude of elongation or deformation of the arm while in-use.

In certain forms, the positioning and stabilizing structure 1300 may be designed so that the positioning and stabilizing structure 1300 springs ‘out of the box’ and generally into its in-use configuration. In addition, the positioning and stabilizing structure 1300 may be arranged to hold its in-use shape once out of the box (e.g., because rigidizers may be formed to maintain the shape of some or part of the positioning and stabilizing structure 1300). Advantageously, the orientation of the positioning and stabilizing structure 1300 is made clear to the user as the shape of the positioning and stabilizing structure 1300 is generally curved much like the rear portion of the user's head. That is, the positioning and stabilizing structure 1300 is generally dome shaped.

In certain forms, a flexible and/or resilient material may be disposed around the rigid or semi-rigid material of the temporal connectors 1250. The flexible material may be more comfortable against the user's head, in order to improve wearability and provide soft contact with the user's face. In one form, the flexible material is a textile sleeve at is permanently or removably coupled to each temporal connector 1250.

In one form, a textile may be over-moulded onto at least one side of the rigidizer. In one form, the rigidizer may be formed separately to the resilient component and then a sock of user contacting material (e.g., Breath-O-Prene™M) may be wrapped or slid over the rigidizer. In alternative forms, the user contacting material may be provided to the rigidizer by adhesive, ultrasonic welding, sewing, hook and loop material, and/or stud connectors.

In some forms, the user contacting material may be on both sides of the rigidizer, or alternatively may only be on the user contacting side (e.g., the user contacting side) of the rigidizer to reduce bulk and cost of materials.

In some forms, the temporal connectors 1250 are constructed from a flexible material (e.g., a textile), which may be comfortable against the user's skin, and may not require an added layer to increase comfort.

Some forms of the positioning and stabilizing structure 1300 may include only temporal connectors 1250. The temporal connectors 1250 may be shaped like temples or arms of eye-glasses, and may rest against the user's head in a similar manner. For example, the temporal arms 3304 may provide a force directed into lateral sides of the user's head (e.g., toward the respective temporal bone).

### 5.3.2.2 Posterior Support Portion

As shown in FIG. 5B, some forms of the positioning and stabilizing structure 1300 may include a rear support, e.g. a posterior support portion 1350 for assisting in supporting the display screen 1220 and/or the display unit housing 1205 proximate to the user's eyes. The posterior support portion 1350 may assist in anchoring the display screen 1220 and/or the display unit housing 1205 to the user's head in order to appropriately orient the display screen 1220 proximate to the user's eyes.

In some forms, the posterior support portion 1350 may be coupled to the display unit housing 1205 via the temporal connectors 1250.

In certain forms, the temporal connectors 1250 may be directly coupled to the display unit housing 1205 and to the posterior support portion 1350.

In some forms, the posterior support portion 1350 may have a three-dimensional contour curve to fit to the shape of a user's head. For example, the three-dimensional shape of the posterior support portion 1350 may have a generally round three-dimensional shape adapted to overlay a portion of the parietal bone and the occipital bone of the user's head, in use.

In some forms, the posterior support portion 1350 may be a posterior portion of the positioning and stabilizing structure 1300. The posterior support portion 1350 may provide an anchoring force directed at least partially in the anterior direction.

In certain forms, the posterior support portion 1350 is the inferior-most portion of the positioning and stabilizing structure 1300. For example, the posterior support portion 1350 may contact a region of the user's head between the occipital bone and the trapezius muscle. The posterior support portion 1350 may hook against an inferior edge of the occipital bone (e.g., the occiput). The posterior support portion 1350 may provide a force directed in the superior direction and/or the anterior direction in order to maintain contact with the user's occiput.

In certain forms, the posterior support portion 1350 is the inferior-most portion of the entire head-mounted display system 1000. For example, the posterior support portion 1350 may be positioned at the base of the user's neck (e.g., overlaying the occipital bone and the trapezius muscle more inferior than the user's eyes) so that the posterior support portion 1350 is more inferior than the display screen 1220 and/or the display unit housing 1205.

In some forms, the posterior support portion 1350 may include a padded material, which may contact the user's head (e.g., overlaying the region between the occipital bone and the trapezius muscle). The padded material may provide additional comfort to the user, and limit marks caused by the posterior support portion 1350 pulling against the user's head.

### 5.3.2.3 Forehead Support

As shown in FIGS. 5A and 5B, some forms of the positioning and stabilizing structure 1300 may include a forehead support 1360 that can contact the user's head superior to the user's eyes, while in use. For example, the forehead support 1360 may overlay the frontal bone of the user's head. In certain forms, the forehead support 1360 may also be more superior than the sphenoid bones and/or the temporal bones. This may also position the forehead support 1360 more superior than the user's eyebrows.

In some forms, the forehead support 1360 may be an anterior portion of the positioning and stabilizing structure 1300, and may be disposed more anterior on the user's head than any other portion of the positioning and stabilizing structure 1300. The posterior support portion 1350 may provide a force directed at least partially in the posterior direction.

In some forms, the forehead support 1360 may include a cushioning material (e.g., textile, foam, silicone, etc.) that may contact the user, and may help to limit marks caused by the straps of the positioning and stabilizing structure 1300. The forehead support 1360 and the interfacing structure 1100 may work together in order to provide comfort to the user.

In some forms, the forehead support 1360 may be separate from the display unit housing 1205, and may contact the user's head at a different location (e.g., more superior) than the display unit housing 1205.

In some forms, the forehead support 1360 can be adjusted to allow the positioning and stabilizing structure 1300 to accommodate the shape and/or configuration of a user's face.

In some forms, the temporal connectors 1250 may be coupled to the forehead support 1360 (e.g., on lateral sides of the forehead support 1360). The temporal connectors 1250 may extend at least partially in the inferior direction in order to couple to the posterior support portion 1350.

In certain forms, the positioning and stabilizing structure 1300 may include multiple pairs of temporal connectors 1250. For example, one pair of temporal connectors 1250 may be coupled to the forehead support 1360, and one pair of temporal connectors 1250 may be coupled to the display unit housing 1205.

In some forms, the forehead support 1360 can be presented at an angle which is generally parallel to the user's forehead to provide improved comfort to the user. For example, the forehead support 1360 may position the user in an orientation that overlays the frontal bone, and is substantially parallel to the coronal plane. Positioning the forehead support substantially parallel to the coronal plane can reduce the likelihood of pressure sores which may result from an uneven presentation.

In some forms, the forehead support 1360 may be offset from a rear support that contacts a posterior region of the user's head (e.g., an area overlaying the occipital bone and the trapezius muscle). In other words, an axis along a rear strap would not intersect the forehead support 1360, which may be disposed more inferior and anterior than the axis along the rear strap. The resulting offset between the forehead support 1360 and the rear strap may create moments that oppose the weight force of the display screen 1220 and/or the display unit housing 1205. A larger offset may create a larger moment, and therefore more assistance in maintaining a proper position of the display screen 1220 and/or the display unit housing 1205. The offset may be increased by moving the forehead support 1360 closer to the user's eyes (e.g., more anterior and inferior along the user's head), and/or increasing the angle of the rear strap so that it is more vertical.

### 5.3.2.4 Adjustable Straps

Portions of the positioning and stabilizing structure 1300 may be adjustable, in order to impart a selective tensile force on the display screen 1220 and/or the display unit housing 1205 in order to secure a position of the display screen 1220 and/or the display unit housing 1205.

In some forms, the display unit housing 1205 may include at least one loop or eyelet 1254, and at least one of the temporal connectors 1250 may be threaded through that loop, and doubled back on itself. The length of a strap of the positioning and stabilizing structure 1300 threaded through the respective eyelet 1254 may be selected by the user in order to adjust the tensile force. For example, threading a greater length through the eyelet 1254 may supply a greater tensile force.

In some forms, at least one of the temporal connectors 1250 may include an adjustment portion 1256 and a receiving portion 1258. The adjustment portion 1256 may be positioned through the eyelet 1254 on the display unit housing 1205, and may be coupled to the receiving portion 1258 (e.g., by doubling back on itself). The adjustment portion 1256 may include a hook material, and the receiving portion 1258 may include a loop material (or vice versa), so that the adjustment portion 1256 may be removably held in the desired position. In some examples, the hook material and the loop material may be Velcro.

In certain forms, the strap may be constructed at least partially from a flexible and/or resilient material, which may conform to a shape of the user's head and/or may allow the adjustment portion to be threaded through the eyelet 1254. For example, the adjustment portion(s) 1256 may be constructed from an elastic textile, which may provide an elastic, tensile force. The remained of the temporal connectors 1250 may be constructed from the rigid or semi-rigid material described above (although it is contemplated that additional sections of the temporal connectors 1250 may also be constructed from a flexible material).

### 5.3.2.4.1 Top Strap Portion

In some forms, the positioning and stabilizing structure 1300 may include a top strap portion, which may overlay a superior region of the user's head.

In some forms, the top strap portion may extend between an anterior portion of the head-mounted display system 1000 and a posterior region of the head-mounted display system 1000.

In some forms, the top strap portion may be constructed from a flexible material, and may be configured to compliment the shape of the user's head.

In certain forms, the top strap portion may be connected to the display unit housing 1205. For example, the top strap portion may be coupled to the superior face 1230. The top strap portion may also be coupled to the display unit housing 1205 proximate to a posterior end of the display unit housing 1205.

In certain forms, the top strap portion may be coupled to the forehead support 1360. For example, the top strap portion may be coupled to the forehead support 1360 proximate to a superior edge. The top strap portion may be connected to the display unit housing 1205 through the forehead support 1360.

In some forms, the top strap portion may be connected to the posterior support portion 1350. For example, the top strap portion may be connected proximate to a superior edge of the posterior support portion 1350.

In some forms, the top strap portion may overlay the frontal bone and the pariental bone of the user's head.

In certain forms, the top strap portion may extend along the sagittal plane as it extends between the anterior and posterior portions of the head-mounted display system 1000.

In certain forms, the top strap portion may apply a tensile force oriented at least partially in the superior direction, which may oppose the force of gravity.

In some forms, the top strap portion may be adjustable in order to impart a selective tensile force on the display screen 1220 and/or the display unit housing 1205 in order to secure a position of the display screen 1220 and/or the display unit housing 1205.

In certain forms, the display unit housing 1205 and/or the forehead support 1360 may include at least one loop or eyelet 1254, and the top strap portion may be threaded through that eyelet 1254, and doubled back on itself. The length of the top strap portion threaded through the eyelet 1254 may be selected by the user in order to adjust the tensile force provided by the positioning and stabilizing structure 1300. For example, threading a greater length of the top strap portion through the eyelet 1254 may supply a greater tensile force.

In some forms, the top strap portion may include an adjustment portion and a receiving portion. The adjustment portion may be positioned through the eyelet 1254, and may be coupled to the receiving portion (e.g., by doubling back on itself). The adjustment portion may include a hook material, and the receiving portion may include a loop material (or vice versa), so that the adjustment portion may be removably held in the desired position. In some examples, the hook material and the loop material may be Velcro.

### 5.3.2.5 Rotational Control

In some forms, the display unit housing 1205 and/or the display screen 1220 may pivot relative to the user's face while the user has donned the positioning and stabilizing structure 1300. This may allow the user to see the physical environment without looking through the head-mounted display unit 1200 (e.g., without viewing computer generated images). This may be useful for users who want to take a break for viewing the virtual environment, but do not wish to doff the positioning and stabilizing structure 1300.

In certain forms, the pivot connection 1260 may be coupled to the temporal connectors 1250. The head-mounted display unit 1200 may be able to pivot about an axis extending between the temporal connectors 1250 (e.g., a substantially horizontal axis that may be substantially perpendicular to the Frankfort horizontal, in use).

In certain forms, the display screen 1220 and/or the display unit housing 1205 includes a pair of arms 1210, which extend away from the display screen 1220 (e.g., in a cantilevered configuration), and may extend in the posterior direction, in use.

In certain forms, the pair of arms 1210 may extend at least partially along the temporal connectors 1250, and may connect to the temporal connectors 1250 at the pivot connection 1260.

In some forms, the pivot connection 1260 may be a ratchet connection, and may maintain the display unit housing 1205 in a raised position without additional user intervention.

In some forms, the display screen 1220 and/or the display unit housing 1205 may include a neutral position (see e.g., FIG. 5B; substantially horizontal in use) and a pivoted position (e.g., pivoted relative to the horizontal axis, in use).

In certain forms, the display screen 1220 and/or the display unit housing 1205 may pivot between approximately 0° and approximately 90° relative to the temporal connectors 1250. In certain forms, the display screen 1220 and/or the display unit housing 1205 may pivot between approximately 0° and approximately 80° relative to the temporal connectors 1250. In certain forms, the display screen 1220 and/or the display unit housing 1205 may pivot between approximately 0° and approximately 70° relative to the temporal connectors 1250. In certain forms, the display screen 1220 and/or the display unit housing 1205 may pivot between approximately 0° and approximately 60° relative to the temporal connectors 1250. In certain forms, the display screen 1220 and/or the display unit housing 1205 may pivot between approximately 0° and approximately 50° relative to the temporal connectors 1250. In certain forms, the display screen 1220 and/or the display unit housing 1205 may pivot between approximately 0° and approximately 45° relative to the temporal connectors 1250. At least at its maximum pivotal position, the display screen 1220 may be more superior than the user's eyes, so that the user does not have to look through the display screen 1220 to view the physical environment.

### 5.3.3 Controller

As shown in FIG. 6, some forms of the head-mounted display system 1000 include a controller 1270 that can be engagable by the user in order to provide user input to the virtual environment and/or to control the operation of the head-mounted display system 1000. The controller 1270 can be connected to the head-mounted display unit 1200, and provide the user the ability to interact with virtual objects output to the user from the head-mounted display unit 1200.

### 5.3.3.1 Handheld Controller

In some forms, the controller 1270 may include a handheld device, and may be easily grasped by a user with a single hand.

In certain forms, the head-mounted display system 1000 may include two handheld controllers. The handheld controllers may be substantially identical to one another, and each handheld controller may be actuatable by a respective one of the user's hands.

In some forms, the user may interact with the handheld controller(s) in order to control and/or interact with virtual objects in the virtual environment.

In some forms, the handheld controller includes a button that may be actuatable by the user. For example, the user's fingers may be able to press the button while grasping the handheld controller.

In some forms, the handheld controller may include a directional control (e.g., a joystick, a control pad, etc.). The user's thumb may be able to engage the directional control while grasping the handheld controller.

In certain forms, the controller 1270 may be wirelessly connected to the head-mounted display unit 1200. For example, the connector 1270 and the head-mounted display unit 1200 may be connected via Bluetooth, Wi-Fi, or any similar means.

In certain forms, the controller 1270 and the head-mounted display unit 1200 may be connected with a wired connection.

### 5.3.3.2 Fixed Controller

In some forms, at least a portion of the controller 1270 may be integrally formed on the display unit housing 1205.

In some forms, the controller 1270 may include control buttons that are integrally formed on the display unit housing 1205. For example, the control buttons may be formed on the superior face 1230 and/or the inferior face 1232, so as to be engageable by the user's fingers when holding the user's palm rests against the lateral left or right face 1234, 1236 of the display unit housing 1205. Control buttons may also be disposed on other faces of the display unit housing 1205.

In some forms, the user may interact with the control buttons in order to control at least one operation of the head-mounted display system 1000. For example, the control button may be an On/Off button, which may selectively control whether the display screen 1220 is outputting an image to the user.

In certain forms, the control buttons and the head-mounted display unit 1200 may be connected with a wired connection.

In some forms, the head-mounted display system 1000 may include both the handheld controller and the control buttons.

In some forms, having only control button(s) may be preferable in an AR or MR device. While wearing the AR or MR head-mounted display system 1000, the user may be interacting with their physical environment (e.g., walking around, using tools, etc.). Thus, the user may prefer to keep their hands free of controllers 1270.

### 5.3.4 Speaker

As shown in FIG. 6, some forms of the head-mounted display system 1000 includes a sound system or speakers 1272 that may be connected to the head-mounted display unit 1200 and positionable proximate to the user's ears in order to provide the user with an auditory output.

In some forms, the speakers 1272 be positionable around the user's ears, and may block or limit the user from hearing ambient noise.

In certain forms, the speakers 1272 may be wirelessly connected to the head-mounted display unit 1200. For example, the speakers 1272 and the head-mounted display unit 1200 may be connected via Bluetooth, Wi-Fi, or any similar means.

In some forms, the speaker 1272 includes a left ear transducer and a right ear transducer. In some forms, the left and right ear transducers may output different signals, so that the volume and or noise heard by the user in one ear (e.g., the left ear) may be different than the volume and or noise heard by the user in the other ear (e.g., the right ear).

In some forms, the speaker 1272 (e.g., the volume of the speaker 1272) may be controlled using the controller 1270.

### 5.3.5 Power Source

As shown in FIG. 6, some forms of the head-mounted display system 1000 may include an electrical power source 1274 can provide electrical power to the head-mounted display unit 1200 and any other electrical components of the head-mounted display system 1000.

In certain forms, the power source 1274 may include a wired electrical connection that may be coupled to an external power source, which may be fixed to a particular location.

In certain forms, the power source 1274 may include a portable battery that may provide power to the head-mounted display unit 1200. The portable battery may allow the user greater mobility than compared to a wired electrical connection.

In certain forms, the head-mounted display system 1000 and/or other electronic components of the head-mounted display system 1000 may include internal batteries, and may be usable without the power source 1274.

In some forms, the head-mounted display system 1000 may include the power source 1274 in a position remote from the head-mounted display unit 1200. Electrical wires may extend from the distal location to the display unit housing 1205 in order to electrically connect the power source 1274 to the head-mounted display unit 1200.

In certain forms, the power source 1274 may be coupled to the positioning and stabilizing structure 1300. For example, the power source 1274 may be coupled to a strap of the positioning and stabilizing structure 1300, either permanently or removably. The power supply 1274 may be coupled to a posterior portion of the positioning and stabilizing structure 1300, so that it may be generally opposite the display unit housing 1205 and/or the head-mounted display unit 1200. The weight of the power source 1274, and the weight head-mounted display unit 1200 and the display unit housing 1205 may therefore be spread throughout the head-mounted display system 1000, instead of concentrated at the anterior portion of the head-mounted display system 1000. Shifting weight to the posterior portion of the display interface may limit the moment created at the user's face, which may improve comfort and allow the user to wear the head-mounted display system 1000 for longer periods of time.

In certain forms, the power source 1274 may be supported by a user distal to the user's head. For example, the power source 1274 may connected to the head-mounted display unit 1200 and/or the display unit housing 1205 only through an electrical connector (e.g., a wire). The power source 1274 may be stored in the user's pants pocket, on a belt clip, or a similar way which supports the weight of the power source 1274. This removes weight that the user's head is required to support, and may make wearing the head-mounted display system 1000 more comfortable for the user.

### 5.3.6 Control System

In some forms, the control system 1276 may be powered by the power source 1274 (e.g., at least one battery) used for powering components of the control system 1276. For example, sensors of the control system 1276 may be powered by the power source 1274.

In some forms, the at least one battery of the power source 1274 may be a low power system battery 1278 and a main battery 1280.

In certain forms, the low power system battery 1278 may be used to power a real time (RT) clock 1282 of the control system 1276.

### 5.3.6.1.1 Integrated Power Support Portion

In some forms, a battery support portion 1288 may support the low power system battery 1278 and/or the main battery 1280. The battery support portion 1288 may be directly supported on the head-mounted display system 1000.

In some forms, the battery support portion 1288 may be disposed within the display unit housing 1205.

In some forms, the battery support portion 1288 may be disposed on the positioning and stabilizing structure 1300. For example, the battery support portion 1288 may be coupled to the posterior support portion 1350. The weight of the head-mounted display system 1000 may be better balanced around the user's head.

### 5.3.6.1.2 Remote Power Support Portion

In some forms, a battery support portion 1288 may support the low power system battery 1278 and/or the main battery 1280. The battery support portion 1288 may be coupled to the user independently of the positioning and stabilizing structure 1300 and/or the display unit housing 1205 (e.g., it may be coupled via a belt clip). The battery support portion 1288 also may be supported remote from the user's body (e.g., if the head-mounted display system 1000 receives power from a computer or video game console). A tether may couple the battery support portion 1288 to the control system 1276 and/or other electronics. The positioning of the battery support portion may improve comfort for the user, since the weight of the low power system battery 1278 and/or the main battery 1280 are not supported by the user's head.

### 5.3.6.2 Orientation Sensor

In some forms, the control system 1276 includes an orientation sensor 1284 that can sense the orientation of the user's body. For example, the orientation sensor 1284 may sense when the user rotates their body as a whole, and/or their head individually. In other words, the orientation sensor 1284 may measure an angular position (or any similar parameter) of the user's body. By sensing the rotation, the sensor 1284 may communicate to the display screen 1220 to output a different image.

In some examples, an external orientation sensor may be positioned in the physical environment where the user is wearing the head-mounted display system 1000. The external position sensor may track the user's movements similar to the orientation sensor 1284 described above. Using an external orientation sensor may reduce the weight required to be supported by the user.

### 5.3.6.2.1 Camera

In some forms, the control system 1276 may include at least one camera, which may be positioned to view the physical environment of the user.

In some forms, the orientation sensor 1284 is a camera, which may be configured to observe the user's physical environment in order to measure and determine the orientation of the user's head (e.g., in what direction the user's head has tilted).

In some forms, the orientation sensor 1284 includes multiple cameras positioned throughout the head-mounted display system 1000 in order to provide a more complete view of the user's physical environment, and more accurately measure the orientation of the user's head.

### 5.3.6.3 Eye Sensor

In some forms, the control system 1276 may include an eye sensor that can track movement of the user's eyes. For example, the eye sensor may be able to measure a position of at least one of the user's eyes, and determine which direction at least one of the user's eyes are looking.

In some forms, the control system 1276 may include two eye sensors. Each sensor may correspond to one of the user's eyes.

In some forms, the eye sensors may be disposed in or proximate to the lenses 1240.

In some forms, the eye sensors may measure an angular position of the user's ears in order to determine the visual output from the display screen 1220.

In some forms, the user's eye may act as a controller, and the user may move their eyes in order to interact with virtual objects. For example, a virtual cursor may follow the position of the user's eyes. The eye sensor may track and measure the movement of the user's eyes, and communicate with a processing system 1286 (described below) in order to move the virtual cursor.

### 5.3.6.4 Processing System

In some forms, the control system 1276 includes a processing system 1286 (e.g., a microprocessor) that may receive the measurements from the various sensors of the control system 1276.

In some forms, the processing system 1286 may receive measurements recorded by the orientation sensor 1284 and/or the eye sensors. Based on these measured values, the processor can communicate with the display screen 1220 in order to change the image being output. For example, if the user's eyes and/or the user's head pivots in the superior direction, the display screen 1220 may display a more superior portion of the virtual environment (e.g., in response to direction from the processing system 1286).

### 5.4 Interfacing Structure

### 5.4.1 Interfacing Structure With Cushion

FIG. 10 shows an interfacing structure 1100 according to a further example of present technology. The interfacing structure 1100 is for a head-mounted display system 1000 comprising a head-mounted display unit 1200 comprising a display. The head-mounted display unit 1200 may comprise a display unit housing 1205 and the interfacing structure 1200 connected to the display unit housing 1205. The interfacing structure 1200 may be configured to connect to the display unit housing 1205, directly or via an intermediate component. The interfacing structure 1100 is constructed and arranged to be in opposing relation with the user's face in use. The head-mounted display system 1000 may otherwise have any of the features, configurations, aspects, functions and the like as described elsewhere herein. For example, the head-mounted display system 1000 may comprise a positioning and stabilising structure 1300 structured and arranged to hold the head-mounted display unit 1200 in an operable position on the user's head in use, for example as described herein.

The interfacing structure 1100 may be configured to engage the user's face around at least a portion of a periphery of the user's eye region in use. The interfacing structure 1200 may be provided around some, most, or all, of the periphery of the user's eye region in use. The interfacing structure 1100 may be configured to engage the sides of the user's face lateral of the user's eyes and engage the user's forehead in use. The interfacing structure 1100 may engage the user's cheeks, the sides of the user's face lateral of the user's eyes and the user's forehead. The interfacing structure 1100 may engage the user's face at regions overlying the user's nose, maxilla, zygomatic bones, sphenoid bones and frontal bones. The interfacing structure 1100 may engage the user's face in region shown in FIG. 4D, for example.

With reference to FIG. 10, the interfacing structure 1100 may comprise a face engaging flange 1118 structured and arranged to be provided around a periphery of an eye region of the user's face and configured to engage the user's face in use. The face engaging flange 1118 may be flexible and resilient. The face engaging flange 1118 is, in this example, formed from an elastomeric material, for example silicone or TPE.

As will be described in more detail below, in some examples the interfacing structure 1100 comprises a cushion 1130. FIGS. 11A-11E show a cushion 1130 of the interfacing structure 1100 shown in FIG. 10. The cushion 1130 may be at least partially covered by the face engaging flange 1118. In some examples of the present technology, the cushion 1130 is formed by a lattice structure. In some examples, the interfacing structure 1100 comprises a cushion 1130 but no face engaging flange 1118 such that the cushion may directly engage the user's face.

The interfacing structure 1100 may be configured to engage the user's face and resist compression when the head-mounted display unit 1200 is fastened securely to the user's face, while remaining comfortable to the user. The cushion 1130 in particular may contribute to the resilience of the interfacing structure 1100.

FIGS. 12A-12D show further views of the interfacing structure 1100 shown in FIG. 10.

Interfacing structures 1100 described herein may be particularly suited to use in a head-mounted display system 1000 configured for VR. However, it is to be understood that the interfacing structures 1100 described herein, or individual features thereof, may be applied in a head-mounted display system 1000 configured for use in any of VR, MR, AR or other artificial reality.

### 5.4.1.1 Face Engaging Flange and Portions of the Interfacing Structure

Referring to FIG. 12C and FIG. 12D, the face engaging flange 1118 may comprise a cross-sectional shape comprising a first end 1121 and a second end 1122. The first end 1121 may be connected to the display unit housing 1205 in use (e.g. connected to the display unit housing 1205 when the interfacing structure 1100 is attached to the display unit housing 1205). The face engaging flange 1118 further comprises a face engaging region 1123 at which the face engaging flange 1118 contacts the user's face in use. The face engaging region 1123 may be located between the first end 1121 and the second end 1122 of the face engaging flange 1118. Face engaging flange 1118 may curl between the first end 1121 and the second end 1122 to form an at least partially enclosed cross-section.

The face engaging flange 1118 may be formed from an elastomeric material, such as silicone or a TPE, for example. In the example shown in FIG. 10 12A-12D, the face engaging flange 1118 is formed from silicone by injection moulding.

The face engaging flange 1118 may be shaped to curl towards the user's face between the first end 1121 and the face engaging region 1123 and may be shaped to curl away from the user's face between the face engaging region 1123 and the second end 1122. As shown in each of FIGS. 12C and 12D, between the face engaging region 1123 and the second end 1122, the face engaging flange 1118 curls over a portion of the cushion 1130 so as to at least partially enclose the cushion.

With reference to FIG. 10, the interfacing structure 1100 may comprise a pair of cheek portions 1140 configured to engage the user's cheeks in use. The interfacing structure 1100 may also comprise a forehead portion 1175 configured to engage the user's forehead in use, and a pair of sphenoid portions 1170 located on respective lateral sides of the interfacing structure 1100 connecting between forehead portion 1175 and the cheek portions 1140. The sphenoid portions 1170 may be configured to engage the user's head proximate the sphenoid bone.

In some examples of the present technology, the face engaging flange 1118 may form at least one closed loop portion 1150 having an enclosed cross-section (e.g., that completely surrounds the cushion 1130). With reference to FIG. 10, the face engaging flange 1118 may form a pair of closed loop portions 1150, each closed loop portion 1150 located in or medially adjacent to a respective cheek portion 1140 of the interfacing structure 1100. The face engaging flange 1118 may additionally or alternatively form a pair of open-loop portions 1160 each having a partially open cross-section. Each open-loop portion 1160 may be located in or laterally adjacent to a respective one of the cheek portions 1140 as shown by way of example only in FIG. 10. As illustrated in FIG. 12D, in each of the cheek portions 1140 the face engaging flange 1118 may extend inferiorly from the first end 1121 of the face engaging flange 1118 and then posteriorly, superiorly, and anteriorly. As illustrated in FIG. 12C, in the forehead portion 1175 the face engaging flange 1118 may extend superiorly from the first end 1121 of the face engaging flange 1118 and then posteriorly, inferiorly, and anteriorly.

With reference to FIGS. 10 and 12B, in some examples the interfacing structure 1100 comprises a nasal portion 1180 between the cheek portions 1140. The nasal portion 1180 may be configured to engage the user's nose in use and may be configured to at least partially block light from reaching the user's eyes from the user's nose region (e.g. block light travelling via a path proximate the surfaces of the user's nose). The nasal portion 1180 may for example be configured to engage anterior, superior and/or lateral surfaces of the user's nose in use. The nasal portion 1180 may be attached to the cheek portions 1140. With reference to FIG. 12B, the nasal portion 1180 may comprise a pronasale portion 1182 configured to be positioned proximate the user's pronasale in use. The nasal portion 1180 may further comprise a first bridge portion 1186 and a second bridge portion 1186 extending at least partially posteriorly from the pronasale portion 1182 to engage the user's nose. The first bridge portion 1186 may be configured to bridge between one of the cheek portions 1140 and a first lateral side of the user's nose. The second bridge portion 1186 may be configured to bridge between the other of the cheek portions 1140 and a second lateral side of the user's nose.

### 5.4.1.2 Cushion

As stated above, in some examples of the present technology, the interfacing structure 1100 comprises a cushion 1130. In some examples the cushion 1130 may be formed by a lattice structure or at least partially from a lattice structure. The cushion 1130 may be structured to allow resilient compression of the interfacing structure 1100, enabling the interfacing structure to comfortably conform to the user's face in use to create a light seal around the display of the head-mounted display system 1000.

The cushion 1130 (e.g. the lattice structure thereof may provide an internal structure around which the face engaging flange 1118 is provided and may be configured to prevent buckling or other distortion of the face engaging flange 1118 that could cause, discomfort, facial marking and/or light leak. The cushion 1130 (e.g. the lattice structure thereof) may be resiliently compressible to keep the head-mounted display unit 1200 stable, especially during vigorous head movement in use.

The cushion 1130 may be partially covered by the face engaging flange 1118, as shown in FIGS. 10 and 12A-12D. The extent to which the face engaging flange 1118 wraps around or encloses the cushion 1130 may vary between examples of the present technology. For example, FIG. 14A shows an interfacing structure 1100 in which the face engaging flange 1118 leaves a portion of the cushion 1130 uncovered, while FIG. 14B shows a different interfacing structure 1100 in which the face engaging flange 1118 almost completely encloses the cushion 1130. In other examples, the cushion 1130 is not covered by a face engaging flange 1118 and the cushion 1130 is configured to directly contact the user's face.

In examples, the cushion 1130 may comprise a length lying in use along at least a portion of a periphery of the user's eye region. The cushion 1130 may have a length lying along some, most, or all, of the periphery of the user's eye region or of the length of the interfacing structure 1100. As described above, the interfacing structure 1100 may comprise cheek portions 1140, sphenoid portions 1170 and a forehead portion 1175. One or more cushions 1130 may be provided within one or more of these portions. In some examples a cushion 1130 is provided in all of the cheek portions 1140, sphenoid portions 1170 and forehead portion 1175. In some examples, the cushion 1130 is provided within the cheek portions 1140. In some examples, the cushion 1130 is provided within the sphenoid portions 1170. In some examples, the cushion 1130 is provided within the forehead portion 1175. In some examples, the cushion is provided within each of the cheek portions 1140, forehead portion 1170 and sphenoid portions 1170. It is to be understood that in some examples the cushion may be formed in two or more parts, while in other examples the cushion may be formed of unitary construction as a single part.

With reference to FIGS. 10 and 11A in particular, in some examples of the present technology the interfacing structure 1100 comprises medial portions 1145 located between the nasal portion 1180 and the respective cheek portions 1140. The face engaging flange 1118 may join to the nasal portion 1180 at the medial portions 1145. As shown in FIG. 10, the face engaging flange 1118 may curve from the cheek portions 1140 anteriorly to form medial portions 1145. In this example the face engaging flange 1118 connects to the nasal portion 1180 along each lateral side of the nasal portion 1180. In this particular example the face engaging flange 1118 forms closed loop portions 1150 at the medial portions 1145 of the interfacing structure 1100. As shown in FIG. 11A, the cushion 1130 may comprise corresponding medial portions 1145 shaped and sized to fit within an at least partially enclosed cross section of the face engaging flange 1118 at the medial portions 1145. The cushion 1130 may comprise medial ends configured to be positioned within the face engaging flange 1118 at the medial portions 1145 of the interfacing structure 1100. The medial ends of the cushion 1130 may curve from a medial direction to an anterior direction, corresponding to the curvature of the face engaging flange 1118. The medial ends of the cushion 1130 may fit within closed loop portions 1150 formed by the face engaging flange 1118.

In some examples, a pair of cushions 1130 are provided within the cheek portions 1140 only. FIG. 17 shows a pair of cushions 1130a and 1130b each configured to be located within a respective one of the cheek portions 1140. Any feature or property of a cushion 1130 described herein, such as lattice structure, material, behaviour or the like is to be understood to also be applicable to a pair of separate cushions 1130a and 1130b provided to cheek portions 1140 of the interfacing structure 1100.

FIGS. 11A-11E show the cushion 1130, which comprises a cushion body 1131 formed by a lattice structure. In some examples, only a portion of the cushion 1130 is formed by a lattice structure. In other examples, the entire cushion 1130 is formed by a lattice structure. In the example shown in FIGS. 11A-11E, the cushion 1130 comprises a main cushion body 1131 formed by a lattice structure and a plurality of cushion clips 1135 which are not formed by a lattice structure. The cushion body 1131 and cushion clips 1135 may be considered to form a “cushion” 1130 or “cushion insert” or the like.

### 5.4.1.2.1 Cushion Attachment

As shown in FIGS. 12A-12D for example, the interfacing structure 1100 may comprise an interfacing structure clip 1101 configured to attach the interfacing structure 1100 to the display unit housing 1205. The interfacing structure clip 1101 may form a snap fit connection or press fit connection with the display unit housing 1205, e.g. with a corresponding portion of the display unit housing 1205, or may be configured to connect to the display unit housing 1205 in another suitable manner. The interfacing structure 1100 may be removable from the head-mounted display unit 1200 for cleaning or replacement, for example. The interfacing structure clip 1101 may be formed from a thermoplastic material, such as nylon, ABS, polycarbonate, polypropylene or the like.

In some examples, the cushion 1130 is removably attached to the interfacing structure clip 1101, for example for cleaning or replacement. In other examples, the cushion 1130 is permanently attached to the interfacing structure clip 1101.

As shown in FIGS. 11A-11E, in one form of the present technology, the cushion 1130 may comprise one or more cushion clips 1135. One or more of the cushion clips 1135 may be configured to connect to the interfacing structure clip 1101 to attach the cushion 1130 to the interfacing structure clip 1101. For example, as shown in FIG. 12C, in the forehead region 1175 the cushion 1130 comprises a cushion clip 1135 that is configured to attach to the interfacing structure clip 1101.

Where one or more cushion clips 1135 are attached to an interfacing structure clip 1101, they may be removably attachable to the interfacing structure clip 1101. In other examples one or more cushion clips 1135 may be permanently attached to the interfacing structure clip 1101.

In some examples of the present technology, such as the example shown in FIGS. 12A-12D, the face engaging flange 1118 may extend from the interfacing structure clip 1101. For example, as shown in FIG. 12C, in the forehead region 1175 the first end 1121 of the face engaging flange 1118 is connected directly to the interfacing structure clip 1101 and the face engaging flange 1118 extends from the interfacing structure clip 1101.

In some examples of the present technology, such as the example shown in FIGS. 12A-12D, the interfacing structure 1100 may comprise a chassis portion 1102. The face engaging flange 1118 may be attached to the chassis portion 1102 and may extend from the chassis portion 1102. For example, as shown in FIG. 12D, in the cheek region 1140 the first end 1121 of the face engaging flange 1118 is connected directly to the chassis portion 1102 and the face engaging flange 1118 extends from the chassis portion 1102.

The chassis portion 1102 may be stiffer than the face engaging flange 1118. For example, the chassis portion 1102 may comprise a greater material thickness than the face engaging flange 1118. The chassis portion 1102 and the face engaging flange 1118 in the example shown in FIGS. 12A-12D are integrally formed. In other examples the chassis portion 1102 may be formed from a different, e.g. stiffer, material to the face engaging flange 1118. For example, the face engaging flange 1118 may be overmoulded to the chassis portion 1102.

The chassis portion 1102 may be attached to the interfacing structure clip 1101. In some examples, the chassis portion 1102 is removably attached to the interfacing structure clip 1101. In other examples the chassis portion 1102 may be permanently attached (e.g. glued or overmoulded) to the interfacing structure clip 1101.

In some examples of the present technology, one or more of the cushion clips 1135 may be configured to connect to a chassis portion 1102 of the interfacing structure 1100. As shown in FIG. 12D, in the cheek regions 1140 the cushion clips 1135 connect to the chassis portion 1102 of the interfacing structure 1100. The cushion clips 1135 in this example are removably attachable to the chassis portion 1102, and may form a snap fit connection to the chassis portion 1102.

FIG. 12E shows an alternative example of the present technology in which the chassis portion 1102 of the interfacing structure 1100 is overmoulded to the interfacing structure clip 1101 and the cushion clip 1135 is removably attached by a press fit connection to the interfacing structure clip 1101. In other examples of the present technology, the cushion clip 1135 may be inserted into the interfacing structure clip 1101 in the manner shown in FIG. 12E during manufacturing but permanently attached to the interfacing structure clip 1101, e.g. by gluing or welding. In other examples both the cushion clip 1135 and the chassis portion 1102 may be removably attached by press fit connections to the interfacing structure clip 1101 in an arrangement as depicted in FIG. 12E.

It is to be understood that in some examples of the present technology, the chassis portion 1102 may comprise two portions that are not connected to each other. For example, in the example shown in FIGS. 12A-12D, the chassis portion 1102 comprises two portions, each located in a respective one of the cheek portions 1140 of the interfacing structure 1100. In other examples the interfacing structure 1100 may comprise a single chassis portion 1102 extending along the length of the interfacing structure 1100 from one cheek portion 1140 to the other cheek portion 1140. In further examples of the present technology, the interfacing structure 1100 may not comprise a chassis portion 1102 and the connection between the face engaging flange 1118 and the interfacing structure clip 1101 may be a direct connection as shown in FIG. 12C.

In some examples, the forehead portion 1175 may comprise a chassis portion 1102 to which the face engaging flange 1118 is connected and the cushion 1130 may comprise a cushion clip 1135 that connects to the chassis portion 1102 in the forehead portion 1175.

In the example shown in FIGS. 11A-11F, the cushion 1130 comprises three cushion clips 1135. One cushion clip 1135 may be provided in the forehead portion 1175 and a cushion clip 1135 may be provided to each of the cheek portions 1140. Similar to the interfacing structure 1100 which has a pair of cheek portions 1140, a pair of sphenoid portions 1170 and a forehead portion 1175, the cushion 1130 of the interfacing structure 1100 may also be considered to have cheek portions 1140, sphenoid portions 1170 and a forehead portion 1175. In other examples of the present technology, there may be a different number of cushion clips 1130 and they may be provided in different locations to those shown in FIGS. 11A-11F, such as in the sphenoid portions 1170.

More generally, it is to be understood that where a feature, component or the like is described with reference to a particular portion around an interfacing structure 1100, e.g. a cheek portion 1140, a sphenoid portion 1170, or a forehead portion 1175, that feature, component or the like may alternatively or additionally be provided to other portions around the interfacing structure 1100, unless the context clearly requires otherwise.

The cushion clips 1135 may be integrally formed with the main body of the cushion 1130. In examples in which the cushion 1130 is formed by a lattice structure, the cushion clips 1135 may not necessarily be formed by the lattice structure and may instead be formed from a “solid” uniform material. In other examples the cushion clips 1135 may be formed separately from the lattice structure and attached to the lattice structure, e.g. by gluing or welding, or may be over moulded to the lattice structure.

Either or both of the interfacing structure clip 1101 or chassis portion 1102 of an interfacing structure 1100 may be structured and/or arranged to support the shape of the interfacing structure 1100 as a whole. For example, the interfacing structure clip 1101 and/or chassis portion 1102 may comprise a stiffness (due to shape and/or material) sufficient to hold themselves and other components such as the cushion 1130 and face engaging flange 1118 in a predetermined shape.

### 5.4.1.2.2 Lattice Structure

As stated above, the cushion 1130 may be formed by a lattice structure.

In the example shown in FIGS. 11A-11F, the cushion 1130 comprises a cushion body 1131 formed by a lattice structure. That is, the material forming the cushion 1130 is structured and arranged to form a lattice. The lattice structure may comprise a plurality of unit cells. Where features or properties of a cushion 1130 are described, it is to be understood that those features or properties may be features or properties of a cushion body 1131 and not features or properties of other portions of a cushion 1130, such as cushion clips 1135. For example, a cushion 1130 may be described as being formed by a lattice structure if the cushion body 1131 has a lattice structure, despite the cushion 1130 having cushion clips 1135 that are not formed by a lattice structure.

In some examples, as shown in FIG. 10-1, the lattice structure may be formed by a plurality of interconnected struts 1166 that form a plurality of voids 1168. The structure of the struts 1166 may repeat in two or three dimensions to form a plurality of unit cells that make up the lattice. In examples, each void may be considered as the empty space defined by each unit cell. Such lattice structure may be advantageous in providing a relatively lightweight, flexible and breathable structure. In examples, the cushion 1130 may comprises 20 or more voids.

In use, as shown in FIG. 10-2, the lattice structure may provide flexibility to conform to facial features and/or accommodate anthropometric variation. When the interfacing structure is in engagement with the user's face, the struts 1166 may flex thereby altering the size, shape and/or orientation of the voids to allow the cushion 1130 to conform to the user's face. Additionally, as described later in this disclosure, characteristics of the lattice structure may vary in different portions of the lattice to adjust the stiffness or flexibility of the cushion for different areas of the user's face. For example, stiffness and flexibility may be adjusted by changing or varying the material of the struts, thickness of the struts, density of the struts, orientation of the struts, spacing of the struts, size of the voids, orientation of the voids, density of the voids, arrangement of unit cells, and/or density of unit cells.

The lattice structure is distinguishable from foam materials where the cell/pore structure is formed on a microscopic level typically with an inflating agent. The lattice structure has a repeating macroscopic cellular structure built up by the material forming the struts.

In some examples of the present technology, the lattice structure may be 3D printed. In other examples, the lattice structure may be formed by another additive manufacturing technique or another manufacturing technique able to produce a lattice structure, or the lattice structure may be formed by injection moulding.

In some examples, the lattice structure is formed from TPU. In other examples, the lattice structure is formed from silicone or from TPE. In examples, the lattice structure is formed from a material having a Durometer hardness within the range of 20 Shore A to 80 Shore A. In other examples, depending on geometry, the hardness may be within the range of 15-100 Shore A. Other ranges envisaged are 15-50, 30-80, 30-60, 20-50, and 20-40 Shore A, for example. In one form the hardness is 30 Shore A.

Various possible lattice structures are envisioned. In some examples, the lattice structure comprises a two-dimensional structure (e.g. honeycomb). In further examples, the lattice structure comprises a three-dimensional structure. In examples, the lattice structure may comprise a fluorite structure (shown in FIG. 15A), a truncated cube structure (shown in FIG. 15B), a IsoTruss structure (shown in FIG. 15C), a hexagonal honeycomb structure (shown in FIG. 15D), a gyroid structure (shown in FIG. 15E) or a Schwarz structure (shown in FIG. 15F). In some examples the cushion 1130 may be formed from another lattice structure. In some examples the cushion 1130 may be formed from a plurality of lattice structures.

In some examples of the present technology, the cushion is formed flat and bent into a three-dimensional shape during assembly with the face engaging flange 1118. FIG. 13 shows schematically a cushion 1130 formed in a flat shape (on the left side) but then deformed into a three-dimensional shape (on the right side). For example, in some forms the cushion 1130 may be 3D printed in a flat configuration. The cushion 1130 may be flexible and able to assume a three-dimensional shape corresponding to a curvature along the length of the face engaging flange 1118. In some examples, the cushion 1130 may be 3D printed in a three-dimensional curved shape. A cushion 3D printed in a three-dimensional curved shape may be customised, as will be described.

In some other examples, the lattice structure may be knitted. In further examples, the lattice structure may be formed from foam having holes formed therein to form a lattice structure. The holes may be formed by laser cutting, for example.

A cushion 1130 formed by a lattice structure may advantageously be able to be designed and produced with fine control over certain properties, at least in comparison to a uniform mass of foam in some examples. In examples of the present technology, the lattice structure forming the cushion 1130 can be designed and produced with greater softness or compliance in specific regions of contact on the face where compliance is desirable (e.g. sphenoid regions of the user's face) than other regions. The properties of a cushion 1130 formed from a uniform mass of foam for example may be more dependent on the overall cross sectional shape and overall stiffness, making it more difficult to achieve fine control of properties in particular locations, whereas properties of a lattice structure may be varied at specific locations within the cushion 1130, in examples of the present technology. In some examples, the lattice structure may be configured to optimise contact pressure based on tissue spring rate and expected dynamic movements. In some examples, the cushion 1130 may apply pressure for a static engagement and light seal whilst the face engaging flange 1118 provides for dynamic contact and light seal.

Some users may dislike the idea of a foam cushion in their head-mounted display system 1000, due to perceived issues with cleanability. In examples of the present technology, a cushion 1130 formed from a lattice structure may be at least as comfortable as a foam cushion but may be more appealing to those users that dislike foam. In some examples the lattice structure is open cell and formed from a machine washable material. In some examples the entire interfacing structure 1100 may be formed from machine washable or sterilisable materials (e.g. face engaging flange 1118 formed from silicone, lattice structure formed from TPU or silicone, interfacing structure clip 1101 formed from a thermoplastic material such as ABS, nylon or the like) meaning the interfacing structure 1100 can be disconnected from the head-mounted display unit 1200 and washed in a washing machine or sterilised.

A cushion 1130 formed from a lattice structure and provided with integral features for attachment within the interfacing structure 1100 (e.g. integral cushion clips 1135) may enable the cushion 1130 to be particularly easy to be inserted within a face engaging flange 1118 of the interfacing structure 1100 manually or robotically during manufacturing or manually by the end user.

In some examples, the cushion 1130 may be structured and arranged to be better able to dissipate heat from the face than a cushion 1130 formed from solid material, such as silicone or foam. Heat may be generated during use, for example by the user as the result of user activity, and/or by the electronic components of the head-mounted display unit 1200. This heat may build up and cause discomfort to the user. In some examples the cushion 1130 may be configured to allow air transfer into, within and out of the cushion body 1131. The lattice structure may allow airflow within the cushion body 1131, allowing for heat to travel through and out of the lattice structure by airflow. Enabling airflow through the interior of the cushion 1130 may assist with avoiding excess heat build-up, may also help to avoid excessive humidity build-up and/or at least help heat to flow away from the contact surface at which the interfacing structure 1100 contacts the user's face.

### 5.4.1.2.3 Varying Properties

In some examples of the present technology, the cushion 1130 comprises one or more characteristics that vary between locations corresponding to the cheek portions 1140, forehead portion 1175 and sphenoid portions 1170 interfacing structure 1100. The lattice structure for example may comprise one or more characteristics that vary between locations corresponding to two or more of the cheek portions 1140, forehead portion 1175 and sphenoid portions 1170. The one or more characteristics of the cushion 1130 or lattice structure may include stiffness of the cushion 1130 or lattice structure and/or characteristics of the lattice structure of the cushion 1130.

The one or more characteristics of the lattice structure of the cushion 1130 that may vary between locations around the interfacing structure 1100 may include any one or more of the shape, thickness, density, spacing, relative orientation and/or material of unit cells forming the lattice structure. In other examples, the lattice structure may vary in other characteristics.

It is to be understood that the way that a lattice structure may be configured to provide for a stiffer region in one location in comparison to another location will depend on the particular lattice structure. In some examples the lattice structure may comprise a beam lattice structure, e.g. a lattice structure formed by a network of members behaving as struts. In one such example the cushion 1130 may comprise a first region and a second region, the first region being stiffer due to increased thickness and/or density of struts. In another example a cushion 1130 may comprise a lattice structure formed from bendable beams. In a first region there may be a large number of readily bendable beams while in a second region there may be a small number of relatively non-bendable beams, such that the first region is more compliant or less stiff than the second region. It is to be understood that multiple parameters may be available for modification throughout a lattice structure to provide different behaviour in different regions of the cushion 1130. In some examples, more voids may be provided in a region of a lattice structure having a lesser stiffness than in a region having a higher stiffness.

In general, where a cushion 1130 is described herein as being more compliant or less stiff in one region in comparison to another, or stiffer in one region in comparison to another, the particular parameters/characteristics of the lattice structure from which that cushion 1130 is constructed may be varied as required to provide the desired differences in behaviour between the regions.

In some examples, the lattice structure may be provided with characteristics resulting in more complex behaviour than only being stiff or flexible. For example, in some forms of the technology the lattice structure may be formed from struts, but some or all of the struts may be curved (C-shaped or otherwise). In other examples some or all of the struts may be straight and may be configured to buckle in use. For example, the struts may function to resist load directed along their length, until a point at which the struts may buckle. At the time of buckling the stiffness of struts may be reduced and the struts may allow for further compression without excessive stiffness. Such an arrangement may provide for a long “travel” (e.g. high adaptability) without unduly large force required between the user's face and the cushion 1130.

In some examples, the lattice structure may be constructed to define voids which close (or move towards a more closed position) during compression of the cushion 1130. Upon closure of substantially all voids in a region, the cushion 1130 may stiffen significantly as it may be no more capacity for compression. In some examples the number, size, shape of the voids available may be selected to cause such stiffening in certain regions where a large amount of support may be required.

In some examples, the cushion 1130 may be stiffer in the forehead portion 1175 and/or in the cheek portions 1140 in comparison to the sphenoid portions 1170. The lattice structure may be different in the forehead portion 1175 and/or the cheek portions 1140 than in the sphenoid portions 1170 to provide the greater stiffness. For example, the thickness of the material forming the unit cells may be greater in the forehead portion 1175 and/or the cheek portions 1140 than in the sphenoid portions 1170, to make the cushion 1130 stiffer in the forehead portion 1175 and/or the cheek portions 1140.

In some examples, the cushion 1130 may be able to deform to accommodate anthropometric variation to a greater extent in the sphenoid portions 1170 than in the forehead portion 1175 and/or the cheek portions 1140. The lattice structure may be highly deformable/adaptable in the sphenoid portions 1170, for example more so than in the forehead portion 1175 and/or the cheek portions 1140. In some examples, the lattice structure may have a lower stiffness in the sphenoid portions 1170 than in the forehead portion 1175 and/or the cheek portions 1140.

Advantageously, the cushion 1130 may be stiffer in the forehead portion 1175 and the cheek portions 1140 in order to resist the posteriorly-directed forces exerted on the head-mounted display unit 1200 by the positioning and stabilising structure 1300 (e.g. headgear strap tension). The laterally facing surfaces of the user's head at the sphenoid portions 1170 may be less suited to countering the posteriorly-directed forces that are transmitted to the interfacing structure 1100 from headgear straps. Accordingly, the cushion 1130 may advantageously be configured to be highly compliant at the sphenoid portions 1170 to accommodate a large range of head/face widths without the need to resist high compression forces exerted on the cushion 1130.

In some examples of the present technology, the lattice structure may comprise one or more characteristics that vary between a user-facing side of the cushion 1130 corresponding to a side of the interfacing structure 1100 configured to contact the user's face in use and a non-user facing side of the cushion 1130 corresponding to a side of the interfacing structure 1100 configured to face away from the user's face in use.

In some forms, the lattice structure on the user-facing side of the cushion 1130 is configured to avoid leaving red marks on the user's face. In some forms, the lattice structure on the non-user facing side of the cushion 1130 is configured to adapt readily to the shape of the user's face (e.g. by flexing to conform to the shape of the user's face). As shown in FIG. 16A, the lattice structure forming the cushion body 1131 may comprise smaller voids 1168 on the user-facing side of the cushion 1130 than on the non-user facing side. Advantageously, the small voids may present a low risk of face marking on the user-facing side while the large voids on the non-user facing side may allow the lattice of the interfacing structure 1100 to readily adapt to different face shapes and sizes (e.g., by having increased flexibility due to relatively larger voids). Facial marking may be considered unsightly and/or embarrassing by the user. Furthermore, an interfacing structure 1100 which significantly marks the face during use may be uncomfortable, especially if worn for long periods. In some examples, the lattice structure may comprise smaller unit cells on the user-facing side than on the non-user facing side.

FIG. 16B shows another example schematically in which a cushion 1130 comprises a cushion body 1131 formed by a lattice structure defining voids. In this example the voids 1168 are smaller on a user-facing side than on a non-user facing side. The lattice structure comprises progressively smaller voids in the direction from the non-user facing side to the user facing side. The density of the cushion 1130 in this example progressively increases towards the user-facing side, eventually forming a uniform surface 1133 on the user-facing side to provide for a smooth and comfortable interface.

In some examples of the present technology, variation in one or more characteristics of the lattice structure causes the cushion 1130 to be more compliant or less stiff on the user-facing side of the cushion 1130 than on the non-user facing side. Such an arrangement may advantageously allow the user-facing side to readily conform to the surface of the user's face while on the non-user facing side the cushion is able to resist compressive forces.

In some examples of the present technology, the material forming the unit cells of the lattice structure is thinner on the user-facing side of the cushion 1130 than on the non-user facing side of the cushion 1130. FIGS. 16C and 16D are schematic views of two such exemplary cushions 1130. The material forming the unit cells on the user-facing side may have a thickness within the range of 0.3-0.5 mm. In other examples the thickness may be outside of this range, such as within the range of 0.2-0.3 mm or 0.5-0.7 mm. The material forming the unit cells on the non-user facing side may have a thickness within the range of 0.8mm-1.2 mm, such as a thickness of 1 mm, for example. In other examples the thickness may be different for example within the range of 0.7mm-1.4 mm or within the range of 0.9mm-1.1 mm.

In some examples, such as in the cushion 1130 shown in FIG. 16C, the user-facing side of the cushion 1130 (e.g. the cushion body 1131 thereof) is defined by unit cells of the lattice structure. The unit cells may be exposed to contact the face engaging flange 1118. The cushion 1130 in this example, or at least the user-facing side, may advantageously be readily compliant. In this example the cushion 1130 may comprise a uniform surface 1132 defining the non-user facing side of the cushion 1130.

In other examples, such as in the cushion 1130 shown in FIG. 16D, the cushion 1130 comprises a uniform surface 1133 on the user-facing side of the cushion 1130. The uniform surface may cover unit cells of the lattice structure. This may advantageously provide for a low risk of facial marking during use.

In some examples, the uniform surfaces 1132 and/or 1133 on the user-facing side and/or non-user facing side, as the case may be, may be integrally formed with unit cells of the lattice structure. For example, the uniform surfaces 1132 and/or 1133 may be 3D printed together with and connected to the lattice structure. The uniform surfaces 1132 and/or 1133 may be 1 mm thick, or in other examples may be within the range of 0.5-1.5 mm, 0.8-1.2 mm or 0.9-1.1 mm thick.

In other examples the uniform surfaces 1132 and/or 1133, as the case may be, may be formed separately and attached to the lattice structure.

As discussed above, in some examples the lattice structure may be formed from foam having a plurality of holes formed therein (e.g. holes in the macroscopic structure of the cushion 1130 distinct from the microscopic cells/pores of the foam material). The holes may be formed by laser cutting, for example or the cushion 1130 may be formed, e.g. moulded, with holes. The size, shape and/or spacing of the holes may be varied within the cushion 1130 in order to vary one or more properties (e.g. stiffness, compliance).

FIG. 18 shows schematically a foam cushion 1130 having a cushion body 1131 having a plurality of holes 1136 formed in the cushion body 1131. Forming the holes 1136 removes material from the cushion body 1131 to effectively form it into a lattice structure (although in some examples the cushion body 1131 may be formed, e.g. moulded, with the holes already present meaning no material removal may be required). The holes 1136 in this example are smaller on a first side (left side in FIG. 18) than on a second side (right side in FIG. 18) of the cushion 1130, to provide the first side of the cushion 1130 with a different stiffness than the second side 1130. Alternatively or additionally, the holes 1136 may vary in size, shape and/or spacing along the length of the cushion 1130. In the example shown in FIG. 18 the holes are circular but in other examples the holes may have a shape other than a circle.

### 5.4.1.2.3.1 Variation Proximate Sensitive Facial Feature

In some examples of the present technology, the cushion 1130 may comprise a lattice structure which comprises one or more characteristics that vary at least at and/or proximate a location corresponding to a sensitive facial feature on the user's face. A variation in characteristics may, for example, be a variation in any one or more of the shape, thickness, density, spacing, relative orientation and/or material of unit cells forming the lattice structure.

FIG. 19A shows schematically a cushion 1130 in contact with a user's face in the region of a sensitive facial feature and on either side of the sensitive facial feature. The sensitive facial feature may be a protruding/raised facial feature, such as a nose bridge or cheek bone, for example. The cushion is receiving a uniformly distributed load on the non-user facing side of the cushion 1130, which for example may be a load transmitted to the cushion 1130 from tension in headgear straps transmitted through components of the head-mounted display unit 1200 and interfacing structure 1100. FIG. 19B shows a plot of the force or contact pressure on the user's face in the region shown in FIG. 19A.

Two curves are plotted in FIG. 19B. The solid line curve represents force or pressure applied to the user's face by a cushion with a uniform lattice structure (which may be identified as an “unoptimised” cushion 1130). As shown in FIG. 19B, there is an increase in the force/pressure applied to the face by the unoptimised cushion 1130 at and proximate the sensitive facial feature, due to the extra compression of the lattice structure caused by the protruding/raised facial feature. The broken line represents force or pressure applied to the user's face by a cushion 1130 having one or more characteristics that vary at or proximate the sensitive facial feature. This cushion 1130 may be considered an “optimised” cushion 1130. The term “optimised” is to be understood to mean “more optimal” in the context of some outcome, such as comfort, stability etc. As shown in FIG. 19B, there is no increase in force/pressure on the user's face at the sensitive facial feature, due to the varying characteristics of the lattice structure. In one example, the lattice structure may be configured to have a lesser stiffness in the region configured to contact the sensitive facial feature than the in the regions on either side of the sensitive facial feature. The lesser stiffness in this illustrated example then results in the force between the sensitive facial feature and the cushion 1130 being no more than the force between the other regions and the cushion 1130.

More generally, the variation in the one or more characteristics of the lattice structure may cause the cushion 1130 to apply less pressure on the sensitive facial feature in use than would be applied without the variation. In FIG. 19B, this is shown by the optimised cushion 1130 applying a lesser force on the face at the sensitive facial feature than the unoptimised cushion 1130. The optimised cushion 1130 applies a more uniform load over the surface of the user's face, as some of the load that would otherwise be applied to the sensitive facial feature is instead applied to the user's face on either side of the sensitive facial feature (where the face is less sensitive). As a result, less load is applied to the sensitive facial feature, in comparison to the unoptimised cushion 1130, despite the cushion 1130 as a whole bearing the same load. This may advantageously adequately support the head-mounted display unit 1200 on the user's face without creating a sore point at the sensitive facial feature.

In further examples, the variation of the one or more characteristics may cause the cushion 1130 to apply less pressure on the sensitive facial feature in use than the cushion 1130 applies to the user's face around the sensitive facial feature. The variation of the one or more characteristics of the lattice structure may result in lesser stiffness or greater compliance in the cushion 1130 at and/or proximate the location corresponding to the sensitive facial feature. FIG. 20A shows schematically a cushion 1130 in contact with a user's face in the region of a sensitive facial feature and on either side of the sensitive facial feature. The cushion 1130 is receiving a uniformly distributed load on the non-user facing side of the cushion 1130. FIG. 20B shows a plot of the force or contact pressure on the user's face in the region shown in FIG. 20A.

The solid line curve in FIG. 20B is substantially the same as the solid line curve in FIG. 19B and represents the force/pressure across the user's face applied by an unoptimised cushion 1130, showing an increase in force at the sensitive facial feature. The broken line curve in FIG. 20B represents the force/pressure across the user's face applied by an optimised cushion 1130 according to another example of the present technology. In this example, despite the presence of a raised sensitive facial feature, the variation in the lattice structure causes the force applied to the user's face at the sensitive facial feature to be less than that applied on either side of the sensitive facial feature. Advantageously, this may provide for a particularly comfortable interfacing structure 1100 as almost all the load is applied to the less sensitive regions around the sensitive facial feature. While in this example and in the example of an optimised cushion 1130 described with reference to FIG. 19B, the optimised cushion 1130 applies a greater load on either side of the sensitive facial feature than the non-optimised cushions 1130, i.e. the optimisation of the lattice structure increases the force on either side of the sensitive facial feature, this may be desirable as these regions may be able to more comfortably support loads than the region of the sensitive facial feature.

FIG. 19C shows an example of a cushion 1130 having a lattice structure with a characteristic that varies along the length of the cushion 1130. In this example the cushion 1130 comprise uniform surfaces 1132 and 1133 on the non-user facing and user-facing sides of the cushion 1130, respectively. The cushion 1130 further comprises a recess 1134 configured to engage a sensitive facial feature such as a nose bridge, cheek bone or the like. The grid-like pattern depicting the cushion body 1131 represents the lattice structure schematically. In this example the orientation of cells forming the lattice structure vary proximate the recess 1134 to provide for a different behaviour at and proximate the recess 1134. For example, the variation in the orientation of the lattice structure at and proximate the recess 1134 may result in a lesser stiffness at the recess 1134, which may in turn provide for comfortable engagement between the cushion 1130 and the sensitive facial feature.

FIG. 22C shows another example of a cushion 1130 comprising a lattice structure with a variation in a characteristic of the lattice structure configured to provide for user comfort. As illustrated schematically, the cushion 1130 comprises a stiffened region 1139 within the cushion 1130 being stiffer than one or more adjacent regions within the cushion (e.g. the left and right side regions of the cushion 1130, as well as a region between the stiffened region 1139 and the recess 1134). In this example the stiffened region 1139 is positioned to span from a first region of the cushion 1130 located on a first side of the sensitive facial feature (e.g. the left side in FIG. 22C) through a second region of the cushion 1130 overlying the sensitive facial feature and into a third region of the cushion 1130 on a second side of the sensitive facial feature (e.g. the right side in FIG. 22C). The stiffened region 1139 may be stiffened by a variation in one or more characteristics of the lattice structure at the stiffened region 1139. As illustrated in FIG. 22C the lattice structure is denser in the stiffened region 1139 than a surrounding compliant region 1138. The increased density may be formed by, for example, more material, smaller voids, additional struts and/or smaller and more numerous unit cells, for example. The actual parameter(s) which may be varied to increase stiffness will depend on the particular lattice structure used in various examples.

FIG. 22D shows yet another example of a cushion 1130 comprising a lattice structure with a variation in a characteristic of the lattice structure resulting in less stiffness in the cushion 1130 at and around a location corresponding to a sensitive facial feature than other regions. In this example, the cushion 1130 comprises a stiffened region 1139 and a compliant region 1138 (i.e., the compliant region having greater flexibility/less stiffness as compared to the stiffened region), each formed by variation in characteristics of the lattice structure, such as variation in one or more of shape, thickness, density, spacing, relative orientation and/or material of unit cells forming the lattice structure. Also in this example the stiffened region 1139 spans from a first region (e.g. on the left in FIG. 22D) of the cushion 1130 on a first side of the sensitive facial feature through a second region of the cushion 1130 overlying the sensitive facial feature and into a third region (e.g. on the right in FIG. 22D) of the cushion 1130 on a second side of the sensitive facial feature. In this example the cushion 1130 is stiffer proximate the user's face in the first region and in the third region than in the second region. That is, the stiffened region 1139 is provided all the way up to the side of the cushion 1130 which engages the user's face in use in the regions on either side of the sensitive facial feature. Additionally, the cushion 1130 comprises a compliant region 1138 surrounding the sensitive facial feature, configured to provide a region of lesser stiffness at the sensitive facial feature for comfort, while the stiffened region 1139 is stiffer to transfer a majority of the overall force on the cushion 1130 to the less sensitive regions of the user's face on either side of the sensitive facial feature.

FIGS. 22G-22J show, schematically, four different ways a lattice structure formed from a network of struts around voids may be configured, in order to provide different stiffness and adaptability. Each shows a cushion 1130 comprising a cushion body 1131 comprising a lattice structure.

In FIG. 22G the lattice structure is formed from relatively thick struts 1166 spaced relatively far apart from each other (high relative spacing) thereby forming relatively large voids 1168. This structure may provide for a cushion 1130 having a medium stiffness and high adaptation distance.

In FIG. 22H the lattice structure is formed from relatively thin struts 1166 spaced relatively far apart from each other (high relative spacing) thereby forming relatively large voids 1168. This structure may provide for a cushion 1130 having a low stiffness and high adaptation distance.

In FIG. 22I the lattice structure is formed from relatively thick struts 1166 spaced relatively close to each other (low relative spacing) thereby forming relatively small voids 1168. This structure may provide for a cushion 1130 having a high stiffness and lower adaptation distance.

In FIG. 22J the lattice structure is formed from relatively thin struts 1166 spaced relatively close to each other (low relative spacing) thereby forming relatively small voids 1168. This structure may provide for a cushion 1130 having a medium stiffness and medium adaptation distance. As shown in FIG. 22J, a user-facing side of the cushion 1130 may comprise a uniform surface 1133 that may be thicker than the struts to provide for a comfortable surface in use. In some examples the uniform surface 1133 may be between 1.5-3 times as thick as the thinnest portion some or all of the struts, such as between 1.7 and 2.5 times as thick, such as twice as thick.

As described elsewhere herein, a cushion 1130 may comprise a lattice structure with one or more characteristics that vary to provide for differing properties in different locations within the cushion 1130. FIGS. 22C and 22D, described above in more detail, comprise stiffened regions 1139 and compliant regions 1138 formed by variations in characteristics of the lattice structures, such as strut thickness.

FIG. 22E shows a further example of a cushion 1130 comprising a cushion body 1131 comprising a lattice structure. The cushion is shown schematically against a user's face. The user's face has a protrusion, which represents a sensitive facial feature such as a nose bridge or other sensitive feature. In this example, the cushion 1130 comprises a stiffened region 1139 on each lateral side of the sensitive facial feature, connected to each other proximate a non-user facing side of the cushion 1130. The stiffened regions 1139 may be formed, for example, by the structure shown in FIG. 22I, as this structure provides a high stiffness. Proximate the sensitive facial feature, the cushion 1130 comprises a compliant region 1138, which may be less stiff than the stiffened regions 1139. The compliant region 1138 may be formed from the structure shown in FIG. 22H, as this structure provides a low stiffness and high adaptation/compliance distance. Along the user-facing side of the cushion 1130, the cushion body 1131 may be formed by the lattice structure shown in FIG. 22J, which has a medium stiffness and medium adaptation distance. The smaller voids and thinner struts may provide for a comfortable feel against the user's face. The cushion 1130 may comprise a uniform layer of material along the user-facing side to provide for a smooth surface.

FIG. 22F shows a further example of a cushion 1130 similar to that shown in FIG. 22E. In this example, the compliant region 1138 formed by the structure shown in FIG. 22H extends all of the way to the surface of the user-facing side of the cushion 1130 at the sensitive facial feature. The structure (being that of FIG. 22J) that is provided along the user-facing side of the cushion 1130 shown in FIG. 22E is, in FIG. 22F, not provided directly over the sensitive facial feature and is instead provided on either lateral side of the sensitive facial feature. The compliant region 1138 formed by the structure shown in FIG. 22H extending substantially all the way to the surface of the cushion 1130 may allow the user-facing side of the cushion 1130 to be highly stretchable in directions parallel to the surface (indicated by the arrows in FIG. 22F) at the sensitive facial feature. The structure with smaller voids (shown in FIG. 22J) provided along the user-facing surface of the cushion 1130 may allow less stretch in the surface.

While certain variations in a lattice structure forming a cushion 1130 are described above (and elsewhere) in the context of reducing load on a sensitive facial feature, it is to be understood that the variations may be applied in any cushion 1130 which has one or more regions stiffer than one or more other regions, even where there is not one specific facial feature considered to be a sensitive facial feature.

FIG. 21A shows schematically another example of a cushion 1130 comprising a lattice structure in contact with a user's face in the vicinity of a raised/protruding sensitive facial feature such as a nose bridge or cheek bone. In this example the load on the non-user facing side of the cushion 1130 is a non-uniform distributed load. As illustrated, the distributed load is greater on the left side than on the right side. There is also a recess 1134 in the cushion 1130, which will be described in more detail below.

FIG. 21B shows a plot of force/pressure across the user's face in the vicinity of the sensitive facial feature. The solid-line curve shows the force on the face exerted by an unoptimised cushion 1130 receiving the non-uniform distributed load shown in FIG. 21A. As shown in FIG. 21B, the force transmitted to the face is large on the left side of the sensitive facial feature and smaller on the right side thereof, corresponding to the non-uniform distributed load applied to the cushion 1130. However, the broken-line curve in FIG. 21B shows the force transmitted to the face by an optimised cushion 1130. As illustrated, the force applied to the face on either side of the sensitive facial feature is substantially the same due to variation in the lattice structure forming the cushion 1130, despite the non-uniform distributed load applied to the non-user facing side of the cushion 1130.

Evident in the examples described with reference to FIGS. 19A-22D, is that in some examples in which the lattice structure comprises one or more characteristics that vary along a length of the cushion 1130. In some examples the cushion 1130 may receive a distributed load applied to a non-user facing side of the cushion 1130, and yet due to the variation in the lattice structure, the cushion 1130 may apply a different distributed load to the user's face along the length of the cushion 1130. In some particular examples, the cushion 1130 may receive a non-uniform distributed load along said length of the cushion 1130 applied to a non-user facing side of the cushion 1130, and yet due to the variation in the one or more characteristics the cushion 1130 applies a uniform load to the user's face along said length of the cushion. Advantageously, the cushion 1130 may be optimised to receive a non-uniform distributed load but apply a smoothed, more even (e.g. closer to uniform) load to the user's face which has a maximum force less than a maximum force of the distributed load on the user's face. This may make the head-mounted display system 1000 particularly comfortable to wear.

### 5.4.1.2.3.2 Other Features to Reduce Load on Sensitive Facial Features

FIG. 21A schematically shows a cushion 1130 being brought into contact with a user's face at and on either side of a sensitive facial feature, which may be a nose bridge, cheek bone or other raised or sensitive feature. The cushion 1130 in this example comprises a recess 1134 configured to be aligned in use with the sensitive facial feature. The recess 1134 may be shaped to receive the sensitive facial feature, as shown in FIG. 21A.

In some examples the recess 1134 is shaped to provide a clearance between the cushion 1130 and the sensitive facial feature at least in an undeformed state, as shown in FIG. 21A. That is, in an undeformed state the recess may be larger than the sensitive facial feature such that the cushion 1130 does not contact the sensitive facial feature. However, in use when the cushion 1130 is pulled into contact with the user's face the cushion 1130 may compress and conform to the user's face such that there is no longer clearance at the recess 1134. However, the presence of the recess 1134 and its clearance in an undeformed state may result in a particularly low force being applied on the sensitive facial feature in use, since there may be minimal compression of the cushion in the region of the recess 1134, or at least less compression than if there was no recess 1134.

In other examples the recess 1134 may not be so large that there is a clearance around the sensitive facial feature even in an undeformed state. The recess 1134 may substantially match a shape of the sensitive facial feature, for example, or may even be smaller than the sensitive facial feature. However, the presence of even a small recess 1134 may go some way to reducing the force applied to sensitive facial feature, as the recess 1134 may act as a relief, reducing some amount of compression required of the cushion 1130 at the sensitive facial feature. Advantageously the recess 1134 may provide for a particularly comfortable interfacing structure 1100.

FIG. 21B shows two force/pressure curves across the user's face in the vicinity of the sensitive facial feature. The solid-line curve shows the force applied to the user's face by an unoptimised cushion 1130 without a recess 1134 and the broken-line curve shows the force applied to the user's face by an optimised cushion 1130 also having a recess 1134 as shown in FIG. 21A. As shown in FIG. 21B the force transmitted to the sensitive facial feature by the cushion 1130 with the recess 1134 is less than the force transmitted to the sensitive facial feature by the cushion 1130 without the recess 1134. Furthermore, at least partially due to the recess 1134 the force applied to the sensitive facial feature by the cushion 1130 with the recess 1134 is less than the force applied to the user's face on either side of the sensitive facial feature.

In some examples of the present technology, the cushion 1130 may comprise one or more force redistribution features configured to in use redirect forces received on a non-user facing side of the cushion 1130 in a region of the cushion 1130 aligned with a sensitive facial feature into one or more regions of the cushion 1130 alongside or spaced from the sensitive facial feature. A force redistribution feature may be a variation in a characteristic of a lattice structure or may be an additional or alternative feature to a lattice structure property.

FIG. 22A schematically shows a cushion 1130 according to a further example of the present technology in contact with a user's face in the vicinity of a sensitive facial feature and receiving a distributed load on a non-user facing side thereof. FIG. 22B shows a plot of the force or pressure applied to the user's face by the cushion 1130 in use. The cushion 1130 shown in FIG. 22A comprises a force redistribution feature in the form a beam structure 1137 within the cushion 1130 (e.g. internal of the cushion body 1131 of the cushion 1130). The beam structure 1137 is positioned to in use span from a first region A of the cushion 1130 located on a first side of the sensitive facial feature through a second region B of the cushion 1130 overlying the sensitive facial feature and into a third region C of the cushion 1130 on a second side of the sensitive facial feature.

The beam structure 1137 is configured to redirect forces received at region B, which is aligned with the sensitive facial feature, into regions A and C, which are alongside and spaced from the sensitive facial feature. As shown in FIG. 22B the force transmitted to the user's face in region B, at the location of the sensitive facial feature, is lower than the force transmitted to the user's face in regions A and C, due to the beam structure 1137 redirecting forces to the regions A and C where they are able to be better tolerated by the user. In this example the cushion 1130 also comprises a recess 1134 like the example shown in FIGS. 21A and 21B, which also has an effect on reducing the force applied to the sensitive facial feature. However, as shown in FIG. 22B the reduction in force throughout region B may be more substantial and may affect a wider region (e.g. substantially all of region B) than the reduction in force resulting from the presence of the recess 1134 alone.

In some examples the cushion 1130 comprises a void adjacent the beam structure 1137 on a user-facing side of the beam structure 1137 in region B but not in regions A and C, which may result the beam structure 1137 transferring force received at region B into the cushion 1130 at regions A and C. Additionally or alternatively, the cushion 1130 may have a lesser stiffness in region B (e.g. due to variations in the lattice structure), which may also enable force to be more readily transferred to regions A and C of the cushion 1130 instead of at region B.

FIG. 22C, already discussed above in the context of a lattice structure having regions of differing stiffnesses, shows another example of a cushion 1130 with a force redistribution feature. In this example the force redistribution feature comprises the stiffened region 1139 within the cushion 1130, being stiffer than one or more adjacent regions within the cushion 1130. In this example the stiffened region 1139 is stiffened by a variation in one or more characteristics of the lattice structure at the stiffened region 1139. As illustrated schematically, the stiffened region 1139 is positioned to span from a first region of the cushion 1130 located on a first side of the sensitive facial feature (e.g. the left side in FIG. 22C) through a second region of the cushion 1130 overlying the sensitive facial feature and into a third region of the cushion 1130 on a second side of the sensitive facial feature (e.g. the right side in FIG. 22C). As illustrated in FIG. 22C the lattice structure is denser in the stiffened region 1139 than a surrounding compliant region 1138. The increased density may be formed by, for example, more material, smaller voids, additional struts and/or smaller and more numerous unit cells, for example. The actual parameter(s) which may be varied to increase stiffness will depend on the particular lattice structure used in various examples. The stiffened region 1139 in this example provides a similar effect to the beam structure 1137 described above and may function like a beam to protect the sensitive facial feature. The stiffened region 1139 may form a force redistribution feature to transmit loads on cushion 1130 at least partially away from the sensitive facial feature and into the adjacent regions which engage less sensitive areas. The stiffened region 1139 may be formed from a finer or denser lattice structure and the surrounding compliant region(s) 1138 may be formed from a coarser, less dense lattice structure to provide less stiffness and reduce weight. The surface layers of the cushion 1130 in this example may be formed from the same material as the lattice structure or may be a different material, such as textile, foam, silicone, faux leather etc.

FIG. 22D already discussed above in the context of a lattice structure having regions of differing stiffnesses, shows another example of a cushion 1130 with a force redistribution feature. In this example, the cushion 1130 comprises a stiffened region 1139 and a compliant region 1138, each formed by variation in characteristics of the lattice structure, such as variation in one or more of shape, thickness, density, spacing, relative orientation and/or material of unit cells forming the lattice structure. The stiffened region 1139 in this example forms a force redistribution feature. Also in this example, the stiffened region 1139 spans from a first region (e.g. on the left in FIG. 22D) of the cushion 1130 on a first side of the sensitive facial feature through a second region of the cushion 1130 overlying the sensitive facial feature and into a third region (e.g. on the right in FIG. 22D) of the cushion 1130 on a second side of the sensitive facial feature. In this example the cushion 1130 is stiffer proximate the user's face in the first region and in the third region than in the second region. That is, the stiffened region 1139 is provided all the way up to the side of the cushion 1130 which engages the user's face in use in the regions on either side of the sensitive facial feature. Additionally, the cushion 1130 comprises a compliant region 1138 surrounding the sensitive facial feature, configured to provide a region of lesser stiffness at the sensitive facial feature for comfort. In this example, the stiffened region 1139 is stiffer to form a force redistribution feature that transfers a majority of the overall force on the cushion 1130 to the less sensitive regions of the user's face on either side of the sensitive facial feature. The portion of the stiffened region 1139 that spans between the two side regions may act as a bridge connecting the portions of the stiffened region 1139 on the sides. The central, bridge or beam-like portion may transfer load to either side of the sensitive facial feature while the side portions may form the main load paths to transfer force to the less sensitive regions on either side of the sensitive facial feature. In some examples the bridge-like central portion of the stiffened region 1139 may be even stiffer than the side portions of the stiffened region 1139. It is to be understood that in some examples there are three or more regions of differing stiffnesses within the cushion 1130.

### 5.4.1.2.4 Personalisation

In some examples, the lattice structure is 3D printed in a shape corresponding to a unique user's face. For example, facial data, which may represent a three-dimensional shape of some or all of a user's face, or one or more characteristics of a user's face, may be obtained using known methods or methods described herein. The lattice structure may then be 3D printed in a shape corresponding to the user's face based on the facial data.

In some examples, the lattice structure may be formed with thicknesses (e.g. overall thickness of the cushion body 1131) based on the intended user's facial data. For example, the relative thicknesses of the cushion 1130 in the forehead portion 1175, sphenoid portions 1170 and cheek portions 1140 may be determined based on the facial data.

Advantageously, 3D printing of a lattice structure may be particularly suited to personalisation based on unique facial data, as it may be cost effective to produce a cushion having a customised shape, at least in comparison to other techniques such as injection moulding.

In some examples, the lattice structure of the cushion 1130 is constructed to optimise contact pressure for a unique individual. The lattice structure may be constructed based on facial data corresponding to the unique individual such that the cushion 1130 provides less contact pressure in one or more regions than it would without use of the facial data. The lattice structure may be tuned to optimise contact pressure in use for a particular user.

In some examples, the cushion 1130 comprises one or more personalised characteristics and is formed in a three-dimensional curved shape based on facial data. In other examples the cushion 1130 comprises one or more personalised characteristics based on facial data and is formed in a flat shape. It is to be understood that in some examples the cushion 1130 may not be personalised and may be formed in either a three-dimensional curved shape or a flat shape.

The resulting comfort and/or performance of a cushion 1130 formed (e.g. 3D printed) to a three-dimensional personalised shape may be better than cushion 1130 produced flat and without personalisation, although a cushion 1130 produced flat may be considered useful for some applications as it may be able to be provided at a lower cost.

In some examples, the cushion 1130 may be formed in a flat configuration but may have one or more features or characteristics that are personalised such as the overall thickness of the cushion 1130 or one or more properties of the lattice structure, such as thickness, spacing, density, shape, size, orientation etc. of the unit cells forming the lattice structure. A cushion 1130 formed in a three-dimensional curved shape may additionally or alternatively be personalised in the three-dimensional curved profile of the cushion 1130 (e.g. the space curve along the length of the cushion 1130).

Either or both of the overall (e.g. macroscopic) shape of the cushion 1130 and characteristics of the lattice structure forming the cushion 1130 may be personalised based on facial data. FIGS. 19A-22D show examples of “optimised” cushions 1130 having features configured to avoid excessive forces being applied to a sensitive facial feature. In some examples of the present technology, facial data of a unique user's face may include details identifying shape and/or location of a sensitive facial feature (e.g. nose bridge, cheek bone or other sensitive area). The facial data may then be used to personalise a cushion 1130 such that it behaves in the manner described with reference to any of FIGS. 19A-22D. For example, the facial data may be used to form a lattice structure with varying characteristics in the construction of the unit cells such that the lattice structure has a lower stiffness in a correct region, corresponding to the vicinity of the sensitive facial feature, than in other regions. Alternatively, or additionally, the facial data may be used to form a recess in the correct location and/or having a correct/sufficient size to correspond to the sensitive facial feature of the particular user from which the facial data has been acquired.

### 5.5 Automatic Sizing

Interfacing structures 1100 (which may also be known as “facial interfaces”, “interfaces”, “user interfaces” and the like) according to examples of the present technology (e.g. the examples shown in FIGS. 10-22D or in any other example disclosed herein), may be provided in a range of sizes so that users can select a most optimal size from the range of sizes when purchasing or using a head-mounted display system. Described below are systems and methods to assist users in determining the correct or most optimal size interfacing structure 1100. It is to be understood that in some examples the systems and methods may be applied to selection of sub-components of an interfacing structure 1100, such as a cushion 1130 (e.g. formed from a lattice structure) or other components of a head-mounted display system, such as a positioning and stabilising structure. References to sizing of an interface are to be understood to alternatively be references to sizing of a cushion 1130 formed from a lattice structure for the interface.

In a beneficial embodiment, the present technology may employ an application downloadable from a manufacturer or third party server to a smartphone or tablet with an integrated camera. When launched, the application may provide visual and/or audio instructions. When prompted or otherwise, the user may activate a process using an image sensor (such as a camera function) to scan or capture one or more images of the user's face, and a facial interface size may be recommended based on an analysis of the captured image or video by a processor of the phone or a cloud. In an alternative embodiment, instead of capturing images of a subject in real-time, the user may be prompted to select and/or upload a pre-exiting image of the user's face for image processing and analysis for sizing. In one example, the image is a 2D image of the user's face. In another example, the image is a 3D image (i.e. contains depth information on selected portion) of the face. This may allow for a correct or optimal size of the facial interface identified quickly and conveniently for a user which improves user fit and comfort.

As described further below, the present technology allows a user to capture an image or series of images of their facial structure. Instructions provided by an application stored on a computer-readable medium, such as when executed by a processor, detect various facial landmarks within the images, measure and scale the distance between such landmarks, compare these distances to a data record, and recommend an appropriate facial interface size. Thus, an automated device of a consumer may permit accurate facial interface selection, such as in the home, to permit customers to determine sizing without trained associates or fitting.

### 5.5.1 System

FIG. 7 depicts an example system 200 that may be implemented for automatic facial feature measuring and facial interface sizing. System 200 may generally include one or more of servers 210, a communication network 220, and a computing device 230. Server 210 and computing device 230 may communicate via communication network 220, which may be a wired network 222, wireless network 224, or wired network with a wireless link 226. In some versions, server 210 may communicate one-way with computing device 230 by providing information to computing device 230, or vice versa. In other embodiments, server 210 and computing device 230 may share information and/or processing tasks. The system may be implemented, for example, to permit automated purchase of facial interfaces where the process may include automatic sizing processes described in more detail herein. For example, a customer may order a facial interface online after running a facial interface selection process that automatically identifies a suitable facial interface size by image analysis of the customer's facial features.

### 5.5.1.1 Computing Device

Computing device 230 can be a desktop or laptop computer 232 or a mobile device, such as a smartphone 234 or tablet 236. FIG. 8 depicts the general architecture 300 of computing device 230. Device 230 may include one or more processors 310. Device 230 may also include a display interface 320, user control/input interface 331, sensor 340 and/or a sensor interface for one or more sensor(s), inertial measurement unit (IMU) 342 and non-volatile memory/data storage 350.

Sensor 340 may be one or more cameras (e.g., a CCD charge-coupled device or active pixel sensors) that are integrated into computing device 230, such as those provided in a smartphone or in a laptop. Alternatively, where computing device 230 is a desktop computer, device 230 may include a sensor interface for coupling with an external camera, such as the webcam 233 depicted in FIG. 7. Other exemplary sensors that could be used to assist in the methods described herein that may either be integral with or external to the computing device include stereoscopic cameras, for capturing three-dimensional images, or a light detector capable of detecting reflected light from a laser or strobing/structured light source. In one embodiment, the sensor 340 comprises an Apple iPhone's 3D TrueDepth Camera or similar sensors employed in other mobile devices capable of 3D facial scanning.

User control/input interface 331 allows the user to provide commands or respond to prompts or instructions provided to the user. This could be a touch panel, keyboard, mouse, microphone, and/or speaker, for example.

Display interface 320 may include a monitor, LCD panel, or the like to display prompts, output information (such as facial measurements or interface size recommendations), and other information, such as a capture display, as described in further detail below.

Memory/data storage 350 may be the computing device's internal memory, such as RAM, flash memory or ROM. In some embodiments, memory/data storage 350 may also be external memory linked to computing device 230, such as an SD card, server, USB flash drive or optical disc, for example. In other embodiments, memory/data storage 350 can be a combination of external and internal memory. Memory/data storage 350 includes stored data 354 and processor control instructions 352 that instruct processor 310 to perform certain tasks. Stored data 354 can include data received by sensor 340, such as a captured image, and other data that is provided as a component part of an application. Processor control instructions 352 can also be provided as a component part of an application.

### 5.5.1.2 Application for Facial Feature Measuring and Facial Interface Sizing

One such application is an application for facial feature measuring and/or facial interface sizing 360, which may be an application downloadable to a mobile device, such as smartphone 234 and/or tablet 236. The application 360, which may be stored on a computer-readable medium, such as memory/data storage 350, includes programmed instructions for processor 310 to perform certain tasks related to facial feature measuring and/or facial interface sizing. The application also includes data that may be processed by the algorithm of the automated methodology. Such data may include a data record, reference feature, and correction factors, as explained in additional detail below.

### 5.5.2 Method for Automatic Measuring and Sizing

As illustrated in the flow diagrams of FIGS. 9A-9D, one aspect of the present technology is a method for controlling a processor, such as processor 310, to measure user's facial features using two-dimensional or three-dimensional images and to recommend or select an appropriate facial interface size, such as from a group of standard sizes, based on the resultant measurements. The method may generally be characterized as including three or four different phases: a pre-capture phase 400, a capture phase 500, a post-capture image processing phase 600, and a comparison and output phase 700.

In some cases, the application for facial feature measuring and facial interface sizing may control a processor 310 to output a visual display that includes a reference feature on the display interface 320. The user may position the feature adjacent to their facial features, such as by movement of the camera. The processor may then capture and store one or more images of the facial features in association with the reference feature when certain conditions, such as alignment conditions are satisfied. This may be done with the assistance of a mirror 330. The mirror 330 reflects the displayed reference feature and the user's face to the camera. The application then controls the processor 310 to identify certain facial features within the images and measure distances therebetween. By image analysis processing a scaling factor may then be used to convert the facial feature measurements, which may be pixel counts, to standard facial interface measurement values based on the reference feature. Such values may be, for example, standardized unit of measure, such as a meter or an inch, and values expressed in such units suitable for interface sizing. Additional correction factors may be applied to the measurements. The facial feature measurements may be compared to data records that include measurement ranges corresponding to different interface sizes for particular interface forms. The recommended size may then be chosen and be output to the user/based on the comparison(s) as a recommendation. Such a process may be conveniently effected within the comfort of the user's own home, if the user so chooses. The application may perform this method within seconds. In one example, the application performs this method in real time. A manufacturer or supplier may arrange for the facial interface of the recommended size to be shipped to a user nominated address automatically.

### 5.6 Methods and Systems For Producing a Customised Head-Mounted Display System

Described below are systems and methods according to additional examples of the present technology, for production of a lattice structure of a head-mounted display system or component thereof. The systems and methods below may be used together with the automatic sizing and personalisation examples above, or as alternatives. References to a head-mounted display system that is customised, tailored, personalised, optimised etc. are to be understood to refer to a head-mounted display system that has at least one component that is customised (e.g. a cushion 1130 customised by way of a customised lattice structure), even if some or all of the other components of the head-mounted display system are not customised.

### 5.6.1 System Architecture

Examples of the system(s) outlined herein may include one or more computing devices with one or more processor(s) programmed or configured to perform the various functions described herein. While examples may describe certain information being stored and/or processing tasks being performed by a particular device, it will be appreciated that alternative embodiments are contemplated in which such information and/or processing tasks are shared.

FIG. 23 shows a schematic view of an exemplary system 100 that may be used to perform various aspects of the present technology as described herein. It will be appreciated that system 100 may receive data from, and send data to, external systems, and may control the operation of components outside of the system 100. The system 100 may generally include a customisation server 102 that manages the collection and processing of data relating to the design and production of a customised component for a head-mounted display system 1000. The customisation server 102 has processing facilities represented by one or more processors 104, memory 106, and other components typically present in such computing devices. It should be appreciated that the server 102, processors 104, and memory 106 may take any suitable form known in the art, for example a “cloud-based” distributed server architecture or a dedicated server architecture. In the exemplary embodiment illustrated the memory 106 stores information accessible by processor 104, the information including instructions 108 that may be executed by the processor 104 and data 110 that may be retrieved, manipulated or stored by the processor 104. The memory 106 may be of any suitable means known in the art, capable of storing information in a manner accessible by the processor 104, including a computer-readable medium, or other medium that stores data that may be read with the aid of an electronic device.

The processor 104 may be any suitable device known to a person skilled in the art. Although the processor 104 and memory 106 are illustrated as being within a single unit, it should be appreciated that this is not intended to be limiting, and that the functionality of each as herein described may be performed by multiple processors and memories, that may or may not be remote from each other and other components of the system 100. The instructions 108 may include any set of instructions suitable for execution by the processor 104. For example, the instructions 108 may be stored as computer code on the computer-readable medium. The instructions may be stored in any suitable computer language or format. Data 110 may be retrieved, stored or modified by processor 104 in accordance with the instructions 110. The data 110 may also be formatted in any suitable computer readable format. The data 110 may also include a record 112 of control routines or algorithms for implementing aspects of the system 100.

Although the server 102 in FIG. 23 is shown only to include memory 106, the server 102 may further be capable of accessing other external memories, data stores, or databases (not shown). For example, information processed at the server 102 may be sent to an external data store (or database) to be stored, or may be accessed by the server 102 from the external data store (or database) for further processing. Additionally, the system 100 may include multiple such data stores and/or databases. In some cases, the data stores or databases may be separately accessible, such as each being accessible to a different server. In other cases, the data stores or databases described herein may not necessarily be separate, but may be stored together but as part of separate files, folders, columns of a table in a common file, etc.

The server 102 may communicate with an operator workstation 114 to provide an operator with access to various functions and information. Such communication may be performed via network 120. The network 120 may comprise various configurations and protocols including the Internet, intranets, virtual private networks, wide area networks, local networks, private networks using communication protocols proprietary to one or more companies, whether wired or wireless, or a combination thereof.

The server 102 performing one or more operations may include using artificial intelligence and/or machine learning algorithms. The server 102 may be configured to generate training datasets and/or employ trained datasets (by the server 102 or external to the server 102) to make certain decisions.

The exemplary system 100 includes one or more user devices 130 equipped to obtain data relating to shape and/or size of a user′ s face, head or features thereof, as will be described further below. By way of example, the user devices 130 may include a mobile computing device such as smart phone 130A or tablet computer 130B, or personal computing device such as a laptop or desktop computer 130C, each equipped with an image sensor such as a camera. While the present technology will be described herein as utilising image data obtained using a camera, alternative embodiments are contemplated in which other sensors are used to obtain the data relating to shape and/or size of a user's head or features thereof. For example, such sensors may include stereoscopic cameras for capturing three-dimensional images, or a light detector capable of detecting reflected light from a laser or strobing/structured light source.

The exemplary system 100 may include one or more manufacturing systems 140, configured to manufacture customised head-mounted display systems or components thereof. The manufacturing system 140 may include one or more manufacturing apparatus 142 configured to physically produce a component of a head-mounted display system 1000. In some examples, the manufacturing apparatus 142 is a 3D printer, knitting machine, weaving machine, laser cutting machine or other additive manufacturing apparatus. In examples, the manufacturing system 140 may include multiple types of manufacturing apparatus 142 for manufacture of different components of a head-mounted display system 1000. The manufacturing apparatus 142 may comprise one or more controllers 144 for control of the operative hardware 146 (e.g. knitting hardware or 3D printing hardware), and dedicated user interfaces for operator input/monitoring of the manufacturing apparatus 142. The manufacturing apparatus 142 may also communicate with other components of the manufacturing system, for example a manufacturing server 150 managing production of custom head-mounted display systems or components thereof in communication with the customisation server 102, and/or a manufacturing operator workstation 152.

In some examples, one or more of the manufacturing apparatus 142 is a laser cutter configured to cut out one or more components of the head-mounted display system and/or modify produced one or more components (e.g., a component produced by another manufacturing apparatus 142). The laser cutter may provide flexibility to provide complex shapes with precision, repeatability, speed and/or automation. The laser cutter may also allow for components generated in large numbers to be customized with speed by modifying a length and/or a shape of the component based on the analysis results of the user.

In some examples, one or more of the manufacturing apparatuses may be provided at a manufacturing plant, at a vendor, and/or at a user's home. In some examples, a component may be produced at one location by one or more of the manufacturing apparatuses and then further modified by one or more of the manufacturing apparatuses at another location. In some examples, the one or more manufacturing apparatuses disposed at different location may receive instructions from the same manufacturing server 150, the same customisation server 102, and/or the same manufacturing operator workstation 152. In some examples, the one or more manufacturing apparatuses disposed at different location may report results of producing and/or modifying a component to the manufacturing server 150, the customisation server 102, and/or the manufacturing operator workstation 152.

In some examples, one or more of the devices in the exemplary system 100 may include communication circuitry configured to communicate with one or more other devices in the system 100 directly and/or via the network 120.

### 5.6.2 Methods for Customised Manufacture of Lattice Structure

As illustrated in the flow diagrams of FIGS. 24A-24E, one aspect of the present technology is a method 7000 of producing at least one customised component of a head-mounted display system 1000. The customised component may be, for example, a component of an interfacing structure 1100 such as a cushion 1130 formed from a lattice structure. The customised component may be customised to an individual user in one or more ways, such as in shape, size or by another property, for example a property described above in relation to personalisation and/or optimisation of a lattice structure.

Referring to FIG. 24A, examples of the method 7000 may generally be characterized as including three phases: a user data capture phase 7100, a specification phase 7200, and a production phase 7300.

### 5.6.2.1 User Data Capture Phase

In order to produce a head-mounted display system that is stable and comfortable for the user to wear, it is desirable to customize the head-mounted display system, or at least components thereof, to conform with the size and/or shape of the user's head (and more particularly facial features). In order to provide such customization, it is often necessary to collect information about the size and/or shape of the user's head—in a number of cases including the user's facial features.

In examples of the present technology, the user data capture phase 7100 includes obtaining information representative of one or more landmark feature locations for a user's head. As used herein, the term “landmark” shall refer to particular points, a region or a feature on a human head associated with elements of the head, including facial features. The location of a landmark may be defined, for example, relative to other landmarks or a fixed reference point. Examples of head landmarks may include, without limitation: a subnasale, a sellion, a tragion, a posterior-most point of the user's head, a superior-most point of the user's head, a lateral-most point of the orbital margin, an inferior-most point of the orbital margin, the Frankfort horizontal plane, the sagittal plane and a coronal plane aligned with the tragion. Other examples of landmarks may be those features illustrated in any one of FIGS. 2B-2F.

5.6.2.1.1 Image data capture

In examples, obtaining the relevant information in the user capture phase 7100 may include capturing image data of at least a portion of a user's head at 7102 of FIG. 24B, and identifying the landmark feature locations based on the image data at 7104. By way of example, the image data may be captured using a camera of the smart phone 130A, tablet 130B, or computer 130C.

U.S. Patent Publication No. 2018/0117272, U.S. Patent Publication No. 2019/0167934, U.S. Pat. Nos. 7,827,038, 8,254,637, and 10,157,477 describe exemplary methods and systems for capturing data (e.g., image data) of at least a portion of a user's head, determining user features, and/or fitting features of a mask to a user, the contents of each of which are incorporated herein by reference in their entirety. Other exemplary software tools for producing a three-dimensional model of a user's head, or portion thereof, may include: the “Capture” application available from Standard Cyborg, the “Scandy Pro” application available from Scandy, LLC; the “Beauty 3D” available from Guangzhou Zhimei Co., Ltd; the “Unre 3D FaceApp” available from UNRE AI LIMITED; and the “Bellus 3D FaceApp” available from Bellus3D, Inc. Furthermore, any of the technology described elsewhere herein in relation to automatic sizing may be applied together with or as an alternative to the facial data acquisition technology described in this section.

In alternative examples, the relevant information may be obtained by a user or vendor performing a series of measurements on the user's head, and a record of these measurements created and entered into the system 100—i.e. circumventing the requirement to capture image data.

### 5.6.2.1.2 Landmark Feature Identification

In examples, identifying landmark features of the user at 7104 may be based on two-dimensional image data. An exemplary method and system for determining landmark features of a user, and locations of same, based on two-dimensional image data is described in U.S. Patent Publication No. 2018/0117272.

In examples, identifying landmark features based on the image data at 7104 may include producing a three-dimensional model of the user's face and/or head (at 7110 of FIG. 24C). The three-dimensional model may be analysed to identify landmark features of the user and determine locations of same at 7112. An exemplary method and system for identifying landmark features and locations of same from a three-dimensional model is described in U.S. Patent Publication No. 2019/0167934. As an example, the three-dimensional model may be generated based on data received from a 3D scanner, a stereo camera, and/or a plurality of images captured of the user's face and/or head from different positions and/or orientations of the capturing device and/or the user.

In examples, local processing facilities at the point of capturing the image data (e.g. the smart phone 130A, tablet 130B, or computer 130C) may be used to identify the landmark features (including generation of the three-dimensional model in examples). In alternative examples, the image data may be communicated to remote processing facilities (e.g. customisation server 102) for further processing.

### 5.6.2.1.3 Relationships Between Landmark Features

In some forms of the present technology, the method 7000 may include identifying relationships between landmark features. Such relationships may provide information regarding anthropometric measurements of the user to inform customisation of the head-mounted display system, or component thereof, for the user. By way of example, a relationship between landmark features may include distance (i.e. spacing between the features), and relative angle.

In examples, identifying a relationship between landmark features may include determining distance between two or more of a subnasale, a sellion, a tragion, a posterior-most point of the user's head, a superior-most point of the user's head, a lateral-most point of the right orbital margin, a lateral-most point of the left orbital margin, an inferior-most point of the orbital margin, the Frankfort horizontal plane, and a coronal plane aligned with the tragion.

It will be appreciated that the landmark features (and their associated relationships) to be identified may be influenced by the design or configuration of the head-mounted display system, or component thereof, to be manufactured-i.e. some landmark features will be relevant to certain designs or components, but not others. In examples, only select landmark features and their relationships may be assessed. In alternative examples, an entire set of landmark features from a list of possible landmark features that are capable of being identified may be assessed in order to allow use of the data set across a range of head-mounted display systems, or components thereof.

FIG. 25 shows a side view of a user's head with a number of landmark feature spacings identified, described below. Each feature spacing is between a pair of landmark feature locations. Each of the spacings may be useful in determining the size and shape of the user's head and locations of features thereof, for use in tailoring a cushion 1130 to the user.

In examples a distance D1 between the subnasale and the coronal plane aligned with the tragion may be determined, the distance D1 being normal to said coronal plane. This landmark feature spacing may enable the spacing in the anterior-posterior axis between the user's lip superior and the user's ears to be accounted for in the design of a customised component for a head-mounted display system 1000.

In examples a distance D2 in the sagittal plane between the subnasale and the tragion may be determined. The distance D2 may be a direct distance in the sagittal plane including both the vertical component and a horizontal component (e.g. a diagonal distance in the sagittal plane between the subnasale and vertically superior tragion). Together with the horizontal distance D1 between the subnasale and the tragion, this distance D2 may enable the height of the ear with respect to the lower periphery of the user's nose to be taken into account in the design of a customised component for a head-mounted display system 1000.

In examples a vertical distance D3 in the sagittal plane between the subnasale and the sellion may be determined. This distance D3 may enable the height of the user's nose and/or the spacing between the lower periphery of the user's nose and the user's eyes to be accounted for in the design of customised component for a head-mounted display system 1000. In particular, this spacing may be particularly useful in determining the shape and/or size of a customised cushion 1130 of and interfacing structure 1100, for example.

In examples a distance D4 between the lateral-most point of the orbital margin and the coronal plane aligned with the tragion may be determined, the distance D4 being normal to said coronal plane. This spacing may enable the distance between the user's ear and the user's eye to be taken into account in the design of a customised component for a head-mounted display system 1000.

In examples a vertical distance D5 between the subnasale and the superior-most point of the user's head may be determined. This feature spacing may enable the height of the user's head and the spacing between the lower periphery of the user's nose and the top of the user's head to be taken into account in the design of a customised component for a head-mounted display system 1000. This feature spacing may be useful in determining the shape and/or size of a customised cushion 1130, for example.

In examples a vertical distance D6 between the superior-most point of the user's head and the Frankfort horizontal plane may be determined. This feature spacing may enable the distance between top the user's head and the user's ear or lower orbital margin to be taken into account in the design of a customised component for a head-mounted display system 1000. This distance may be useful in determining the shape and/or size of a customised cushion 1130, for example.

In examples a distance D7 between the rearmost point of the head and a coronal plane aligned with the tragion may be determined, the distance D7 being normal to said coronal plane. This feature spacing may enable the size of the user's head and/or the distance between the user's ear and the rear of the user's head to be taken into account in the design of a customised component for a head-mounted display system 1000.

The preceding relationships are given by example only, and are not intended to be limiting to all forms of the present technology.

5.6.2.2 Specification phase

In the specification phase 7200, examples of the method 7000 include determining a set of manufacturing specifications for production of a head-mounted display system, or one or more components thereof such as a cushion 1130 formed from a lattice structure or the lattice structure thereof, based on the one or more landmark feature locations and/or relationships between same.

In examples, such specifications are determined based on one or more performance requirements of the component. Examples of such performance requirements may include one or more of: stiffness, contact pressure, compliance, forces to be applied by or to the component, elasticity, dimensions (including size and relative angles of features of the component), tactile feel, breathability, heat dissipation, and/or positioning on the user's head. Such performance criteria may be influenced by one or more of: stability (for example, stability of the head-mounted display system during vigorous movements), user comfort (for example, the feel of the component to the touch, and relative positioning to avoid more sensitive areas of the user's head), and manufacturing considerations (for example, material costs and/or complexity of manufacture). It will be appreciated that the performance requirements for a component will be influenced by the one or more landmark feature locations and/or relationships between same, examples of which are described further below. In examples, the customised component specifications may be determined based in part on non-performance characteristics such as colour.

In examples, the performance requirements may be based on functional requirements which are not derived from the landmark feature locations and/or relationships between same, as described above.

The performance requirements and resulting manufacturing specifications will depend on the particular type or style of customised component to be produced.

In examples, the customised component may include a cushion 1130 or lattice structure thereof, as described herein. References to a production of a customised cushion 1130 are to be understood to be references to at least a lattice structure thereof, whether or not the lattice structure forms the entire completed cushion 1130 or not. The cushion 1130 may be customised to a particular user by being formed in a particular shape and/or size, based on the landmark feature locations and/or relationships, that results in a comfortable and stable fit for that particular user. Exemplary cushions 1130 are described above with reference to FIGS. 7-22B, for example.

In examples, the performance requirements of one component of the head-mounted display system may be influenced by properties or characteristics of another component. By way of example, for a customised cushion 1130 certain performance requirements may be determined in part by dimensions and/or configurations of a display unit housing 1200 or interfacing structure 1100 to which the cushion 1130 is to be attached.

In examples, the manufacturing specifications may comprise material specifications. A particular material, or blend of materials, may be selected based on a performance requirement such as stiffness, hardness, flexibility, compliance, or tactile feel. In some examples a material may be selected based on preferences of the user for whom the customised component is being produced.

In examples, the manufacturing specifications may comprise construction technique specifications. For example, in a cushion 1130 comprising a lattice structure, a particular type/pattern of lattice structure (e.g. one of the example structures in FIGS. 15A-15F) may be selected based on performance requirements for the component. Where the lattice structure is formed by knitting then knitting stitch(es) may be specified.

In examples, determining a set of manufacturing specifications may comprise selecting a set of manufacturing specifications from a plurality of pre-existing sets of manufacturing specifications. In examples, determining a set of manufacturing specifications may comprise selecting a plurality of manufacturing specifications to form the set of manufacturing specifications from a plurality of pre-existing manufacturing specifications. Selection of pre-existing manufacturing specifications may be based on similarities between the one or more landmark feature locations and/or relationships determined for the user, and those associated with the pre-existing manufacturing specification.

Identifying the landmark features and/or their location (e.g., at 7104 and/or 7112), identifying relationships between the landmark features, determining functional requirements (e.g., for a head-mounted display system and/or one or more components thereof) (e.g., at 7202), and/or determining manufacturing specifications (e.g., at 7204) may include using artificial intelligence and/or machine learning algorithms. For example, a trained dataset may be used to identify the landmark features and/or their location. In some examples, the captured image data and/or the three dimensional models used to identify the landmark features may be used to train datasets. In another example, a trained data set may be used to identify manufacturing specifications based on the landmark features, their locations, and/or functional requirements.

### 5.6.2.3 Producing the Customised Component

In examples, producing the head-mounted display system or component thereof (e.g. cushion 1130) based on the set of manufacturing specifications at 7300 comprises producing manufacturing machine programming instructions for production of the head-mounted display system or component thereof based on the set of manufacturing specifications at 7302 (see FIG. 24E). The manufacturing machines 142 are programmed with the manufacturing machine programming instructions at 7304, and are operated according to the manufacturing machine programming instructions to produce the head-mounted display system or component thereof at 7306.

In some examples, producing the customised component at 7300 comprises additive manufacturing (for example, 3D printing) of the customised component. The manufacturing machines 142 may comprise a 3D printer to print the customised component, for example the cushion 1130 or lattice structure thereof. The manufacturing machines 142 may comprise a laser cutter to cut-out and/or modify a customised component, for example a cushion 1130 formed from foam and having laser cut holes to form it into a lattice structure.

### 5.6.2.3.1 Producing Manufacturing Machine Programming Instructions

In examples, the manufacturing machine programming instructions for production of the head-mounted display system or component thereof (e.g. cushion 1130) may be generated automatically based on the set of manufacturing specifications. In examples, the manufacturing machine programming instructions may be generated from a model of the head-mounted display system or component embodying the set of manufacturing specifications. Software tools are known for producing manufacturing machine programming instructions from two-dimensional and three-dimensional models. Some aspects of the programming instructions may be determined automatically.

In examples, producing manufacturing machine programming instructions for production of the head-mounted display system or component thereof based on the set of manufacturing specifications at 7302 comprises generating a map representing the one or more manufacturing specifications at 7310 (see FIG. 24F). In such examples, producing the manufacturing machine programming instructions at 7302 comprises generating the instructions based on the map representing the manufacturing specifications at 7312.

In an example, the map may comprise a two-dimensional model of the head-mounted display system or component thereof, e.g. one or more two-dimensional images. In examples, details of the manufacturing specifications may be supplied by visually coding the model—i.e. certain manufacturing specifications may be obtained by visual recognition of characteristics of the map. In an example, the map may comprise a three-dimensional model of the head-mounted display system or component thereof. In such an example, details of the manufacturing specifications may be encoded into the three-dimensional model.

In examples the map may be generated at a first processing facility, for example customisation server 102, and communicated to the appropriate manufacturer system 140 for generation of the manufacturing machine programming instructions.

In other examples, the generation of the map and the manufacturing machine programming instructions may be performed at a single processing facility, for example by generating the map using a first software application, and generating the manufacturing machine programming instructions using a second software application.

In examples, the map may be converted into a model from which the manufacturing machine programming instructions may be generated. In an alternative example, the manufacturing specifications may be embodied in a map configured to be converted directly into the manufacturing machine programming instructions. In examples, the set of manufacturing specifications may be converted into the manufacturing machine programming instructions without an intermediary model or map being generated.

In examples, the set of manufacturing specifications may be used to modify a pre-existing template from which the manufacturing machine programming instructions are generated. Such templates may have predefined baseline rules associated with them, for example relating to manufacturing constraints, or universal performance requirements for a particular component design. In exemplary embodiments, such templates may include predefined regions of the component design, wherein the manufacturing specifications are used to modify parameters of each predefined region.

### 5.6.2.4 Distribution of Customised Component

In examples, following production of the customised head-mounted display system or component thereof, an automated distribution system may be used to manage delivery to the user. In examples, the customised head-mounted display system or component thereof (e.g. cushion 1130) may be delivered directly to the user from the facilities of the manufacturing system 140, or to a designated collection point or address.

In examples in which multiple components are to be produced, or at least supplied together with at least one customised component, an assembly phase may be performed. In examples, assembly may be performed by the vendor of the head-mounted display system. Where the manufacturer of the customised component is a third party, the customised component may be delivered to a facility of the vendor for assembly with other components prior to delivery to the user. Alternatively, assembly may be performed by the user.

### 5.6.2.5 Matching of User to Existing Products

According to an aspect of the present technology, user-specific data (e.g. measurements obtained from the user, or user profile information) may be used to select a head-mounted display system component from a group of pre-existing component configurations having associated manufacturing specifications and programming instructions. For example, the selection may be based on a comparison between user-specific data and a data record relating to information associated with the pre-existing component configurations.

In examples, the pre-existing component configurations may be developed based on one or more sets of data representative of landmark features of heads representative of a user base. For example, a set of data may comprise a model of a human head having characteristics associated with profile categories such as gender, age, or build. Such models may be trained, for example using artificial intelligence and/or machine learning algorithms. Manufacturing specifications may be developed based on analysis of such representative models, and programming instructions generated from same.

5.6.2.6 Using Feedback to Modify Specification and/or Update Models

According to an aspect of the present technology, feedback from the user, vendor and/or manufacturing operator may be used to update parameters and/or models used to perform one or more of the above discussed operations (e.g., identifying the landmark features and/or their location, identifying relationships between landmark features, determining functional requirements, and/or determining manufacturing specifications). The feedback may be received via the head-mounted display device 1000, the user devices 130, the operator workstation 114, and/or the manufacturing operator workstation 152.

The user may provide feedback after receiving the customized head-mounted display system. The use may input information indicating how well the head-mounted display system fits when the head-mounted display system is first used, after a predetermined period of time (e.g., after receiving or starting to use the head-mounted display system), and/or after a predetermined amount of use. The user may be asked predefined questions about different aspects of the head-mounted display system and/or asked to rate different features of the head-mounted display system. The vendor may input feedback received from the user and/or feedback based on observing the user using the head-mounted display system. The manufacturing operator may provide feedback based on the customized head-mounted display systems being produced by the manufacturing apparatus 142. For example, the manufacturing operator may inspect the manufactured head-mounted display system and input details of defects in the head-mounted display system caused by the manufacturing process.

The feedback from the user, vendor and/or manufacturing operator may be used to modify manufacturing specifications and/or update models used (e.g., by artificial intelligence and/or machine learning algorithms) to identify the landmark features and/or their location, to identify relationships between landmark features and/or to identify manufacturing specifications.

### 5.7 Cleaning

In some forms, the head-mounted display system 1000 or at least a portion thereof, is designed to be used by a single user, and cleaned in a home of the user, e.g., washed in soapy water, without requiring specialised equipment for disinfection and sterilisation. Specifically, the positioning and stabilizing structure 1300 and the interfacing structure 1100 are designed to be cleaned, as they are both in direct contact with the user's head.

In some other forms, the components of the positioning and stabilizing structure 1300 and interfacing structure 1100 are used in labs, clinics and hospitals wherein a single head-mounted display may be reused on multiple persons or used during medical procedures. In each of the labs, clinics and hospitals the head-mounted displays, or relevant components thereof, can be reprocessed and be exposed to, for example, processes of thermal disinfection, chemical disinfection and sterilisation. As such, the design of the positioning and stabilizing structure and interfacing structure may need to be validated for disinfection and sterilisation of the mask in accordance with ISO17664.

Materials may be chosen to withstand reprocessing. For example, robust materials may be used in the positioning and stabilizing structure 1300 to withstand exposure to high level disinfection solutions and agitation with a brush. Further, some components of the positioning and stabilizing structure are separable, and in-use may be disconnected to improve the reprocessing efficacy.

In some examples, the interfacing structure 1100 may, in use, be in contact with the user's head and therefor may become dirty (e.g., from sweat). The interfacing structure 1100 may be designed to be removed from the display unit housing 1205, to provide the ability to remove it for cleaning and/or replacement. It may be desirable to wash the interfacing structure 1100 while not getting the positioning and stabilizing structure 1300 wet. Alternatively or in addition, the positioning and stabilizing structure 1300 may be dirty from contact with the user's head, and may be removed for cleaning and/or replacement independently of the interfacing structure 1100. In either case, this may be facilitated by allowing these components to disconnect for such a purpose.

In some examples, a cover (e.g., constructed from a textile, silicone, etc.) may be removably positioned over the interfacing structure and can be removed to be cleaned and/or replaced after each use. The cover may allow the interface structure 3400 to remain fixed to the display unit housing 1205, and still provide a surface that can be easily cleaned after being used.

### 5.8 External Computer

In some forms, the head-mounted display system 1000 (e.g., VR, AR, and/or MR) may be used in conjunction with a separate device, like a computer or video game console. For example, the display interface may be electrically connected to the separate device.

In some forms, at least some processing for the head-mounted display system 1000 may be performed by the separate device. The separate device may include a larger and/or more powerful processor than could be comfortably supported by the user (e.g., the processor of the separate device may be too heavy for the user to comfortably support on their head).

### 6 GLOSSARY

For the purposes of the present technology disclosure, in certain forms of the present technology, one or more of the following definitions may apply. In other forms of the present technology, alternative definitions may apply.

### 6.1 General

Ambient: In certain forms of the present technology, the term ambient will be taken to mean (i) external of the display interface and/or user, and (ii) immediately surrounding the display interface and/or user.

For example, ambient light with respect to a display interface may be the light immediately surrounding the user, e.g. the light in the same and/or adjacent room as a user, and/or natural light from the sun.

In certain forms, ambient (e.g., acoustic) noise may be considered to be the background noise level in the room where a user is located, other than for example, noise generated by the display device or emanating from speakers connected to the display device. Ambient noise may be generated by sources outside the room.

Leak: The word leak will be taken to be an unintended exposure to light. In one example, leak may occur as the result of an incomplete seal between a display unit and a users' face.

Noise, radiated (acoustic): Radiated noise in the present document refers to noise which is carried to the user by the ambient air. In one form, radiated noise may be quantified by measuring sound power/pressure levels of the object in question according to ISO 3744.

User: A person operating the display interface and/or viewing images provided by the display interface. For example, the person may be wearing, donning, and/or doffing the display interface ..

### 6.1.1 Materials

Silicone or Silicone Elastomer: A synthetic rubber. In this specification, a reference to silicone is a reference to liquid silicone rubber (LSR) or a compression moulded silicone rubber (CMSR). One form of commercially available LSR is SILASTIC (included in the range of products sold under this trademark), manufactured by Dow Corning. Another manufacturer of LSR is Wacker. Unless otherwise specified to the contrary, an exemplary form of LSR has a Shore A (or Type A) indentation hardness in the range of about 35 to about 45 as measured using ASTM D2240.

Polycarbonate: a thermoplastic polymer of Bisphenol-A Carbonate.

### 6.1.2 Mechanical Properties

Resilience: Ability of a material to absorb energy when deformed elastically and to release the energy upon unloading.

Resilient: Will release substantially all of the energy when unloaded. Includes e.g. certain silicones, and thermoplastic elastomers.

Hardness: The ability of a material per se to resist deformation (e.g. described by a Young's Modulus, or an indentation hardness scale measured on a standardised sample size).
‘Soft’ materials may include silicone or thermo-plastic elastomer (TPE), and may, e.g. readily deform under finger pressure.
‘Hard’ materials may include polycarbonate, polypropylene, steel or aluminium, and may not e.g. readily deform under finger pressure.

Stiffness (or rigidity) of a structure or component: The ability of the structure or component to resist deformation in response to an applied load. The load may be a force or a moment, e.g. compression, tension, bending or torsion. The structure or component may offer different resistances in different directions. The inverse of stiffness is flexibility.

Floppy structure or component: A structure or component that will change shape, e.g. bend, when caused to support its own weight, within a relatively short period of time such as 1 second.

Rigid structure or component: A structure or component that will not substantially change shape when subject to the loads typically encountered in use. An example of such a use may be setting up and maintaining a user interface in sealing relationship.

As an example, an I-beam may comprise a different bending stiffness (resistance to a bending load) in a first direction in comparison to a second, orthogonal direction. In another example, a structure or component may be floppy in a first direction and rigid in a second direction.

### 6.2 Materials

Closed-cell foam: Foam comprising cells that are completely encapsulated, i.e. closed cells.

Elastane: A polymer made from polyurethane.

Elastomer: A polymer that displays elastic properties. For example, silicone elastomer.

Ethylene-vinyl acetate (EVA): A copolymer of ethylene and vinyl acetate.

Fiber: A filament (mono or poly), a strand, a yarn, a thread or twine that is significantly longer than it is wide. A fiber may include animal-based material such as wool or silk, plant-based material such as linen and cotton, and synthetic material such as polyester and rayon. A fiber may specifically refer to a material that can be interwoven and/or interlaced (e.g., in a network) with other fibers of the same or different material.

Foam: Any material, for example polyurethane, having gas bubbles introduced during manufacture to produce a lightweight cellular form.

Neoprene: A synthetic rubber that is produced by polymerization of chloroprene. Neoprene is used in trade products: Breath-O-Prene.

Nylon: A synthetic polyamide that has elastic properties and can be used, for example, to form fibres/filaments for use in textiles.

Open-cell foam: Foam comprising cells, i.e. gas bubbles that aren't completely encapsulated, i.e. open cells.

Polycarbonate: a typically transparent thermoplastic polymer of Bisphenol-A Carbonate.

Polyethylene: A thermoplastic that is resistant to chemicals and moisture.

Polyurethane (PU): A plastic material made by copolymerizing an isocyanate and a polyhydric alcohol and, for example, can take the form of foam (polyurethane foam) and rubber (polyurethane rubber).

Semi-open foam: Foam comprising a combination of closed and open (encapsulated) cells.

Silicone or Silicone Elastomer: A synthetic rubber. In this specification, a reference to silicone is a reference to liquid silicone rubber (LSR) or a compression moulded silicone rubber (CMSR). One form of commercially available LSR is SILASTIC (included in the range of products sold under this trademark), manufactured by Dow Corning. Another manufacturer of LSR is Wacker. Unless otherwise specified to the contrary, an exemplary form of LSR has a Shore A (or Type A) indentation hardness in the range of about 35 to about 45 as measured using ASTM D2240.

Spacer Fabric: A composite construction comprised of two outer textile substrates joined together and kept apart by an intermediate layer of monofilaments.

Spandex: An elastic fibre or fabric, primarily comprised of polyurethane. Spandex is used in trade products: Lycra.

Textile: A material including at least one natural or artificial fiber. In this specification, a textile may refer to any material that is formed as a network of interwoven and/or interlaced fibers. A type of textile may include a fabric, which is constructed by interlacing the fibers using specific techniques. These include weaving, knitting, crocheting, knotting, tatting, tufting, or braiding. Cloth may be used synonymously with fabric, although may specifically refer to a processed piece of fabric. Other types of textiles may be constructed using bonding (chemical, mechanical, heat, etc.), felting, or other nonwoven processes. Textiles created through one of these processes are fabric-like, and may be considered synonymous with fabric for the purposes of this application.

Thermoplastic Elastomer (TPE): Are generally low modulus, flexible materials that can be stretched at room temperature with an ability to return to their approximate original length when stress is released. Trade products that use TPE include: Hytrel, Dynaflex, Medalist

Thermoplastic Polyurethane (TPU): A thermoplastic elastomer with a high durability and flexibility.

### 6.3 Mechanical Properties

Resilience: Ability of a material to absorb energy when deformed elastically and to release the energy upon unloading.

Resilient: Will release substantially all of the energy when unloaded. Includes e.g. certain silicones, and thermoplastic elastomers.

Hardness: The ability of a material per se to resist deformation (e.g. described by a Young's Modulus, or an indentation hardness scale measured on a standardised sample size).
‘Soft’ materials may include silicone or thermo-plastic elastomer (TPE), and may, e.g. readily deform under finger pressure.
‘Hard’ materials may include polycarbonate, polypropylene, steel or aluminium, and may not e.g. readily deform under finger pressure.

Stiffness (or rigidity) of a structure or component: The ability of the structure or component to resist deformation in response to an applied load. The load may be a force or a moment, e.g. compression, tension, bending or torsion. The structure or component may offer different resistances in different directions.

Floppy structure or component: A structure or component that will change shape, e.g. bend, when caused to support its own weight, within a relatively short period of time such as 1 second.

Rigid structure or component: A structure or component that will not substantially change shape when subject to the loads typically encountered in use.

As an example, an I-beam may comprise a different bending stiffness (resistance to a bending load) in a first direction in comparison to a second, orthogonal direction. In another example, a structure or component may be floppy in a first direction and rigid in a second direction.

### 6.4 Anatomy

The following definitions correspond references identified in FIGS. 1-2.

### 6.4.1 Anatomy of the Face

Ala: the external outer wall or “wing” of each nostril (plural: alar)

Alare: The most lateral point on the nasal ala.

Alar curvature (or alar crest) point: The most posterior point in the curved base line of each ala, found in the crease formed by the union of the ala with the cheek.

Auricle: The whole external visible part of the ear.

(nose) Bony framework: The bony framework of the nose comprises the nasal bones, the frontal process of the maxillae and the nasal part of the frontal bone.

Bridge (nasal): The nasal bridge is the midline prominence of the nose, extending from the Sellion to the Pronasale.

(nose) Cartilaginous framework: The cartilaginous framework of the nose comprises the septal, lateral, major and minor cartilages.

Cheilion: A point located at the corner of the mouth.

Columella: the strip of skin that separates the nares and which runs from the pronasale to the upper lip.

Columella angle: The angle between the line drawn through the midpoint of the nostril aperture and a line drawn perpendicular to the Frankfort horizontal while intersecting subnasale.

Endocanthion: The point at which the upper and lower eyelids meet, proximal to the Sellion.

Epicranius: The Epicranius, or frontal belly, refers to structures that cover the cranium.

External occipital protuberance: A protuberance on the outer surface of the occipital bone.

Frankfort horizontal plane: A line extending from the most inferior point of the orbital margin to the left tragion. The tragion is the deepest point in the notch superior to the tragus of the auricle.

Glabella: Located on the soft tissue, the most prominent point in the midsagittal plane of the forehead.

Interpupillary Distance: The distance between the centres of the pupils of the eyes.

Lateral nasal cartilage: A generally triangular plate of cartilage. Its superior margin is attached to the nasal bone and frontal process of the maxilla, and its inferior margin is connected to the greater alar cartilage.

Lip, inferior (labrale inferius): A point on the face between the mouth and supramenton, lying in the median sagittal plane.

Lip, superior (labrale superius): A point on the face between the mouth and nose, lying in the median sagittal plane.

Greater alar cartilage: A plate of cartilage lying below the lateral nasal cartilage. It is curved around the anterior part of the naris. Its posterior end is connected to the frontal process of the maxilla by a tough fibrous membrane containing three or four minor cartilages of the ala.

Nares (Nostrils): Approximately ellipsoidal apertures forming the entrance to the nasal cavity. The singular form of nares is naris (nostril). The nares are separated by the nasal septum.

Naso-labial sulcus or Naso-labial fold: The skin fold or groove that runs from each side of the nose to the corners of the mouth, separating the cheeks from the upper lip.

Naso-labial angle: The angle between the columella and the upper lip, while intersecting subnasale.

Otobasion inferior: The lowest point of attachment of the auricle to the skin of the face.

Otobasion superior: The highest point of attachment of the auricle to the skin of the face.

Pronasale: the most protruded point or tip of the nose, which can be identified in lateral view of the rest of the portion of the head.

Philtrum: the midline groove that runs from lower border of the nasal septum to the top of the lip in the upper lip region.

Pogonion: Located on the soft tissue, the most anterior midpoint of the chin.

Ridge (nasal): The nasal ridge is the midline prominence of the nose, extending from the Sellion to the Pronasale.

Sagittal plane: A vertical plane that passes from anterior (front) to posterior (rear). The midsagittal plane is a sagittal plane that divides the body into right and left halves.

Sellion: Located on the soft tissue, the most concave point overlying the area of the frontonasal suture.

Septal cartilage (nasal): The nasal septal cartilage forms part of the septum and divides the front part of the nasal cavity.

Subalare: The point at the lower margin of the alar base, where the alar base joins with the skin of the superior (upper) lip.

Subnasal point: Located on the soft tissue, the point at which the columella merges with the upper lip in the midsagittal plane.

Supramenton: The point of greatest concavity in the midline of the lower lip between labrale inferius and soft tissue pogonion.

Superciliary arch: A protuberance of the frontal bone above the eye.

Temporalis muscle: A muscle in the temporal fossa that serves to raise the lower jaw.

Temporomandibular joint: A freely moveable joint between the temporal bone and mandible that allows for the opening, closing, protrusion, retraction, and lateral movement of the mandible.

Vermillion, upper: A red part of the lips covered with stratified squamous epithelium which is in continuity with the oral mucosa of the gingivolabial groove.

### 6.4.2 Anatomy of the Skull

Frontal bone: The frontal bone includes a large vertical portion, the squama frontalis, corresponding to the region known as the forehead.

Lateral cartilage: Portion of cartilage lateral of the Septal cartilage and inferior to the Nasal bones.

Mandible: The mandible forms the lower jaw. The mental protuberance is the bony protuberance of the jaw that forms the chin.

Masseter minor: A lower portion of the Masseter muscle of which raises the lower jaw.

Maxilla: The maxilla forms the upper jaw and is located above the mandible and below the orbits. The frontal process of the maxilla projects upwards by the side of the nose, and forms part of its lateral boundary.

Nasal bones: The nasal bones are two small oblong bones, varying in size and form in different individuals; they are placed side by side at the middle and upper part of the face, and form, by their junction, the “bridge” of the nose.

Nasion: The intersection of the frontal bone and the two nasal bones, a depressed area directly between the eyes and superior to the bridge of the nose.

Occipital bone: The occipital bone is situated at the back and lower part of the cranium. It includes an oval aperture, the foramen magnum, through which the cranial cavity communicates with the vertebral canal. The curved plate behind the foramen magnum is the squama occipitalis.

Orbit: The bony cavity in the skull to contain the eyeball.

Parietal bones: The parietal bones are the bones that, when joined together, form the roof and sides of the cranium.

Septal cartilage: Cartilage of the nasal septum.

Sphenoid bone: A wedge shaped bone of the base of the cranium.

Supraorbital foramen: An opening in the inferior bone of the orbit for the passage of the Supraorbital nerve, artery and vein.

Temporal bones: The temporal bones are situated on the bases and sides of the skull, and support that part of the face known as the temple.

Trapezius minor: A triangular-shaped superficial muscle of the upper back.

Zygomatic bones: The face includes two zygomatic bones, located in the upper and lateral parts of the face and forming the prominence of the cheek.

### 6.5 User Interface

Frame: Frame will be taken to mean a display housing unit that bears the load of tension between two or more points of connection with a headgear and/or a hoop. The frame may seal against the user's face in order to limit and/or prevent the ingress and/or egress of light.

Hoop: Hoop will be taken to mean a form of positioning and stabilizing structure designed for use on a head. For example the hoop may comprise a collection of one or more struts, ties and stiffeners configured to locate and retain a user interface in position on a users' face for holding a display unit in an operational position in front of a user's face. Some ties are formed of a soft, flexible, elastic material such as a laminated composite of foam and fabric/textile. In some forms, the term headgear may be synonymous with the term hoop.

Membrane: Membrane will be taken to mean a typically thin element that has, preferably, substantially no resistance to bending, but has resistance to being stretched.

Seal: May be a noun form (“a seal”) which refers to a structure, or a verb form (“to seal”) which refers to the effect. Two elements may be constructed and/or arranged to ‘seal’ or to effect ‘sealing’ therebetween without requiring a separate ‘seal’element per se.

Shell: A shell will be taken to mean a curved, relatively thin structure having bending, tensile and compressive stiffness. For example, a curved structural wall of a mask may be a shell. In some forms, a shell may be faceted. In some forms a shell may be airtight. In some forms a shell may not be airtight.

Stiffener: A stiffener will be taken to mean a structural component designed to increase the bending resistance of another component in at least one direction.

Strut: A strut will be taken to be a structural component designed to increase the compression resistance of another component in at least one direction.

Swivel (noun): A subassembly of components configured to rotate about a common axis, preferably independently, preferably under low torque. In one form, the swivel may be constructed to rotate through an angle of at least 360 degrees. In another form, the swivel may be constructed to rotate through an angle less than 360 degrees.

Tie (noun): A structure designed to resist tension.

### 6.6 Shape of Structures

Products in accordance with the present technology may comprise one or more three-dimensional mechanical structures, for example a mask cushion or an impeller. The three-dimensional structures may be bounded by two-dimensional surfaces. These surfaces may be distinguished using a label to describe an associated surface orientation, location, function, or some other characteristic. For example a structure may comprise one or more of an anterior surface, a posterior surface, an interior surface and an exterior surface. In another example, a seal-forming structure may comprise a face-contacting (e.g. outer) surface, and a separate non-face-contacting (e.g. underside or inner) surface. In another example, a structure may comprise a first surface and a second surface.

To facilitate describing the shape of the three-dimensional structures and the surfaces, we first consider a cross-section through a surface of the structure at a point, p. See FIG. 3A to FIG. 3E, which illustrate examples of cross-sections at point p on a surface, and the resulting plane curves. FIGS. 3A to 3E also illustrate an outward normal vector at p. The outward normal vector at p points away from the surface. In some examples we describe the surface from the point of view of an imaginary small person standing upright on the surface.

### 6.6.1 Curvature in One Dimension

The curvature of a plane curve at p may be described as having a sign (e.g. positive, negative) and a magnitude (e.g. 1/radius of a circle that just touches the curve at p).

Positive curvature: If the curve at p turns towards the outward normal, the curvature at that point will be taken to be positive (if the imaginary small person leaves the point p they must walk uphill). See FIG. 3A (relatively large positive curvature compared to FIG. 3B) and FIG. 3B (relatively small positive curvature compared to FIG. 3A). Such curves are often referred to as concave.

Zero curvature: If the curve at p is a straight line, the curvature will be taken to be zero (if the imaginary small person leaves the point p, they can walk on a level, neither up nor down). See FIG. 3C.

Negative curvature: If the curve at p turns away from the outward normal, the curvature in that direction at that point will be taken to be negative (if the imaginary small person leaves the point p they must walk downhill). See FIG. 3D (relatively small negative curvature compared to FIG. 3E) and FIG. 3E (relatively large negative curvature compared to FIG. 3F). Such curves are often referred to as convex.

### 6.6.2 Curvature of Two Dimensional Surfaces

A description of the shape at a given point on a two-dimensional surface in accordance with the present technology may include multiple normal cross-sections. The multiple cross-sections may cut the surface in a plane that includes the outward normal (a “normal plane”), and each cross-section may be taken in a different direction. Each cross-section results in a plane curve with a corresponding curvature. The different curvatures at that point may have the same sign, or a different sign. Each of the curvatures at that point has a magnitude, e.g. relatively small. The plane curves in FIGS. 3A to 3E could be examples of such multiple cross-sections at a particular point.

Principal curvatures and directions: The directions of the normal planes where the curvature of the curve takes its maximum and minimum values are called the principal directions. In the examples of FIG. 3A to FIG. 3E, the maximum curvature occurs in FIG. 3A, and the minimum occurs in FIG. 3E, hence FIG. 3A and FIG. 3E are cross sections in the principal directions. The principal curvatures at p are the curvatures in the principal directions.

Region of a surface: A connected set of points on a surface. The set of points in a region may have similar characteristics, e.g. curvatures or signs.

Saddle region: A region where at each point, the principal curvatures have opposite signs, that is, one is positive, and the other is negative (depending on the direction to which the imaginary person turns, they may walk uphill or downhill).

Dome region: A region where at each point the principal curvatures have the same sign, e.g. both positive (a “concave dome”) or both negative (a “convex dome”).

Cylindrical region: A region where one principal curvature is zero (or, for example, zero within manufacturing tolerances) and the other principal curvature is non-zero.

Planar region: A region of a surface where both of the principal curvatures are zero (or, for example, zero within manufacturing tolerances).

Edge of a surface: A boundary or limit of a surface or region.

Path: In certain forms of the present technology, ‘path’ will be taken to mean a path in the mathematical-topological sense, e.g. a continuous space curve from f(0) to f(1) on a surface. In certain forms of the present technology, a ‘path’ may be described as a route or course, including e.g. a set of points on a surface. (The path for the imaginary person is where they walk on the surface, and is analogous to a garden path).

Path length: In certain forms of the present technology, ‘path length’ will be taken to mean the distance along the surface from f(0) to f(1), that is, the distance along the path on the surface. There may be more than one path between two points on a surface and such paths may have different path lengths. (The path length for the imaginary person would be the distance they have to walk on the surface along the path).

Straight-line distance: The straight-line distance is the distance between two points on a surface, but without regard to the surface. On planar regions, there would be a path on the surface having the same path length as the straight-line distance between two points on the surface. On non-planar surfaces, there may be no paths having the same path length as the straight-line distance between two points. (For the imaginary person, the straight-line distance would correspond to the distance ‘as the crow flies’.)

### 6.6.3 Space Curves

Space curves: Unlike a plane curve, a space curve does not necessarily lie in any particular plane. A space curve may be closed, that is, having no endpoints. A space curve may be considered to be a one-dimensional piece of three-dimensional space. An imaginary person walking on a strand of the DNA helix walks along a space curve. A typical human left ear comprises a helix, which is a left-hand helix, see FIG. 3M. A typical human right ear comprises a helix, which is a right-hand helix, see FIG. 3N. FIG. 3O shows a right-hand helix. The edge of a structure, e.g. the edge of a membrane or impeller, may follow a space curve. In general, a space curve may be described by a curvature and a torsion at each point on the space curve. Torsion is a measure of how the curve turns out of a plane. Torsion has a sign and a magnitude. The torsion at a point on a space curve may be characterised with reference to the tangent, normal and binormal vectors at that point.

Tangent unit vector (or unit tangent vector): For each point on a curve, a vector at the point specifies a direction from that point, as well as a magnitude. A tangent unit vector is a unit vector pointing in the same direction as the curve at that point. If an imaginary person were flying along the curve and fell off her vehicle at a particular point, the direction of the tangent vector is the direction she would be travelling.

Unit normal vector: As the imaginary person moves along the curve, this tangent vector itself changes. The unit vector pointing in the same direction that the tangent vector is changing is called the unit principal normal vector. It is perpendicular to the tangent vector.

Binormal unit vector: The binormal unit vector is perpendicular to both the tangent vector and the principal normal vector. Its direction may be determined by a right-hand rule (see e.g. FIG. 3L), or alternatively by a left-hand rule (FIG. 3K).

Osculating plane: The plane containing the unit tangent vector and the unit principal normal vector. See FIGS. 3K and 3L.

Torsion of a space curve: The torsion at a point of a space curve is the magnitude of the rate of change of the binormal unit vector at that point. It measures how much the curve deviates from the osculating plane. A space curve which lies in a plane has zero torsion. A space curve which deviates a relatively small amount from the osculating plane will have a relatively small magnitude of torsion (e.g. a gently sloping helical path). A space curve which deviates a relatively large amount from the osculating plane will have a relatively large magnitude of torsion (e.g. a steeply sloping helical path). With reference to FIG. 3O, since T2>T1, the magnitude of the torsion near the top coils of the helix of FIG. 3O is greater than the magnitude of the torsion of the bottom coils of the helix of FIG. 3O.

With reference to the right-hand rule of FIG. 3M, a space curve turning towards the direction of the right-hand binormal may be considered as having a right-hand positive torsion (e.g. a right-hand helix as shown in FIG. 30). A space curve turning away from the direction of the right-hand binormal may be considered as having a right-hand negative torsion (e.g. a left-hand helix).

Equivalently, and with reference to a left-hand rule (see FIG. 3K), a space curve turning towards the direction of the left-hand binormal may be considered as having a left-hand positive torsion (e.g. a left-hand helix). Hence left-hand positive is equivalent to right-hand negative.

### 6.6.4 Holes

A surface may have a one-dimensional hole, e.g. a hole bounded by a plane curve or by a space curve. Thin structures (e.g. a membrane) with a hole, may be described as having a one-dimensional hole. See for example the one dimensional hole in the surface of structure shown in FIG. 3F, bounded by a plane curve.

A structure may have a two-dimensional hole, e.g. a hole bounded by a surface. For example, an inflatable tyre has a two dimensional hole bounded by the interior surface of the tyre. In another example, a bladder with a cavity for air or gel could have a two-dimensional hole. In a yet another example, a conduit may comprise a one-dimension hole (e.g. at its entrance or at its exit), and a two-dimension hole bounded by the inside surface of the conduit. See also the two dimensional hole through the structure shown in FIG. 3H, bounded by a surface as shown.

### 6.7 Other Remarks

A portion of the disclosure of this patent document contains material which is subject to copyright protection. The copyright owner has no objection to the facsimile reproduction by anyone of the patent document or the patent disclosure, as it appears in Patent Office patent files or records, but otherwise reserves all copyright rights whatsoever.

Unless the context clearly dictates otherwise and where a range of values is provided, it is understood that each intervening value, to the tenth of the unit of the lower limit, between the upper and lower limit of that range, and any other stated or intervening value in that stated range is encompassed within the technology. The upper and lower limits of these intervening ranges, which may be independently included in the intervening ranges, are also encompassed within the technology, subject to any specifically excluded limit in the stated range. Where the stated range includes one or both of the limits, ranges excluding either or both of those included limits are also included in the technology.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated herein by reference in their entirety to disclose and describe the methods and/or materials which are the subject of those publications. The publications discussed herein are provided solely for their disclosure prior to the filing date of the present application. Nothing herein is to be construed as an admission that the present technology is not entitled to antedate such publication by virtue of prior invention. Further, the dates of publication provided may be different from the actual publication dates, which may need to be independently confirmed.

The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular examples, it is to be understood that these examples are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative examples and that other arrangements may be devised without departing from the spirit and scope of the technology.

### 6.8 SELECTED REFERENCE SIGNS LIST

100 User
1000 Head-mounted display system
1100 Interfacing structure
1101 Interfacing structure clip
1102 Chassis portion
1118 Face engaging flange
1121 First end of face engaging flange
1122 Second end of face engaging flange
1123 Face engaging region
1130 Cushion
1131 Cushion body
1135 Cushion clip
1140 Cheek portion
1150 Closed loop portion
1160 Open loop portion
1170 Sphenoid portion
1175 Forehead portion
1180 Nasal portion
1182 Pronasale portion
1186 Bridge portions
1200 Head-mounted display unit
1205 Display unit housing
1220 Display screen
1230 Superior face
1232 Inferior face
1234 Lateral left face
1236 Lateral right face
1238 Anterior face
1240 Lens
1250 Temporal connector
1254 Eyelet
1256 Adjustment portion
1258 Receiving portion
1260 Pivot connection
1270 Controller
1272 Speaker
1274 Power source
1276 Control system
1278 Low power system battery
1280 Main battery
1282 Real time clock
1284 Orientation sensor
1286 Processing system
1288 Battery support portion
1290 Control system support
1300 Positioning and stabilising structure
1350 Posterior support portion
1360 Forehead support

1. An interfacing structure for a head-mounted display system, the interfacing structure configured to engage a user's face around at least a portion of a periphery of a user's eye region in use, the interfacing structure comprising:
a cushion at least partially formed by a lattice structure;
wherein the interfacing structure comprises a pair of cheek portions configured to engage the user's cheeks in use, a forehead portion configured to engage the user's forehead in use, and a pair of sphenoid portions located on respective lateral sides of the interfacing structure connecting between the forehead portion and the cheek portions and configured to engage the user's head proximate the sphenoid bone, the cushion being provided within each of the cheek portions, forehead portion and sphenoid portion; and
wherein the lattice structure comprises one or more characteristics that vary between locations corresponding to two or more of the cheek portions, forehead portion and sphenoid portions of the interfacing structure.

2. The interfacing structure of claim 1, wherein the interfacing structure comprises a face engaging flange structured and arranged to be provided around a periphery of an eye region of the user's face and configured to engage the user's face in use, the face engaging flange being flexible and resilient, the face engaging flange at least partially covering the lattice structure.

3. The interfacing structure of claim 2, wherein the interfacing structure comprises an interfacing structure clip configured to attach the interfacing structure to a display unit housing of the head-mounted display system.

4. The interfacing structure of claim 3, wherein the cushion is removably attached to the interfacing structure clip.

5. The interfacing structure of claim 3, wherein the cushion is permanently attached to the interfacing structure clip.

6. (canceled)

7. The interfacing structure of claim 3, wherein the cushion comprises one or more cushion clips configured to connect to the interfacing structure clip to attach the cushion to the interfacing structure clip.

8. The interfacing structure of claim 7, wherein the one or more cushion clips are removably attachable to the interfacing structure clip.

9. The interfacing structure of claim 7, wherein the face engaging flange extends from the interfacing structure clip.

10. The interfacing structure of claim 9, wherein the interfacing structure clip is configured to form a snap fit connection with the display unit housing.

11. The interfacing structure of claim 9, wherein the interfacing structure further comprises a chassis portion, the face engaging flange being attached to the chassis portion, the chassis portion being stiffer than the face engaging flange and being attached to the interfacing structure clip.

12. The interfacing structure of claim 11, wherein the face engaging flange and the chassis portion are integrally formed.

13. The interfacing structure of claim 11, wherein one or more of the cushion clips are configured to connect to the chassis portion.

14. The interfacing structure of claim 13, wherein the cushion clips are removably attachable to the chassis portion.

15-25. (canceled)

26. The interfacing structure of claim 1, wherein the cushion is formed from foam having holes therein forming the lattice structure.

27. The interfacing structure of claim 26, wherein the size, shape and/or spacing of the holes varies along a length of the cushion and/or between a first side of the cushion and a second side of the cushion.

28-29. (canceled)

30. The interfacing structure of claim 1, wherein the one or more characteristics of the lattice structure that vary between locations include stiffness of the lattice structure.

31. The interfacing structure of claim 1, wherein the one or more characteristics of the lattice structure that vary include shape, thickness, density, spacing, relative orientation and/or material of unit cells forming the lattice structure.

32. The interfacing structure of claim 1, wherein the cushion is stiffer in the forehead portion and/or the cheek portions in comparison to the sphenoid portions.

33. The interfacing structure of claim 1, wherein the cushion is able to deform to accommodate anthropometric variation to a greater extent in the sphenoid portions than in the forehead portion and/or the cheek portions.

34-78. (canceled)

79. A head-mounted display system, comprising:
a head-mounted display unit comprising a display unit housing, a display and the interfacing structure according to claim 1, the interfacing structure being configured to connect to the display unit housing; and
a positioning and stabilising structure structured and arranged to hold the head-mounted display unit in an operable position on the user's head in use.
